(19) United States
(12) Patent Application Publication
(10) Pub. No.: US 2023/0057940 A1
(43) Pub. Date: Feb. 23, 2023

(54) METAL PASTE FOR HYBRID ADDITIVE MANUFACTURING AND METHOD OF 3D PRINTING

(71) Applicant: MANTLE INC., San Francisco, CA (US)

(72) Inventors: Fabio ZURCHER, Brisbane, CA (US); Stephen T. CONNER, San Francisco, CA (US); Christopher FLEMING, Oakland, CA (US); Mohammed Haouaoui, Richmond, CA (US)

(73) Assignee: MANTLE INC., San Francisco, CA (US)

(21) Appl. No.: 17/875,032

(22) Filed: Jul. 27, 2022

Related U.S. Application Data
(60) Provisional application No. 63/203,668, filed on Jul. 27, 2021.

(51) Int. Cl. C09D 11/14; C09D 11/033; C09D 11/037

(52) U.S. Cl. CPC C09D 11/14; C09D 11/033; C09D 11/037

(57) ABSTRACT

Paste compositions for additive manufacturing and methods for the same are provided. The paste composition may include an organic vehicle, and one or more powders dispersed in the organic vehicle. The organic vehicle may include a solvent, a polymeric binder, a thixotropic additive, and a dispersant. The organic vehicle may be configured to provide the paste composition with a suitable viscosity. The organic vehicle may also be configured to provide a stable paste composition for a predetermined period of time.

### CROSS-REFERENCE TO RELATED APPLICATIONS

This application claims priority to U.S. Provisional Patent Application Ser. No. 63/203,668 which was filed on Jul. 27, 2021, the disclosure of which is incorporated by reference to the extent consistent with the present application.

### TECHNICAL FIELD

The present disclosure is directed to a paste for three-dimensional (“3D”) printing and a method of using the paste to print 3D objects.

### BACKGROUND

Additive manufacturing is a rapidly growing field in which material is assembled in a customized manner. The most common methods for additive manufacturing involve deposition of plastic or metal in a layer-by-layer fashion. Each layer is individually shaped by selective mass and energy input. The subfield of metal additive manufacturing holds much promise, particularly in the creation of high-value metal pieces for applications such as prototyping, aerospace components, and industrial tooling.

Metal pastes, which are dispersions of metal powders in a solvent, are known in the art as a means to deposit layers of metal powders with diameters typically less than 100 micrometers. The addition of a solvent has the effect of screening particles from interparticle attraction, allowing the formation of a stable dispersion or suspension. Various additives, such as polymers, can be included in the pastes to allow particles to flow past one another smoothly. Metal pastes have been used in additive manufacturing, as shown, for example, in U.S. Pat. No. 6,974,656 (issued to Hinczewski), wherein a metal paste is deposited in a layerwise fashion and further sintered after a multistep process. However, metal pastes are not often used in metal additive manufacturing due to various challenges in formulating and using the metal pastes. Common alternative additive manufacturing technologies use high energy sources such as lasers to fuse dry metal powders at temperatures near or above their melting point. While these technologies can rapidly produce metal parts of diverse alloys, they suffer from low precision and repeatability.

In additive manufacturing, materials are added, most commonly layer by layer, to produce an item through repetition of a set of mechanical processes. This is in contrast to subtractive manufacturing, such as machining, in which material is subtracted from a metal, ceramic, or metal alloy forged billet or block of bar stock of material by various mechanical processes. A sequentially additive process allows for the manufacture of unique features impossible by subtractive processes that do not include a part bonding step, such as internal structures used to form internal cooling channels. However, additive manufacturing often lacks the critical dimension precision and surface finish quality required of production level precision parts due to errors in the iteratively applied layer by layer addition of materials, and also the internal structure of feed stock from which additive parts are made can be different from that used in traditional subtractive manufacturing.

To solve these problems, hybrid methods of production have been disclosed whereby an additive process is combined with a subtractive process. In one such process, metal or ceramic containing paste is laid down layer by layer using a three-dimensional (3D) printer, and then refined by traditional machining after all, some, or one of the 3D additive steps are completed. The finished metal paste part (referred to in the art as a “green body”) may then be post-processed, usually by subjecting it to furnace sintering which fuses the metal paste into a strong part.

There are many difficulties in implementing the above outlined process due to stringent and sometimes conflicting requirements of the process on the metal or ceramic paste feedstock. First, the paste feedstock must be stable long enough to be practically stored and handled yet still be capable of assuming a fluid nature for 3D printing proposes. Once printed, the fluid paste must level and re-flow yet still hold a desired shape; then it must be able to be dried to a uniform and high density. Then, after printing, it must be amenable to subtractive machining processes whereby it can be machined to a desired shape without deformation or fracture with a fine surface finish, and the part must retain shape, integrity and finish for a practical delay and handling for sintering. Finally, during sintering the dried paste should not undergo significant changes in density that could adversely and unpredictably affect its shape, strength and size. This unique and novel set of material requirements are not met by metal or ceramic pastes that might be available for purchase in the market and have not been disclosed previously.

For example, a UV curable metal filled paste is disclosed in U.S. Pat. No. 6,974,656 for a process where a viscous paste of metal and UV polymerizable resin is formed into an object layer-by-layer, each layer cured by exposure to UV light by means of an initiator and the cured resin thus forming a substantial fraction of the solidified object. This approach has the notable disadvantage of leaving a substantial fraction by volume, a minimum of about 40% by volume, of non-metal parts behind in the solidified object which must be removed by thermal degradation prior to sintering. Once the cured resin is removed and the remaining metal particles are sintered, the finished object will have the significant disadvantages of either (a) substantial shrinkage and concomitant distortion or, (b) low density and concomitant low strength, or a combination of both (a) and (b) which compromise both desirable mechanical properties and final part accuracy after sintering. Further, removal of the cured resin at the end of the layer-by-layer formation does not permit for mechanical refinishing after each layer application, thus internal cavities possible in a printed part could not be finished or accurately shaped as is possible, intended and needed as discussed in this disclosure. Finally, neither thought nor care has been given to create a green body part amenable to mechanical processing as in the present disclosure.

In U.S. Pat. No. 6,630,009, the same authors teach and elaborate on a similar metal filled paste containing a resin which may be cured by UV by means of an initiator in the resin or heat cured, also by means of a suitable initiator component of the resin. Neither would such a paste be suitable to the process targeted in the present disclosure because, once UV cured or heat cured, the resin remains a solid component of the green body and must be removed after green body formation.

Although the resins in U.S. Pat. Nos. 6,630,009 and 6,974,656 are taught to be modified by a ‘diluent’ for purposes of changing the viscosity of the curable resin, these authors teach that the diluent should be also curable and create a cross-linked network under the influence of the UV or heat ‘like the resin’ and therefore are intended to remain in the green body and are functionally and intentionally an integral part of the curable resin. After the curing process, these diluents will remain a part of the green body.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A composition of a flowable but highly viscous paste of particles suitable for a hybrid additive and subtractive manufacturing process is disclosed wherein; the paste is stable and resists settling of the solid components of the paste; the paste undergoes a shear thinning transformation which allows three-dimensional printing through a dispense nozzle; leveling immediately after dispense; the shear thinning of the paste reverses shortly after dispense so that the dispensed paste does not flow and retains features shapes; the paste can be transformed into a substantially solid material by a controlled drying process whereby one or more components are physically removed by volatilization; the said transformed paste is suitable to being machined to a fine finish without fracture or deformation by subtractive processes and; the paste may be sintered in a vacuum or under inert atmosphere whereby all non-particle components not yet removed are burned, oxidized, or volatilized leaving a sintered, solid part. The invention further pertains to pastes of both metals and ceramics and to composites of both metals and ceramics.

An embodiment of the present disclosure is directed to a paste composition that is optimized for a hybrid additive manufacturing process.

The foregoing and/or other aspects and utilities embodied in the present disclosure may be achieved by providing a paste composition for additive manufacturing. The paste composition may include an organic vehicle, and one or more powders dispersed in the organic vehicle. The organic vehicle may include a solvent, a polymeric binder, a thixotropic additive, and a dispersant.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a plot exemplifying the relationship between viscosity and shear upon addition of thixotropic additive, according to embodiments disclosed.

FIG. 2 illustrates a plot exemplifying the relationship between sag and leveling, according to embodiments disclosed.

FIG. 3 illustrates a plot exemplifying the relationship between paste viscosity and levels or degrees of shear during a printing process, according to embodiments disclosed.

FIG. 4 illustrates a plot exemplifying the change in paste viscosity as it is subjected to different levels of shear during the printing process and to solvent evaporation immediately after being deposited.

FIG. 5 illustrates an example of a green body formed by a 3D printing method, according to embodiments disclosed.

It should be noted that some details of the figure have been simplified and are drawn to facilitate understanding of the embodiments rather than to maintain strict structural accuracy, detail, and scale.

### DETAILED DESCRIPTION

### Definitions of Technical Terms

Anti-Cracking Additive: Material that has the property of reducing or preventing cracking or fractures in the green body as compared with the same green body formed without the anti-cracking additive, and optionally has one or more of the following properties: preventing or limiting clogging or obstructions in the paste dispensing system, reducing or preventing bending and warping in the green body, reducing stress in the green body.

Bulk Density: The bulk density is defined as the mass of the powder divided by the total volume it occupies. The total volume includes particle volume, interparticle void volume, and internal pore volume. The density is determined based on the mass of the total volume of the powder in air, unless a medium other than air is specified.

D10: Particle size below which 10% of the particles' volume of a particle population resides.

D50: Particle size below which 50% of the particles' volume of a particle population resides.

D90: Particle size below which 90% of the particles' volume of a particle population resides.

D99: Particle size below which 99% of the particles' volume of a particle population resides.

Dryability: The ability of a material to be dried or to be dryable.

Final Object/Final Part: Final product of the printing process, after sintering. The final object is a sintered body.

Forced Drying: The removal of volatile components, e.g. solvents, from a film under focused or general application of energy by the modes of conduction, convection, and/or radiation.

Green Body: A compact of particles, along with additional organic and inorganics binders and other additives, wherein volatile components have been removed from the compact.

Green Body Density: Density of a green body before being sintered expressed as the percentage of the true (e.g., literature) density of the material that desirably remains after sintering (e.g., absent any residual binders or other materials that are primarily burned away during sintering).

Green Body Shrinkage: Reduction in the green body linear dimensions upon sintering. It is the difference in dimension between the green body and the sintered body, expressed as a percentage of the green body dimension.

High Alloy Steel: Steels that have 8% to 50% alloying elements by weight, based on the total weight of the high alloy steel, where the alloying elements are any elements other than iron. As an example, high alloy steels have 8 to 15% by weight alloy elements.

Layer or Film Roughness: Roughness of a printed layer, defined as the ratio between the average difference between adjacent highest and lowest points (peak to valley) in the layer and the average layer thickness.

Low Alloy Steel: Steels that have less than 8% alloying elements by weight, based on the total weight of the low alloy steel, where the alloying elements are any elements other than iron.

Machinable: The property of being mechanically able to sustain controlled removal of portions of a material body by means of rotary cutting tools (e.g. endmills, grinding bits, etc.). An example of a rotary cutting tool is the Promax end mill of the series US501 made by CERATIZIT Sacramento (Rancho Cordova, Calif.).

Feedstock Particles: Particles that form the principal component of the paste and, after removing the volatile components and after sintering, form the final part. The particles are primarily composed of metals, ceramics or combinations thereof.

Feedstock Paste: Paste in which the principal component, that is the material precursor, are feedstock particles as defined herein.

Particle Size Distribution: List of values that defines the relative amount, by mass or by volume, of particles in a population according to size. Examples of such values are D10, D50, D90 and D99. Particle populations may have monomodal or multimodal particle size distributions. Particle size distributions are monomodal when the plot of the relative amount of particles vs. particle size shows only one maximum. Particle size distributions are multimodal when the plot of the relative amount of particles vs. particle size shows more than one maximum.

Paste Dispensing System: Apparatus in 3D printer used for dispensing/depositing the paste. The dispensing system comprises the lines mechanisms, parts, etc. that deliver the paste from the paste reservoirs to the substrate.

Printing: the controlled deposition of paste onto a substrate into a film (layer) with an arbitrary shape.

Printing Defects: unintentional voids (gaps) or excesses of paste that deviate from the intended printing layer shape.

Shear Thinning Ratio: Ratio of the viscosities measured at low and high shear, for example a shear rate of 2 s-1 and a shear rate of 50 s-1, as measured with a Brookfield DV3T-HB Cone/Plate Rheometer equipped with a cone spindle CP-52.

Sinterability: The ability of a material, e.g. a green body, to be sintered.

Sintered Body: Printed part after it undergoes the sintering process.

Sintered Body Density: Density of the sintered body, expressed as the percentage of the true (e.g., literature) density of the material that desirably remains after sintering (e.g., absent any residual binders or other materials that are primarily burned away during sintering).

Sintering Aid: Material that, because of its reactivity toward other materials in the composition, diffusion rate in other materials, particle size, and/or lower melting point, increases the sintering rate at a given temperature and/or reduces the sintering temperature.

Total Drying: The removal of volatile components, e.g. solvents, from a film until the concentration of volatile components is reduced to less than 5% by weight of the original amount of solvent.

True Density: Intrinsic density of a material (e.g., as reported in the literature).

Unforced Drying: The removal of volatile components, e.g. solvents, from a film without adding energy from external sources.

Vehicle/Organic Vehicle: Liquid or gel-like portion of the paste, typically composed of paste components, other than feedstock particles.

Wet Film: A layer of paste in which the volatile components have not yet been removed by forced drying.

Reference will now be made in detail to embodiments of the present teachings, examples of which are illustrated in the accompanying drawings. In the drawings, like reference numerals have been used throughout to designate identical elements. In the following description, reference is made to the accompanying drawing that forms a part thereof, and in which is shown by way of illustration a specific exemplary embodiment in which the present teachings may be practiced. The following description is, therefore, merely exemplary.

Paste Advantages and Properties

The present disclosure is directed to a paste that has one or more advantages when used for three-dimensional (“3D”) printing, also sometimes referred to herein as additive manufacturing (AM). In an embodiment, the paste is a shear thinning, volatile paste comprising metal or ceramic particles. The paste is designed to have a balance of properties that enable a hybrid additive manufacturing process where a green body is simultaneously printed and machined, followed by a sintering step, for the purpose of making a high precision additively manufactured part. Whereas individual tools that 1) print unmachined green bodies or 2) machine previously printed green bodies, are known in the art, a combined machine that both prints and machines simultaneously is a novel process described in U.S. Pat. No. 10,807,162, the contents of which is incorporated herein by reference in its entirety.

The paste has one or more of the following advantages at various stages of usage in a 3D printing process: the green body can be precision machined readily using standard machine tools; the paste can be printed in a manner that minimizes printing defects; the paste can be printed such that unforced drying minimizes paste film roughness; the paste can be readily dried to form a consistent density green body using forced drying within a window of temperatures and times that are advantageous for layerwise 3D metal printing; the paste can maintain a stable dispersion while in use on a printer, in storage and during transportation for a time scale greater than 10 days.

Paste Advantages and Properties—Paste Stability

Paste stability is defined as the time it takes, under a certain condition, for the paste to significantly change its state of dispersion or composition in a manner which decreases its performance in a 3d printing process. One of the ordinary skill in the art would readily recognize that any change in paste composition is a continuous process rather than a step change and thus a paste is considered stable as long as its composition is within a certain range for a time in which all desired processes can be completed. One of ordinary skill in the art will readily recognize that a paste can be considered stable as long as its properties and the properties of the resulting printed object are within specifications for a time period greater than 10, 20, 30, 60, or 120 days at room temperature and pressure. This time period can be greater, such as more than 30, 60, 90, 120, or 360 days at temperatures below room temperature, such as 2-5° C., or 2-10° C., or 5-10° C., or 5-15° C. It should be appreciated that the determination of whether the paste and/or the resulting printed object are within specification is discussed herein. It should be appreciated that stability may refer to the stability of one or more components of the paste composition. For example, stability may refer to the stability of the organic vehicle. For example, phase separation of the organic vehicle may represent instability in the organic vehicle. In another example, settling of the particles or powders within the organic vehicle may also represent instability of the paste composition.

Since the lifetime of a paste encompasses the time from production to the moment the paste is converted into a printed object, the paste lifetime includes storage, transportation, and deployment in a printer and therefore the paste may be exposed to different environmental conditions. One of ordinary skill in the art will appreciate that the lifetime of a commercial paste can easily be at least several months and therefore stability is an essential feature for a commercial paste. While one can control the conditions at which the paste is exposed to, it is not always feasible to do so at all times.

A paste, defined herein as a mixture of a solid in powder form suspended in a liquid or gel-like organic vehicle, has two main mechanisms that limit its lifetime, chemical reaction and phase separation. One of ordinary skill in the art would recognize that the first degradation mechanism (chemical reaction) can be dealt with by selecting chemically compatible ingredients and avoiding any conditions that can initiate chemical reactions in any of the paste components. The second degradation mechanism (phase separation) is addressed by stopping or slowing down the movement of the paste components relative to each other and thus ensuring that the mixture stays homogeneous. This mechanism is particularly important in pastes formulated with solid particles and organic vehicles that have significantly different specific gravities. In the case the solid particles are heavier than the organic vehicle, this phenomenon is known as particles settling.

Particle settling can be inhibited by increasing the viscosity of the paste. Pastes with high viscosity are more resilient to particle settling than low viscosity pastes, thus are more stable. While the viscosity of a fluid is dependent on the environment conditions, notably temperature (viscosity is typically inversely dependent on temperature), one of ordinary skill in the art would readily appreciate that it is not always possible to keep a paste at the temperature at which it is stable, especially while being deployed in a printer. On the other hand, the viscosity of a paste can be controlled by the use of ingredients such as binders and rheology modifiers like thixotropic additives (thixotropes).

Adding binders and/or thixotropes to a paste will increase its viscosity and thus its stability. The viscosity increase generated by a thixotropic additive only manifests at low shear, i.e. when the paste is not subjected by any movement. At higher shear, the effect of a thixotropic additive decreases. From a stability point of view, both binders and thixotropic additives achieve the same beneficial effect as the viscosity relevant to the long-term stability of a paste is at low shear, i.e. when the paste is stationary. On the other hand, the viscosity beneficial effect induced by a thixotropic additive only applies at low shear, i.e. when it's relevant for paste stability, but disappears, or becomes less pronounced, in other conditions. This behavior can be particularly advantageous in cases where it is desirable to have a low viscosity paste in other situations other than storage, e.g. while being dispensed. In several embodiments of this invention, the paste only has the high viscosity required for stability at low shear and its viscosity drops when subjected to high shear.

In some embodiments, the paste comprises at least one binder and at least one thixotropic additive so that the paste will benefit from the stability caused by high viscosity at low shear, the lower viscosity at higher shear induced by the thixotropic additive and the other beneficial effects caused by the binder as described hereinafter.

Particle settling can also be caused by particles sticking together to form large agglomerates that can no longer be suspended in the paste organic vehicle in a stable fashion. These large agglomerations would then settle faster than non-agglomerated particles thus causing the paste to become unstable.

In some embodiments, the paste comprises a dispersant, which prevents particles from agglomerating, thus enhancing the stability of the paste.

Paste Advantages and Properties—Paste Printability

The printing of 3D objects with high precision requires a paste that can be printed uniformly with little or no defects. Specifically, a paste with excellent printability properties for 3D printing will have the following properties: good leveling, defect-free printing and ability to print objects with vertical or negative sloped walls without any sag or warp from the desired geometry.

Good leveling properties require a paste that has the ability to reflow so that the valleys and hills of a printed layer (the depressions between adjacent printed lines and the highest point of the printed line cross-section) have the time to even out or level off, forming a layer with uniform thickness. The ability to reflow at a time scale that is useful in a printing process, e.g. between 0.01 second and 1 minute, 0.01 second and 10 seconds, or between 0.01 second and 1 second, requires a paste with low viscosity. Moreover, the time that a paste is allowed to reflow may be further reduced by the unforced drying of the paste, i.e. the evaporation of the solvent without any intentionally added energy, which will cause the paste to quickly become very viscous and thus solidify in place before having the time to reflow to a smooth layer with homogeneous thickness. A paste with very low viscosity would be advantageous because it would be able to reflow before the paste solidifies due to unforced drying.

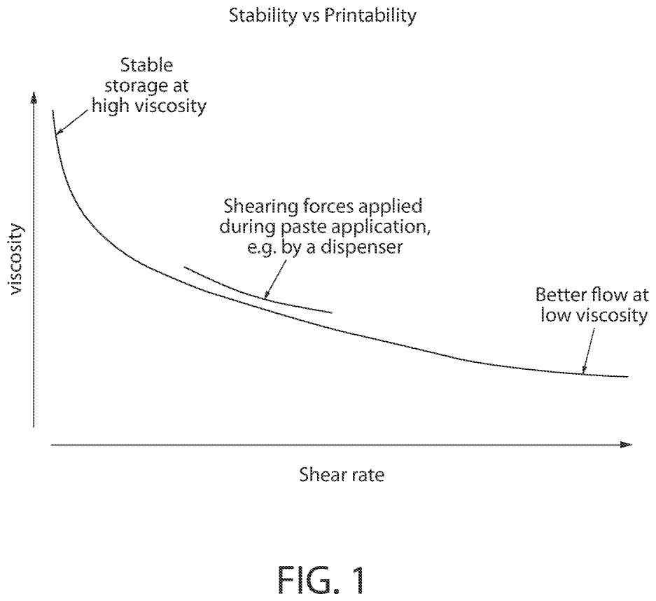

While a paste with low viscosity would exhibit very good leveling properties, it would also be much less stable than a paste with high viscosity as discussed hereinbefore. In at least one embodiment, the paste is formulated with a thixotropic additive so that it exhibits a shear thinning effect as described hereinbefore. This paste would have high viscosity at low shear, and thus be a stable paste, but its viscosity will drop when shear is applied, e.g. while being dispensed. This paste will have a low viscosity as it exits the nozzle of the dispense system, that is while being printed. Thixotropic behavior differs from pseudo-plastic behavior in that a pseudo-plastic paste would display low viscosity when shear is applied, but its viscosity would also immediately raise when the shear is removed, i.e. after the paste is dispensed. A paste with thixotropic behavior would retain the low viscosity for some time after the shear is removed, i.e. its viscosity will take an appreciable amount of time to return to its original value at low shear. A thixotropic behavior would be beneficial because it allows the paste time to reflow as its viscosity remains low for some time after being dispensed. One of ordinary skill in the art would immediately recognize that adding a thixotropic additive to the paste would induce a thixotropic behavior to the paste and thus add a significant benefit in the paste leveling properties and overall printing properties. In at least one embodiment, the paste comprises a thixotropic additive, which will induce high viscosity at low shear and thus high stability against particle settling hence long lifetime. Conversely, it will have low viscosity at high shear with a time lag after the shear is removed, thus allowing the paste to reflow after being dispensed and form a smooth layer with homogeneous thickness. The benefits of adding a thixotropic additive are exemplified in FIG. 1.

Printing without defects, or with very low defect counts, i.e. defect-free printing, is essential for a high precision 3D printing process that can produce objects with expected and uniform material properties such as density, strength, toughness, etc. and with precise dimensions.

A printing defect is herein defined as an area in the printed layer that has no paste, i.e. a “void”. A printing defect is an “unintentional” void and thus it should not be confused with an “intentional” void, which is an area in the printed layer where paste intentionally wasn't deposited.

The causes of printing defects are numerous and can be traced to the printing process, printing parameters, or to the paste's flow behaviors. In one embodiment, a defect is caused by an interruption in paste dispensing. A paste with high viscosity is more susceptible to dispensing interruptions that results in defects and therefore, a low viscosity paste would be advantageous. The use of thixotropic additives for lowering the paste viscosity during the dispensing while keeping the viscosity high during storage has been described hereinbefore.

Paste dispensing interruptions can also be caused by agglomerations in the paste. A paste is essentially a suspension of solid particles in an organic vehicle. When suspended, particles can agglomerate, i.e. stick together to form large collections of individual particles with no organics separating the particles. When such agglomerations become large enough, they can disrupt the flow in the dispense nozzle, which in a high precision printer is small, usually 1 mm or less, in order to allow the printing of small features. Disruptions in the dispense flow can cause interruptions or significant reduction in the printing flow thus generating a defect.

In one embodiment, the paste comprises at least one dispersant, which prevents particles from agglomerating. Agglomerations are formed when the surface of a particle has higher affinity to the surface of another particle than to the organic vehicle in which the particle is suspended. Dispersants are usually molecules or polymers that have a portion with high affinity to the particle surface and another portion with high affinity to the organic vehicle. Therefore, the portion of the dispersant with high particle affinity will coat the particle surface, leaving the other portion of the dispersant, which has high affinity to the vehicle, exposed to the vehicle. Because their surface is now passivated and has better compatibility with the vehicle, the particles exhibit a significantly reduced tendency to form agglomerations.

Another key component of a 3D printing process is the ability to form walls with vertical and negative slopes, which allow printing complex 3D features including channels, pockets and other features that are difficult or impossible to create with standard subtractive manufacturing methods. For a paste to be able to print such complex features without defects, it must resist all sag, which requires the paste to stay fixed in place within a short amount of time after dispensing.

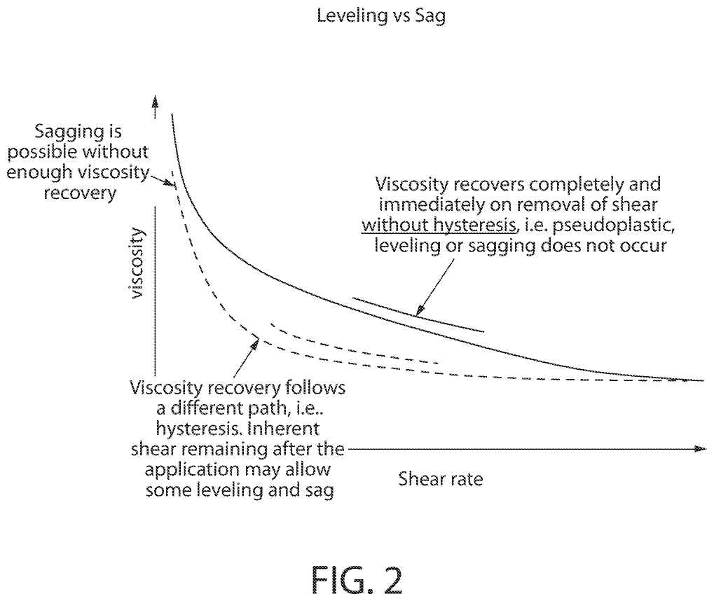

The paste described hereinbefore may have a low viscosity while being dispensed and immediately afterward. A low viscosity paste is conducive to sag. The paste described hereinbefore may also display a thixotropic behavior, which allows for some reflow after being dispensed, as opposed to a pure pseudo-plastic behavior in which the viscosity immediately return to its low shear value once the shear is removed, after the paste is dispensed. While a pseudo-plastic paste would not show any sag in vertical walls and overhang, it also won't be able to reflow and thus won't form a smooth printed layer with uniform thickness. The dichotomy between sag and leveling is exemplified in FIG. 2.

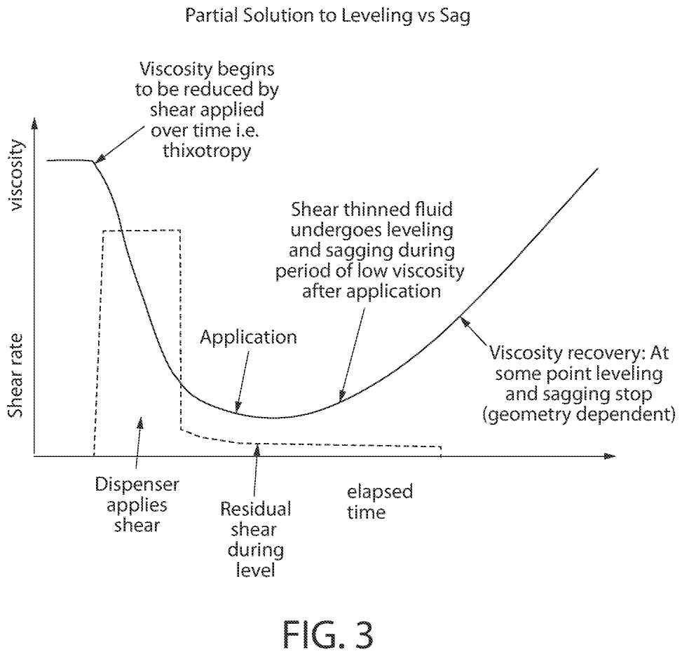

While it would be possible to take advantage of the thixotropic behavior of the paste, the timescale of the viscosity increases after the shear is removed, i.e. after dispensing, which is too long for being useful in preventing sag in overhangs (walls with negative slope). Therefore, it would be difficult to solely rely on the thixotropic behavior to print leveled layers without any sag as exemplified in FIG. 3.

On the other hand, during the unforced drying—the time between the moment the paste is dispensed and the moment the forced drying begins, the paste increases its viscosity due to the removal of at least some of its volatile components, i.e. the solvent, and thus the paste movement greatly decreases until it stops or, in other words, the paste is fixed in place. The time from the moment the paste is dispensed to the moment enough solvent has evaporated for the paste to fix in place depends on the solvent evaporation rate. It is well known in the art that a solvent evaporation rate depends on the solvent boiling point, the solvent vapor pressure and the environment temperature.

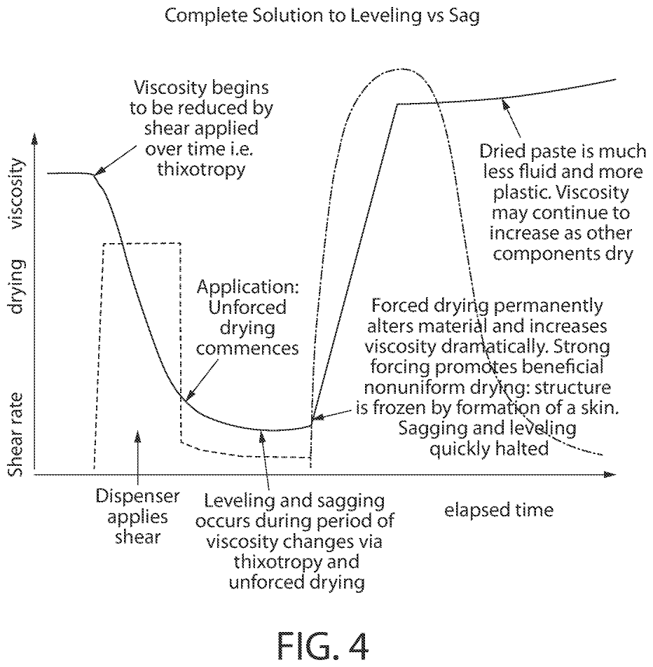

In some embodiments, the solvent of the paste has a relatively high vapor pressure but relatively high boiling point, the combination of which results in an evaporation rate high enough to prevent any sag in vertical walls and overhangs, but not as high to prevent the paste to reflow into a smooth layer with uniform thickness. This embodiment is exemplified in FIG. 4.

Paste Advantages and Properties—Paste Dryability

In an additive manufacturing process that relies on a layer by layer deposition, each layer is printed and subsequently dried before the next layer is deposited. Unless otherwise specified, the drying step comprises an unforced drying step and a forced drying step. In unforced drying, solvent leaves the printed thick film naturally through evaporation at a rate determined by the temperature and air flow in the printing volume. In forced drying, energy is intentionally applied with the specific goal of removing the volatile components of the paste, specifically the solvent. In order for the process to be efficient and able to produce objects with expected and uniform material properties such as density, strength, toughness, etc. and with precise dimensions, the drying step needs to fulfill several requirements. In particular, the drying step needs to be rapid to keep the overall layer deposition time short; it needs to efficiently and completely remove the volatile components without leaving any residual solvent; and it needs to form a printed layer with uniform composition and density and with a consistent composition and density across all layers, so that a homogeneous green body is formed, with little or no volatile components left in it.

Using higher volumetric loadings of metal or ceramic particles can result in faster and more efficient drying. However, excessively high rates of drying result in lower packing densities of the particles, as well as other problems such as inhomogeneity of particle compositions in a resulting dried film. In an embodiment, the total drying time (e.g., time for removing the solvent) ranges from about 10 seconds to about 300 seconds, such that the particles of 1-50 μm have time to pack uniformly due to thermal motion into a dried film between 25-1000 μm, 25-500 μm, 100-500 μm, 25-250 μm, or 100-250 μm. The wet film has a thickness between 50-2000 μm, 50-1000 μm, 200-1000 μm, 50-500 μm, or 200-500 μm.

Forced dry time is the time in which a paste has stopped flowing a substantial lateral distance but is still reducing in thickness due to the removal of volatile components. It is a function of the paste composition, temperature, and the pressure of the local environment. The forced drying time is defined for a single area of deposited wet material, irrespective of lateral heating rates which would increase or decrease the time required to bring an arbitrarily shaped area to the same temperature

The forced drying time for the printed layer is from is to 20 min, from 1 s to 10 min, from 1 s to 2 min, or from 1 s to 1 min. One skilled in the art understands that the drying time, if done with a solvent removal actuator, such as a heating lamp, that moves over the printed layer in passes, depends on the ratio between the area of the printed layer and the area of the actuator.

One of ordinary skill in the art would readily understand that in order to have a short drying time, the volatile components of the paste, such as the solvent, need to have a high evaporation rate at the conditions of the forced drying. In some embodiments, the forced drying comprises actuators which increase the temperature of the wet layer. Therefore, in these embodiments, the solvent may have a fast evaporation rate at said increased temperature. Since the evaporation rate at any given temperature depends on the vapor pressure at said temperature and the boiling point, in some embodiments, the solvent may have a high vapor pressure and a low boiling point, so that the paste has a fast drying time, resulting in a low overall printing time for the 3D object.

Another key feature of the drying step is the ability to efficiently and completely remove the volatile components without leaving any residues. One of ordinary skill in the art would readily appreciate that residues from the drying step, such as volatile components that were not completely removed or decomposition products, could negatively affect the quality of the final, sintered 3D object. Therefore, it would be advantageous to select volatile components, i.e. the solvent, that can be completely removed in a suitable time frame as described hereinbefore with a forced drying energy input that doesn't cause any undesirable decomposition reaction that can leave residues or otherwise negatively affect the non-volatile components. That is, it is desirable to keep the temperature of the wet and dry film low enough to avoid deleterious decomposition of the paste components, unwanted chemical reactions of paste components or undesirable changes in the green body properties. However, the energy input must be high enough to completely remove the volatile components in the desirable timeframe. One of the ordinary skill in the art will readily recognize that only solvents with boiling points below a limit and vapor pressures above another limit are suitable for a paste with the drying properties described hereinbefore.

Another important feature of the drying step is the ability to form a green body with homogeneous composition and density. As described hereinbefore, a paste whose volatile components have low boiling points, high vapor pressure and high evaporation rate would be desirable as they can be easily and completely removed thus ensuring that the resulting green body has uniform composition and density.

On the other hand, if the solvent evaporation rate is too fast, and thus the drying rate is too fast, the particles in a deposited layer of paste don't have time to efficiently pack, leaving voids in the green body and thus a green body with inhomogeneous and/or too low density. Therefore, formulating the paste with a solvent with boiling point and evaporation rate that are low enough for ensuring a fast and complete drying, but high enough that such fast drying is slow enough for allowing the feedstock particles to efficiently pack during the drying step, would be highly advantageous.

In some embodiments, the solvent has a boiling point between 40° C. and 200° C., between 50° C. and 175° C., between 60° C. and 140° C., or between 80° C. and 120° C. In some other embodiments, the solvent has a vapor pressure at 25° C. between 0.01 mmHg and 50 mmHg, between 0.1 mmHg and 40 mmHg, between 1 mmHg and 30 mmHg or between 5 mmHg and 25 mmHg. One of ordinary skill in the art would recognize that one can also tune the boiling point, the vapor pressure and the evaporation rate by mixing different solvents.

The packing of feedstock particles during the paste drying process is not only controlled by the rate of drying, but also by the shape of the feedstock particles. It is known in the art that spherical particles can form better packing than irregularly shaped particles. In some embodiments, the paste feedstock material comprises particles with spherical or spheroidal shape, wherein the ratio between the long and short axis of the particles is from 1 to 2, from 1 to 1.5, or from 1 to 1.2.

One of ordinary skill in the art would immediately recognize that time and shape are not mutually exclusive ways to promote the formation of a homogeneous green body with the desired density, and on the contrary can be advantageously used in a synergistic fashion, in which a paste comprises both spherical or spheroidal feedstock particle and the solvent with the boiling point and vapor pressure described hereinbefore.

Finally, the forced drying step involves the removal of the volatile components of the paste, the solvent, which comprises a substantial portion of the paste volume. Therefore, one of ordinary skill in the art would immediately appreciate that the drying step involves a substantial loss in volume of the wet printed body to form the dry green body. Such loss of volume, or shrinkage, can generate stress in the green body that may result in cracks, fractures, or undesired shape changes such as warping, bending, etc. Therefore, it would be desirable to have a paste that, while drying, can form a green body that has some ductility or plasticity to prevent the formation of cracks or fractures or cause the green body to warp or bend.

In some embodiments, the paste comprises an anti-cracking additive that imparts additional flexibility, ductility, plasticity, or malleability to the green body.

Paste Advantages and Properties—Green Body Machinability

The key component of the hybrid additive manufacturing process is the subtractive portion, in which the green body is machined to selectively remove a portion of the printed green body. In some embodiments, the machining step takes place at the end of the printing step, i.e. when the green body is fully printed, or every n steps during the printing process, where n is from 1 to 1000, from 1 to 100, from 1 to 10, or combinations thereof. A detailed description of the hybrid additive manufacturing process is presented in U.S. Pat. No. 10,807,162, which is herein incorporated by reference.

A hybrid process that produces high precision objects with superior surface finish requires a high precision and defect free machining step, which, in turn, requires a green body with certain material properties that make it machinable. Specifically, a machinable green body needs to have a minimum strength, to have a minimum toughness, and not to be subjected to chipping while being machined.

The one of ordinary skill in the art would understand that the mechanical properties of the green body depend both on the printing and drying conditions as well as on the paste composition, which determines the green body composition and paste drying properties.

The strength of the green body can be increased by additives such as binders. Once the volatile components of the paste have been removed, the binder creates a cohesive network between the feedstock particles that acts as a glue which holds the particles together. Moreover, volatile components that are not fully removed during the drying step can have a detrimental effect on green body strength and thus on its machinability. Therefore, one of ordinary skill in the art would recognize that a fully dried green body with a minimal amount of residual solvents or other residue species has superior machinability properties than a green body that was not completely dried. The choice of solvents that advantageously impact the dryability of the wet printed body has been discussed hereinbefore.

As discussed, the binder is also a rheology modifier and proportionally affects the paste viscosity. While a paste with high binder content may be desirable because it produces green bodies with very high strength, it may also result in a paste with too high of a viscosity for high quality, defect free printing. Therefore, the binder level has a lower and upper limit. The first is determined by the minimum necessary green body strength to be machinable and the latter is determined by the maximum paste viscosity to be printable. Suitable viscosity for printing is described hereinbefore.

In some embodiments, the paste comprises a binder that enables the green body to have a fracture strength of at least 5 MPa.

In order to be machinable, a green body also needs to have a minimum toughness to prevent fracture during the machining step. One of ordinary skill in the art would readily understand that, in order to be tough, a green body needs to be strong, but it also needs to be ductile at the same time. Therefore, green body toughness is a balance between green body strength and green body ductility.

The use of anti-cracking additives in the paste to prevent cracking during the drying step was described hereinbefore. Such anti-cracking additives can be advantageously deployed to promote green body toughness along with binders.

In some embodiments, the paste also comprises an anti-cracking additive that enables the green body to be machined without fractures.

In order to produce an object with sharp corners and edges and superior surface finish, the green body needs to be highly resistant to chipping and pitting. One of ordinary skill in the art will readily understand that a strong and tough green body is also impervious to chipping but will also appreciate that small chips or pits can also be the result of removing large particles during the machining step. Therefore, a paste that can produce a green body that can be machined without pitting or chipping may have an upper limit in the size of the largest feedstock particles and, if necessary, have means to prevent agglomerations of feedstock particles. The advantageous use of dispersant to prevent agglomerations has been presented hereinbefore.

The largest particle size in a population of particles, or particle size distribution, is often defined in the art as the D99, which is the size below which 99% of the particles' volume resides. One of ordinary skill in the art would readily appreciate that it would be advantageous to set an upper limit for the D99 of the feedstock particle size distribution in order to limit the size of pits.

In some embodiments, the paste feedstock particles have a D99 of 100 μm or less, 70 μm or less, or 40 μm or less.

Paste Advantages and Properties—Green Body Sinterability

In the final step of the hybrid additive manufacturing process, the green body is sintered to produce the final object. During the sintering step, the feedstock particles fuse together at temperatures near their melting point and all other components that were not removed during the drying step, such as the binder and other additives, are removed. The sintering step results in a densification of the printed object and thus a shrinkage of the object dimensions. It is highly desirable that the sintered material density is as close as possible to the density of the target material. In some embodiments the sintered material density is 90-100% of the target material true density, 95-98% of the target material true density, or 98-100% of the target material true density. It is also desirable that the sintered material density is uniform throughout the sintered body, i.e. the sintered final object. Finally, it is desirable that the sintered body composition and mechanical properties are as close as possible to that of the target material. The impact of the paste drying properties on green body density and uniformity has been discussed hereinbefore.

In a high precision additive manufacturing process, the dimensions of the final sintered objects need to be as close as possible to target dimensions, which requires the shrinkage to be predictable and uniform in all dimensions. Within a certain relative shrinkage variability, one of ordinary skill in the art would readily appreciate that a green body with high density would require less shrinkage and thus result in higher absolute precision of the sintered body dimensions Therefore, it would be advantageous to deploy a paste that can generate a green body with high density.

Employing particles that are rounded to sphericity as described hereinbefore, can allow for packing densities greater than >66%, or >68%, or >70% to be achieved over such drying times. One of ordinary skill in the art would readily recognize that, for spherical particles of the same size, the maximum packing density achievable is 74% (cubic and hexagonal close packing). Higher packing densities can be achieved by using particles with multimodal distribution, e.g. bimodal or trimodal, that is with two or three different particle sizes, respectively, in which the smaller particles will occupy the interstitial voids in the packing of the larger particles. Close packings of spherical particles have two types of voids, octahedral and tetrahedral voids, or holes. The octahedral holes can be filled with spherical particles with diameters up to 0.414 times the diameter of the close packing spherical particles, while the tetrahedral voids can accommodate spherical particles with diameters up to 0.225 the diameter of the close packing spherical particles. One of the ordinary skill in the art would readily recognize that mixing two powders with two different particle size distribution and the small particles having a D50 of up to 0.4-0.5 times the diameter of the larger particles would achieve a higher density than a monomodal powder, or a mixture of powders with the same particle size distribution. It would also be obvious to one of ordinary skill in the art, that a paste formulated with the mixture of powders described above would enable to print a green body with higher density. In some embodiments, the paste comprises particles with multimodal particle size distribution.

Additionally, one of ordinary skill in the art would also appreciate that particle agglomerations are an impediment to the optimal particle packing described above and thus detrimental to high green body density. The beneficial use of dispersants to prevent particle agglomerations has been described hereinbefore. In some embodiments, the paste comprises a dispersant.

A predictable, uniform, and low shrinkage also require that no volatile components are left in the green body. The advantageous use of solvents that can be effectively and completely removed during the drying step has been described hereinbefore.

To produce a sintered body with targeted composition, density and mechanical properties, it would be advantageous to use binders and additives that do not leave any residue while being removed during the sintering process. In some embodiments, the paste comprises binders and additives that cleanly burn or cleanly decompose during the sintering process leaving little or no residues.

Paste Advantages and Properties—Summary

In a specific embodiment, a paste designed to be used in a hybrid additive manufacturing process that produces 3D objects with high precision and superior surface finish would have the following properties, long term stability, excellent printability and dryability, and able to form a green body with excellent machinability and sinterability properties.

In some embodiments, such paste for hybrid additive manufacturing has thixotropic properties that result in high viscosity at low shear for improved stability and low viscosity at high shear for high quality printing properties, has controlled evaporation rate during unforced drying for high quality printing properties, has fast but controlled evaporation rate during forced drying for short overall printing process and high quality green body formation, allows for complete removal of volatile components and optimal packing of feedstock particles during forced drying for high quality green body formation, forms a green body that is strong and tough for superior machinability, forms a green body with high and uniform density and free of machining defects for the formation of a sintered body with precise, target dimensions, density and mechanical properties.

In some embodiments, such paste for hybrid additive manufacturing comprises feedstock particles with multimodal size distribution, a maximum D99 value and spherical of spheroidal shape to allow for the formation of a green body with high and uniform density and defect-free machinability.

In some other embodiments, the paste for hybrid additive manufacturing also comprises a solvent with a moderate evaporation rate and relatively low boiling point to allow for high quality printing, complete, uniform, and fast drying, and green body machinability.

In yet some other embodiments, the paste for hybrid additive manufacturing further comprises a binder that imparts high green body strength and paste stability.

In some additional embodiments, the paste for hybrid additive manufacturing optionally comprises a thixotropic additive to impart thixotropic properties to the paste.

In some other additional embodiments, the paste for hybrid additive manufacturing optionally comprises a dispersant to prevent particle agglomerations for a defect-free printing and green body machining.

In yet other embodiments, the paste for hybrid additive manufacturing optionally comprises an anti-cracking additive to prevent cracking, fracturing, warping or bending in the green body during drying and machining.

Paste Composition

The paste comprises particles comprising a material chosen from a metal, a ceramic or combinations thereof; a polymeric binder, a solvent or a mixture thereof; a thixotropic additive; a dispersant; an anti-cracking additive and a wetting agent. Polymeric binder, the solvent, the thixotropic additive, the dispersant, the anti-cracking additive and the wetting agent are optional; at least one of these ingredients is employed in the paste. Other optional ingredients include, but are not limited to, rheology modifiers (other than thixotropic additives), surfactants, leveling agents, defoamers, anti-settling agents, anti-flocculant additives, plasticizers, or the like, or a combination thereof.

Paste Composition—Feedstock Particles

The feedstock particles can comprise any suitable metal, ceramic or combinations thereof. Suitable metals include, but are not limited to, iron, iron alloys such as carbon steel, stainless steel, tool steel, titanium, titanium alloys, copper, copper alloys, nickel, nickel alloys, chromium, chromium alloys, cobalt, cobalt alloys, manganese, manganese alloys, zirconium, zirconium alloys, hafnium, hafnium alloys, vanadium, vanadium alloys, niobium, niobium alloys, tantalum, tantalum alloys, molybdenum, molybdenum alloys, tungsten, tungsten alloys, magnesium, magnesium alloys, zinc, zinc alloys, boron, boron alloys, aluminum, aluminum alloys, carbon, silicon, tin, where the alloys comprise mixtures of one or more additional metals chosen from carbon, silicon, iron, titanium, copper, nickel, chromium, cobalt, manganese, molybdenum, vanadium and other metals. In an example, the particles comprise iron and one or more metals chosen from nickel, chromium, cobalt, vanadium, molybdenum and manganese. In an embodiment, the particles can comprise any suitable ceramic. Examples of suitable ceramics include, but are not limited to, metal oxides, aluminum oxide, aluminum nitride, silicon nitride, silicon oxide, aluminum silicon oxides, cerium oxides, boron nitride, boron oxide, silicon carbide, titanium nitride, titanium carbide, titanium oxide, calcium titanate, strontium titanate, barium titanate, zinc oxide, zinc sulfide, zirconium oxide, calcium zirconate, strontium zirconate, barium zirconate, yttrium stabilized zirconium oxide, partially stabilized zirconium oxide, hafnium oxide, tungsten oxide, tungsten carbide, iron oxide, bismuth strontium calcium copper oxide, yttrium barium copper oxide, carbon fiber, and graphite.

Particles of different compositions (e.g., different metals or metal alloys) can be employed in the same paste. For example, the paste can comprise two, three, four or more particles, each type of particle comprising a different composition, where the compositions can be chosen from any of the metals, metal alloys or ceramics described herein.

The particles can have a multimodal particle size distribution, such as a bimodal or trimodal distribution. In an embodiment, the particles comprise small particles and large particles that have a D10, D50 and D90 that are larger than those of the small particles. The small particles have a D10 ranging from about 1 μm to about 10 μm, from about 1 μm to about 8 μm, from about 1 μm to about 5 μm, or from about 1 μm to about 3 μm, a D50 ranging from about 1 μm to about 15 μm, from about 2 μm to about 10 μm, from about 3 μm to about 8 μm, or from about 3 μm to about 5 μm, and a D90 ranging from about 1 μm to about 20 μm, from about 3 μm to about 15 μm, or from about 5 μm to about 10 μm. The large particles have a D10 ranging from about 1 μm to about 20 μm, from about 3 μm to about 15 μm, or from about 5 μm to about 10 μm, a D50 ranging from about 5 μm to about 30 μm, from about 5 μm to about 25 μm, from about 10 μm to about 20 μm, or from about 10 μm to about 15 μm, and a D90 ranging from about 10 μm to about 40 μm, from about 15 μm to about 35 μm, from about 20 μm to about 30 μm, or from about 20 μm to about 25 μm. In another embodiment, the particles comprise medium particles, where the medium particles have D10, D50 and D90 that are between those of the small and large particles. The medium particles have a D10 ranging from about 1 μm to about 10 μm, from about 1 μm to about 8 μm, from about 1 μm to about 5 μm, or from about 1 μm to about 3 μm, a D50 ranging from about 1 μm to about 15 μm, from about 2 μm to about 10 μm, or from about 4 μm to about 8 μm, and a D90 ranging from about 1 μm to about 20 μm, from about 3 μm to about 15 μm, from about 5 μm to about 10 μm, or from about 8 μm to about 10 μm. Further examples of other suitable particle size distributions are disclosed in U.S. Pat. No. 10,087,332, patented on Oct. 2, 2018, and U.S Patent Publication No. 2019/0016904, published on Jan. 17, 2019, the disclosure of both of which are incorporated herein by reference in their entireties.

The particles with different particle size distribution can be of the same or different materials. In some embodiments, the relative amounts of the particles of different materials are tuned to achieve a target composition of the printed and/or sintered object. In other embodiments, the particle size distributions of the particles of different materials can be advantageously tuned, for example to allow for the particle of one material to occupy the interstitial space between the particles of another material and therefore to ensure for a more uniform composition of the final object.

In some embodiments, the particles comprise one or more materials that act as sintering aid by virtue of their reactivity toward other materials in the composition, diffusion rate in other materials, particle size, and/or lower melting points. Examples of sintering aid materials include, but are not limited to, any of the materials described herein. In some embodiments the sintering aid material particles have smaller size distribution and are deployed in lower amounts as compared with the other materials particles.

In some other embodiments, the paste comprises particles of different materials, with different relative amounts and different particle size distributions. The type of materials, their relative volume and/or weight ratios, and their particle size distribution are tuned to attain the desired printability, packing, sintering, and metallurgical properties. One skilled in the art will readily recognize that theoretically there are infinite combinations of mixtures of different materials that contain the same combination of atoms, that is that can form the same material after sintering, but only some combinations (materials, relative ratio, particle size distribution) result in the desired sintered material in an additive manufacturing process. In some embodiments, the material particles comprise metals and metal alloys. Examples of metal and metal alloys powders include, but are not limited to, iron, iron alloys such as carbon steel, stainless steel, tool steel, titanium, titanium alloys, copper, copper alloys, nickel, nickel alloys, chromium, chromium alloys, cobalt, cobalt alloys, manganese, manganese alloys, zirconium, zirconium alloys, hafnium, hafnium alloys, vanadium, vanadium alloys, niobium, niobium alloys, tantalum, tantalum alloys, molybdenum, molybdenum alloys, tungsten, tungsten alloys, magnesium, magnesium alloys, zinc, zinc alloys, boron, boron alloys, aluminum, aluminum alloys, carbon, silicon, tin, where the alloys comprise mixtures of one or more additional metals chosen from carbon, silicon, iron, titanium, copper, nickel, chromium, cobalt, manganese, molybdenum, vanadium, or the like, or a combination thereof.

In at least one embodiment, a paste used in the additive manufacturing of steel objects comprises particles of a low alloy steel with a size distribution D90 of 25 μm or less, D50 between 10 μm and 20 μm, D10 of 10 μm or less, and a relative amount of 50-70% by weight, particles of a high alloy steel with a size distribution D90 of 10 μm or less, D50 between 4 μm and 8 μm, D10 of 5 μm or less and a relative amount of 20-40% by weight, and particles of carbonyl iron as a sintering aid with a size distribution D90 of 10 μm or less, D50 between 3 μm and 8 μm, D10 of 5 μm or less and a relative amount of 5-30% by weight. An alloy steel is defined as a steel with other alloying elements added deliberately in addition to iron and carbon in order to improve its mechanical properties. Common alloying elements include manganese, nickel, chromium, molybdenum, vanadium, silicon, and boron. Less common alloying elements include aluminum, cobalt, copper, cerium, niobium, titanium, tungsten, tin, zinc, lead, and zirconium.

In another embodiment, a paste used in the additive manufacturing of steel objects comprises particles of a low alloy steel with a size distribution of D90 of 25 μm or less, D50 between 10 μm and 20 μm, D10 of 10 μm or less, and a relative amount of 50-70% by weight, nickel particles with a size distribution of D90 of 25 μm or less, D50 between 10 μm and 20 μm, D10 of 10 μm or less, and a relative amount of 10-30% by weight, and particles of carbonyl iron as a sintering aid with a size distribution of D90 of 10 μm or less, D50 between 3 μm and 8 μm, D10 of 5 μm or less, and a relative amount of 5-30% by weight.

In yet another embodiment, a paste used in the additive manufacturing of steel objects comprises particles of a high alloy steel with a size distribution D90 of 25 μm or less, D50 between 10 μm and 20 μm, D10 of 10 μm or less, and a relative amount of 50-70% by weight, particles of a second high alloy steel with a relative amount of 10-40% by weight, and particles of carbonyl iron as a sintering aid with a size distribution D90 of 10 μm or less, D50 between 3 μm and 8 μm, D10 of 5 μm or less, and a relative amount of 5-30% by weight. In a related embodiment, the particles of the second high alloy steel have a size distribution D90 of 10 μm or less, D50 between 4 μm and 8 μm, D10 of 5 μm. In another related embodiment, the particles of the second high alloy steel have a size distribution D90 of 25 μm or less, D50 between 10 μm and 20 μm, D10 of 10 μm or less.

In a similar embodiment, a paste used in the additive manufacturing of steel objects comprises particles of a high alloy steel with a size distribution of D90 of 25 μm or less, D50 between 10 μm and 20 μm, D10 of 10 μm or less, and a relative amount of 50-70% by weight, particles of a second high alloy steel with a size distribution of D90 of 10 μm or less, D50 between 4 μm and 8 μm, D10 of 5 μm, and a relative amount of 10-40% by weight, and particles of a low alloy steel with a size distribution of D90 of 25 μm or less, D50 between 10 μm and 20 μm, D10 of 10 μm or less, and a relative amount of 10-30% by weight.

Paste Composition—Particle Loading

The particles in the paste are in an amount ranging from about 20% by volume to about 80% by volume, such as about 30% to about 70%, about 40% to about 60%, or about 45% to about 55% by volume, based on the total volume of the paste prior to drying. While the industry standard to describe the ingredients quantity in a paste is by weight, one of ordinary skill in the art would readily recognize that the volume percentages of the paste ingredients can be easily converted into weight percentages by means of the paste density, expressed in mass per volume, and the ingredients densities. The density specified herein for the powdered ingredients, such as the metal or ceramic powders, is the particle density or the true density of the powdered solid, as opposed to the bulk density, which measures the average density of a volume of the powder in a specific medium (usually air). Similarly, the volume specified for the powdered materials is the particles volume or the true volume of the powdered solid, as opposed to the bulk volume, which measures the average volume of a certain mass of the powder in a specific medium (usually air). One of ordinary skill in the art would appreciate that two pastes that have the same ingredients but the metal or ceramic material in identical volumetric ratios, as long as their powdered ingredients have the same particle size distributions, are expected to have similar paste properties, such as rheology, printing behavior, and drying behavior, although they may have very different weight percentages of the ingredients. For example, a suspension of 50% iron powder (with density of 7.87 g/cm³) by volume in terpineol (with density of 0.93 g/cm³) and a suspension of 50% boron nitride powder (with density of 2.1 g/cm³) in terpineol are both 50% in volume, but the iron suspension is 89% by weight while the boron nitride suspension is 69% by weight. In some embodiments, the weight percentage of particles is chosen to be as high as possible while keeping all other desired paste properties. To ones ordinarily skilled in the art, it is apparent that the percentage of metal or ceramic particles is inversely proportional to the percentage of other non-particulate components, most of which are removed during the drying process or post printing processes, e.g. de-binding, sintering and/or annealing, etc. Therefore, the percent by weight of metal or ceramic particles can affect the extent of shrinkage during drying, the drying time and green body density. In an embodiment, the percent by volume of metal or ceramic particles in the paste is chosen to be at least 40%, or at least 50% so that the thickness of the deposited paste shrinks by no more than about 50% during the process of drying, which comprises the removal of >90% of the volatile components such as solvent originally contained in a formulation.

In at least one embodiment, the particles in the paste comprise particles of steel, iron, nickel or combination thereof in an amount ranging from about 70% percent by weight to about 97% percent by weight, such as about 80% to about 95%, about 87% to about 93%, or about 89% to about 91% by weight, based on the total weight of the paste prior to drying.

Paste Composition—Solvent

The solvent can include one or more volatile compounds and can be chosen to decrease viscosity and/or to provide a desired evaporation rate and drying time for the paste at the processing temperatures employed during 3D printing, specifically during and immediately after the deposition step and during the drying step. If the evaporation rate is too fast, then insufficient reflow of the paste may occur during and after deposition, which can result in poor leveling of the printed thick films, as well as increased roughness and defects, such as voids. On the other hand, a drying rate that is too slow can undesirably increase drying times, reduce process efficiency or lead to incomplete and uneven drying, which is undesirable as it may result in uneven shrinkage of the green body during sintering. Incomplete drying may also result in reduced or inhomogeneous density of the final product upon sintering, which can negatively affect the mechanical properties of the material. Therefore, a solvent with a suitable drying rate, or evaporation rate, can aid in balancing between the desired amount of flow of the layer during and after deposition and prior to the layer being dried to the point where flow stops, while still providing fast and complete evaporation of the solvent to achieve a dry paste.

In an embodiment, a solvent is selected that has a boiling point that will provide a suitable drying rate, such as a boiling point ranging from 40° C. to 200° C., from 50° C. to 175° C., from 60° C. to 140° C., or from 80° C. to 120° C. Whether or not a boiling point is suitable will depend on, among other things, the drying conditions (e.g., temperature, pressure, or whether or not convective drying is used) employed during the printing process. Solvents with a suitable boiling point can allow drying of a layer having a thickness of up to about 1 mm with thermal flux of about 5 to about 150 kW/m². Complete dryness is achieved when at least 95% of the volatile components are removed.

The vapor pressure for the solvent at 25° C. can range, for example, from about 0.01 mmHg to 50 mmHg, 0.1 mmHg to 40 mmHg, 1 mmHg to 30 mmHg, or 5 mmHg to 25 mmHg. It is important to mention that those values are for the paste solvent, which can be a mixture of solvents or a single solvent. Thus, the desired boiling point and vapor pressure for the paste solvent can be achieved by finding a single pure solvent that already has those values or by mixing two or more solvents whose values are on either side of the desired values.

Suitable solvents can be linear, branched and cyclic hydrocarbons or linear, branched and cyclic oxygenated hydrocarbons, either of which can be aliphatic or aromatic. As examples, the solvent can comprise one or more compounds chosen from alcohols; ethers, ether-alcohols, glycols, glycol ethers, mineral spirits, C5 to C16 hydrocarbons including linear, branched or cyclic alkanes, alkenes, alkynes, any of which can be aliphatic or aromatic), terpenes, terpenoids, esters, acetates, ketones, and so forth. Examples of suitable alcohols include, but are not limited to, ethanol, propanol, isopropanol, 1-butanol, 2-butanol, iso-butanol, 1-pentanol, 2-pentanol, 3-pentanol, iso-pentanol, 2-methyl-butanol, neo-pentanol, 3-methyl-butanol, 2-methyl-butan-2-ol, 1-hexanol, 2-hexanol, 3-hexanol, 2-methyl-pentanol, 3-methyl-pentanol, iso-hexanol, 2-methyl-pentan-2-ol, 3-methyl-pentan-2-ol, 4-methyl-pentan-2-ol, 3-methyl-pentan-3-ol, 3,3-dimethylbutanol, 2,3-dimethylbutan-2-ol, 3,3-dimethylbutan-2-ol, 2-ethyl-butanol, cyclohexanol, all isomers of heptanol, all isomers of octanol, and mixtures of any two or more of these solvent compounds. Examples of glycol ethers include, but are not limited to, ethylene glycol monoethyl ether, ethylene glycol monopropyl ether, propylene glycol monomethyl ether, propylene glycol monomethyl ether acetate, ethylene glycol monobutyl ether, diethylene glycol ethyl ether, dipropylene glycol monomethyl ether and combinations thereof. Examples of acetates and esters include, but are not limited to, propyl acetate, iso-propyl acetate, ethyl butyrate, butyl acetate, iso-butyl acetate, 3-methoxy butyl acetate and combinations thereof. Examples of ketones include, but not limited to, methyl amyl ketone, di-iso-butyl ketone and combinations thereof. Examples of other solvents include, but are not limited to, terpineol, eucalyptol, limonene, pinene, 3-carene, para-cymene, camphene, terpinene, and combinations thereof. In an embodiment, two or more solvent compounds are blended to achieve a solvent with the desired boiling point and vapor pressure, and thereby the desired evaporation rate. Thus, combinations of any two, three or more of the above solvent compounds can be employed to form the solvent.

In an embodiment, the solvent is in an amount ranging from about 10% by volume to about 80% by volume, or about 30% by volume to about 70% by volume, or about 40% by volume to about 60% by volume, or to about 30% by volume to 50% by volume, based on the total volume of the paste.

In at least one embodiment, the particles in the paste comprise particles of steel, iron, nickel or combination thereof, and the solvent is in an amount ranging from about 1% by weight to about 30% by weight, from about 2% by weight to about 20% by weight, from about 5% by weight to about 15% by weight, or from about 6% by weight to about 12% by weight.

Paste Composition—Polymeric Binder

The polymeric binder is included in the paste to stabilize the paste so that any particles comprising metal, which generally have a relatively high density compared to most non-metallic materials, will not settle prior to drying or will settle relatively slowly so as to maintain a homogeneous paste composition. The polymeric binder also provides added strength to any resulting green body formed from the paste during a three-dimensional printing process. The term green body is generally well understood in the art and refers to an object formed from the paste that has been dried to remove a substantial fraction (>70%, >90%, >95%) of solvent or other volatile components but has not yet been sintered. In an example, the polymeric binder is chosen so that a green body formed from the paste is strong enough to be held for machining, but not so hard as to fracture, deform, or otherwise be transformed by cutting forces.

As examples, the polymeric binder can comprise at least one polymer chosen from, for example, polysaccharides such as cellulose, polyalcohols, polyethers, polyamines, polyamides and polyacrylates. Specific examples of polymeric binders include, but are not limited to, polyether imide, polyamide imide, polyether sulfone, polyphenyl sulfone, polyether ketone and polyether ether ketone, polylactic acid, polyvinyl pyrrolidinone, polyacrylic acid, polymethyl methacrylate, polyethylene oxide, polyoxymethylene, ethyl cellulose, methyl cellulose, hydroxy propyl cellulose, hydroxy propyl methyl cellulose, hydroxy ethyl cellulose, cellulose acetate butyrate, polyvinyl alcohol, Combinations of any two, three or more of the above listed polymers can be employed to form the polymeric binder. The polymeric binder is in an amount ranging from about 0.1% by weight to about 10% by weight, such as about 0.2% by weight to about 5% by weight, or about 0.2% by weight to about 1% by weight, based on the total weight of the paste. It would be apparent to one skilled in the art that the amount in weight percent strongly depends on the nature of the particles in the paste, that is their specific gravity. In cases where the particles have high specific gravity, for example in iron or iron alloys pastes, the optimal polymeric binder content by weight will be in a lower range as compared with the optimal polymeric binder content in a paste comprising lower specific gravity particles, for example in the case of ceramic particles.

In an embodiment, the polymeric binder comprises at least one polymer having a thermal decomposition temperature ranging from about 150° C. to about 400° C., where the thermal decomposition temperature is determined at 760 mmHg pressure in air. In an embodiment, the polymeric binder has an oxygen to carbon (“0/C”) atomic ratio ranging from 0.5 to 1.2. Polymers with a relatively high oxygen to carbon ratio, such as cellulose (O/C ratio of about 0.83), polyethylene oxide (O/C ratio of about 0.5), polyvinyl alcohol (O/C ratio of about 0.5), will tend to decompose cleanly during sintering and thereby leave little or no residue, even in environments with reduced oxygen concentration, i.e. oxygen partial pressure less than 160 mmHg. This process of removing the binder in thermal treatments is also known in the art as binder burnout. A binder that leaves little or no residues is said to have a clean burnout. Most of the polymeric binders discussed herein are commercially available in different grades, chain lengths and derivatizations to tailor to the needs of different industries. Examples of commercially available types of cellulose are cellulose ethers and cellulose esters, examples of which include, but are not limited to, methyl cellulose, ethyl cellulose, hydroxyethyl cellulose, hydroxypropyl cellulose, hydroxypropyl methyl cellulose, cellulose acetate butyrate, cellulose acetate propionate; ethyl methyl cellulose, hydroxyethyl methyl cellulose, hydroxyethyl ethyl cellulose, carboxymethyl cellulose. These types of celluloses are tailored to different solvent systems. For example, methyl cellulose and hydroxypropyl methyl cellulose are water soluble, while ethyl cellulose is soluble in organic solvents. Commercial celluloses are available with different polymer molecular weights. The molecular weight of cellulose affects the viscosity of the solution of the binder in a particular solvent. For example, ethyl cellulose is available with various molecular weights. Examples of commercial ethyl celluloses with different molecular weights include, but are not limited to, ethyl cellulose 10 (e.g. ETHOCEL Standard 10), ethyl cellulose 45 (e.g. ETHOCEL Standard 45), ethyl cellulose 100 (e.g. ETHOCEL Standard 100), ethyl cellulose 200 (e.g. ETHOCEL Standard 200), ethyl cellulose 300 (e.g. ETHOCEL Standard 300), The number indicates the viscosity, in mPa·s (also known as cP), of a 5% solution of ethyl cellulose in 80% toluene and 20% ethanol at 25° C. Using binders, such as cellulose, that include oxygen is generally known in applications that require the clean removal, i.e. with little or no carbon residues, of the binder upon thermal treatment, for example in the ceramic industry. In an embodiment, the polymeric binder can decompose in air at 150° C. and leave less than 10% residue by weight. In another embodiment, the polymeric binder can decompose in an inert atmosphere (e.g., nitrogen) at 350° C. or less and leave less than 10% residue by weight.

Paste Composition—Thixotropic Additive

The thixotropic additive, or thixotrope, allows for control of the rheology of the paste. A relatively low viscosity can be beneficial for flow through a 3D print nozzle and reflow upon deposition of the paste on the substrate, thereby allowing for a printed layer with uniform thickness, smooth surface and reduced defects. A relatively high viscosity can avoid settling of particles in the paste during storage and can be useful for printing 3D features with vertical or negative slope walls. For example, the paste can be stable for 1 week, 1 month, 6 months or more than 6 months, with no discernible settling of particles. The use of the thixotropic additive provides both a reduced viscosity at high shear due to shear thinning during printing and an increased viscosity at low shear before and after deposition of the paste, thereby allowing for reduced or no settling of the particles in the paste and the formation of a 3-dimensional object. Moreover, the thixotropic additive introduces time lag between the change in shear and the change in viscosity. The time dependent shear thinning behavior is known in the art as thixotropic behavior. The thixotropic behavior of the paste is desirable especially in the period that immediately follows the flow of the paste through the nozzle. The flow through the nozzle applies high shear to the paste, thus lowering its viscosity. Once the paste exits the nozzle, the shear is suddenly almost completely eliminated. Despite this, the thixotropic behavior of the paste allows for the viscosity to continue to stay low for some time after the paste exits the nozzle, thus enabling the paste to produce a smooth and uniform layer. One skilled in the art will recognize that tuning the thixotropic behavior and the drying rate of the paste is key to achieve a smooth, uniform and defect free layer while allowing for building 3D objects that feature vertical and/or negative slope walls. Different thixotropic additives may produce different thixotropic behavior, ranging from very strong to almost non-existent, but still produce high paste stability and strong shear thinning effects in the paste. Therefore, by carefully choosing the type of thixotropic additive, it is possible to tune the paste for different thixotropic behaviors while still having good printing and stability properties.

Any suitable thixotropic additive, or thixotrope, can be employed, including, for example, thixotropic compounds in the form of small molecules, macromolecules, oligomers, polymers, inorganic material or mixtures thereof. In an embodiment, the thixotropic additive is chosen from compounds comprising castor oil derivatives, modified polyureas, polyamides, polyamide waxes, amides, amide waxes, diamides, diamides of organic acids, reaction products of diamines and organic acids, reaction products of amides, polyurethanes, polyacrylates, silicates, organoclays, phyllosilicates, overbased sulfonates or mixtures of two or more of any of these. Castor oil is mostly composed by a triester of glycerol and ricinoleic acid. Examples of commercially available thixotropes include, but are not limited to, the Thixatrol® series from Elementis (specialty chemicals company headquartered in London UK) and the RHEOBYK series from Altana (chemical company headquartered in Wesel, Germany). Examples of product in the Thixatrol® product line include Thixatrol® P200X and P220X (polyamide wax in xylene), Thixatrol® P240X and P260X (polyamide wax in xylene and alcohols), Thixatrol® ST (modified derivative of castor oil), Thixatrol® GST (modified derivative of castor oil), Thixatrol® TSR (polyester amide in organic solvent), Thixatrol® MAX (reaction mass of: N,N′-ethane-1,2-diylbis(hexanamide), 12-hydroxy-N-[2-[(1-oxyhexyl)-amino]-ethyl]-octadecan-amide and N,N′-ethane-1,2-diylbis(12-hydroxyoctadecanamide)), Thixatrol® AS 8053 (mixture of organic acid diamides), Thixatrol® P200A (polyamide in organic solvent), Thixatrol® P200N (polyamide in ethanol), Thixatrol® P2100W (polyamide in water and propylene glycol monomethyl ether), Thixatrol® PM 8054 (mixture of organic acid diamides), Thixatrol® PM 8056 (mixture of organic acid diamides), Thixatrol® PLUS (reaction product of decanoic acid, 12-hydroxystearic acid and 1,2-ethandiamine), M-P-A 1075 (organic thixotrope in n-butanol), M-P-A 4020 BA (organic rheological additive in n-butyl acetate). Examples of product in the RHEOBYK product line include, but are not limited to, RHEOBYK-100 (mixture of castor oil derivative and amide wax, including N,N′-1,2-ethanediylbis[12-hydroxy-octadecanamide), RHEOBYK-405 (solution of polyhydroxycarboxylic acid amides in organic solvents), RHEOBYK-410 (solution of a modified urea), RHEOBYK-415 (solution of a urea derivative), RHEOBYK-425 (solution of a urea-modified polyurethane), RHEOBYK-430 (solution of a high molecular weight, urea-modified, medium-polarity polyamide), RHEOBYK-440 (solution of a modified polyamide), RHEOBYK-7405 (solution of polyhydroxycarboxylic acid amides), RHEOBYK-7410 ET (solution of a modified urea), RHEOBYK-7420 ES (solution of a modified urea), RHEOBYK-7590 (castor oil derivative), RHEOBYK-7594 (castor oil derivative), RHEOBYK-7600 (solution of a hydrophobic modified polyurethane), RHEOBYK-H 600 (solution of an aminoplast polyethylene glycol).

In an embodiment, the thixotropic additive is in an amount ranging from about 0.01% by weight to about 5% by weight, such as about 0.05% by weight to about 2% by weight, or about 0.1% by weight to about 1% by weight, based on the total weight of the paste. As explained hereinbefore, it would be apparent to the ones skilled in the art that the optimal amount in weight percent strongly depends on the specific gravity of the particles in the paste. The shear thinning ratio induced by the thixotropic additive is about 2 to about 50, such as about 2 to about 20, or about 2 to about 10, for a shear rate of 2 s⁻¹ and a shear rate of 50 s⁻¹, measured with a Brookfield DV3T-HB Cone/Plate Rheometer equipped with a cone spindle CP-52 at 25° C.

The paste is printable through a nozzle of, for example, size 0.5 mm to 1 mm, which applies a shear rate of about 2 to about 1000 s⁻¹, such as about 10 to about 500 s-1 or about 20 to about 100 s⁻¹, inducing a drop in the paste viscosity, that is a shear thinning of the paste. In some embodiments, the shear thinning ratio induced by the nozzle is about 2 to about 10.

Paste Composition—Dispersant

In an embodiment, the paste comprises one or more dispersants. Dispersants are used to prevent particle agglomeration. One of ordinary skill in the art would readily understand that particle agglomeration could potentially result in printing defects, nozzle clogging, roughening of the printed object surface, and paste decomposition through settling, and therefore is undesirable. The strategies for preventing agglomeration are various and include, among others, inducing electrostatic repulsion between the particles or coating the particles' surface with surfactants, thus providing a steric barrier between particles (providing a steric barrier is referred hereinbelow as steric hindrance strategy). One of ordinary skill in the art would readily understand that different strategies employ different types of molecules, but generally the dispersants will have a positive interaction, or affinity, with the particle surface. In the case of metal or ceramic particles, the particle surface will often be an oxide, hydroxide, oxyhydroxide, carbonate, carbide, nitride, sulfide or combination thereof. In case the steric hindrance strategy is employed, the dispersant can also have an affinity with the paste medium, which is dominated by the solvent. The particle surface and the solvent are often chemically different and thus the dispersant is selected to have at least two chemically distinct portions, one portion with an affinity to the particle and one portion with an affinity to the solvent. In other words, the dispersant is a surfactant. In an embodiment, the paste comprises one or more dispersants to allow for an increased amount of material particles in the paste, i.e. higher material particle loading, without causing any agglomeration between the material particles. Higher material particle loading paste can advantageously allow for reduced drying times, which results in faster process time, use of a lower vapor pressure solvent, i.e. less volatile, while keeping essentially the same drying times, more uniform drying, which results in a more uniform green body, and/or higher green body density, which results in lower shrinkage during the sintering step. One skilled in the art will readily understand that higher particle loading, and its associated benefits, can be also achieved without the deployment of dispersants, but by carefully optimizing the paste composition and the choice of its components. Dispersants are typically polymers or high molecular weight molecules with high affinity to the dispersion medium (e.g. polyols, polyesters, polyamines, polyamides, long-chain alcohols, long-chain carboxylic acids, etc.) and specific functional groups with high affinity to the particles surface (e.g. phosphate esters, carboxyl groups, salts of carboxyl groups, amino groups, etc.). Examples of commercially available dispersants include, but are not limited to members of the Solsperse™ series sold by Lubrizol (headquartered in Wickliffe, Ohio) and the Disperbyk series sold by from Altana (headquartered in Wesel, Germany), e.g. Solsperse™ 3000, Solsperse™ 8000, Solsperse™ 26000, Solsperse™ 36000 (polyester), Solsperse™ 36600, Solsperse™ 38500, Solsperse™ 41000 (polymeric alkoxylate), Solsperse™ 45000 (polymeric alkoxylate), Solsperse™ 64000 (mixture of polyether and polyether ester), Solsperse™ 65000 (phosphate ester), Solsperse™ 66000 (polymeric alkoxylate), Solsperse™ 67000 (polyether ester), Solsperse™ 71000, Solsperse™ 74000, Solsperse™ 84500, Solsperse™ 85000 (phosphodiester polymer), Solsperse™ 86000, Disperbyk-101 (solution of a salt of long-chain polyamine amides and a polar acidic polyester), Disperbyk-102 (copolymer with acidic groups), Disperbyk-106 (salt of a polymer with acidic groups), Disperbyk-108 (hydroxy-functional carboxylic acid ester with pigment-affinic groups), Disperbyk-109 (high molecular weight alkylolamino amide), Disperbyk-111 (copolymer with acidic groups), Disperbyk-118 (Linear polymer with highly polar, different pigment-affinic groups), Disperbyk-167 (solution of a high molecular weight block copolymer with pigment affinic groups), Disperbyk-180 (alkylol ammonium salt of a copolymer with acidic groups), Disperbyk-182 (solution of a high molecular weight block copolymer with pigment affinic groups), Disperplast-1142 (polar, acidic ester of long-chain alcohols), Disperplast-1150 (polar, acidic ester of long-chain alcohols), and Disperplast-1180 (carboxylic acid derivatives with wetting properties). One of ordinary skill in the art would readily understand that because the dispersant interacts with the particle surface, the amount of dispersant employed to achieve the desired effect strongly depends on the total surface area of the metal or ceramic particles in the paste. The dispersant, or its active component, is in an amount ranging from about 0.01% by weight to about 10% by weight, such as about 0.01% by weight to about 5% by weight, about 0.01% by weight to about 1% by weight or about 0.01% by weight to about 0.1% by weight, based on the total weight of the paste.

Paste Composition—Anti-Cracking Additive

In an embodiment, the paste comprises one or more anti-cracking additives. anti-cracking additives are used to add some plasticity to the printed object after drying and can be advantageously used for preventing cracking, bending or warping during the drying process. Anti-cracking additives are typically organic compounds that, at room temperature, are solid and relatively soft. Examples of anti-cracking additives include, but are not limited to, small organic molecules, e.g. menthol, camphor; a subset of short chain cellulose esters, e.g. cellulose acetate, cellulose acetate butyrate, cellulose acetate propionate; cellulose ethers, e.g. methyl cellulose, ethyl cellulose, ethyl methyl cellulose, hydroxyethyl cellulose, hydroxypropyl cellulose, hydroxyethyl methyl cellulose, hydroxypropyl methyl cellulose, hydroxyethyl ethyl cellulose, carboxymethyl cellulose; ethoxylated fatty alcohols, i.e. ethoxylated lauryl alcohol (also known as polyoxyethylene lauryl ether), ethoxylated cetyl alcohol (also known as polyoxyethylene cetyl ether), ethoxylated oleyl alcohol (also known as polyoxyethylene oleyl ether), ethoxylated stearyl alcohol (also known as polyoxyethylene stearyl ether); ethoxylated fatty acids, i.e. ethoxylated lauric acid, ethoxylated palmitic acid, ethoxylated palmitoleic acid, ethoxylated oleic acid, ethoxylated stearic acid; and combinations thereof. Examples of commercially available ethoxylated fatty alcohols include, but are not limited to, members of the BRIJ™ series sold by Croda (headquartered in the United Kingdom).

Other examples of anti-cracking additives include plasticizers, e.g. glycerol, propylene glycol, polyethylene glycol, dimethyl phthalate, diethyl phthalate, dibutyl phthalate, dibutyl sebacate, triethyl citrate, tributyl citrate, triethyl acetyl citrate, triethyl butyl citrate, triacetin, castor oil, acetylated monoglyceride, and combination thereof.

In some embodiments, it is advantageous to use anti-cracking additives that can be easily removed during the post-printing (de-binding, sintering, or annealing) steps without going through a liquid phase, which could cause undesirable deformations in the printed object. For example, it would be advantageous if the anti-cracking additive either sublimes or cleanly burns away during the post-printing steps. In an embodiment, the anti-cracking additive is in an amount ranging from about 0.01% by weight to about 10% by weight, such as about 0.05% by weight to about 5% by weight, or about 0.1% by weight to about 2% by weight, based on the total weight of the paste. Additionally, some anti-cracking additives can limit clogging of the paste dispensing system during printing.

Paste Composition—Wetting Agent

In an embodiment, the paste comprises one or more polysiloxanes. Polysiloxanes are used as wetting agents and/or leveling agents. Polysiloxanes can be advantageously deployed to coat, or “wet”, the surface of the metal or ceramic particles resulting in improved flowing properties of the paste that positively affect the leveling of a printed layer. Among the most widely used polysiloxanes are polydimethylsiloxanes (PDMS), which come with different terminal groups, different chain lengths and different types of copolymers. The general chemical formula of polydimethysiloxane is RO[Si(CH₃)₂O]ₙR with R being the terminal group and n being any integer number equal or larger than 0. In the case of trimethylsiloxy-terminated polydimethylsiloxanes, R═Si(CH₃)₃. Commercially available examples of PDMS include, but are not limited to, the trimethylsiloxy-terminated polydimethylsiloxanes from Gelest (a specialty chemicals company headquartered in Morrisville, Pa.) available with different polymeric chain lengths and thus viscosities ranging from less than 1 cP (DMS-T00) and 1 cP (DMS-T01) to more than 20,000,000 cP (DMS-T72). In an embodiment, the polysiloxane is in an amount ranging from about 0.01% by weight to about 5% by weight, such as about 0.05% by weight to about 2% by weight, or about 0.1% by weight to about 1% by weight, based on the total weight of the paste.

Paste Composition—Other Ingredients

Other ingredients include, but are not limited to, rheology modifiers (other than thixotropic additives), surfactants, leveling agents, defoamers, anti-settling agents, anti-flocculant additives, plasticizers, etc. Examples of commercially available compounds that may be used as other ingredients include, but are not limited to, the Nuospere® (wetting agents), Disponer™ (dispersants), Levaslip™ (leveling agents) and Dapro® (defoamers) product series from Elementis, the Anti-Terra (wetting, dispersing and anti-settling additives), Garamite (rheology modifiers), and Byk (defoamers, surfactants) product series from Altana. Examples of other additives that are commercially available include, but are not limited to, organic waxes, polysiloxanes, phyllosilicates (clays), organoclays, and ammonium salts of organic acids. One of ordinary skill in the art would recognize that the amount of other ingredients in the paste formulation depends on the type of ingredient, its efficacy, and the desired amplitude of its effect on the paste properties. Moreover, many of the commercial additives are not pure active compounds but rather solutions where a solvent is an inactive component of the additive. These additives are typically used in amounts ranging from about 0.01% by weight to about 10% by weight, based on the total weight of the paste.

Metal Paste for Hybrid 3D Printing of a Steel Part

In one embodiment the paste comprises a powder of a first metal, a powder of a second metal, a polymeric binder, a solvent, a thixotropic additive and a dispersant. The first metal powder comprises a steel powder (steel is defined as an iron based alloy) and has a particle size distribution defined by a D99 of less than 40 μm, a D90 between 20 and 30 μm, a D50 between 10 and 20 μm and a D10 of maximum 10 μm. The first metal powder comprises iron and at least one other element from the list of chromium, nickel, molybdenum, vanadium, manganese, silicon and carbon. In one embodiment, the first powder may be a low alloy steel powder. The second metal powder comprises an iron powder with a particle size distribution defined by a D90 of maximum 15 μm, a D50 between 3 and 8 μm and a D10 of maximum 5 μm. The total metal content in the paste is between 30% and 60% by volume (between 80% and 93% by weight). The ratio of the iron powder in relation to the total metal content may be between 1% and 50%, between 1% and 25%, or between 5% and 15% by volume.

The polymeric binder comprises a cellulose based polymer, a cellulose ether, a cellulose ether soluble in organic solvents, or a cellulose ether soluble in the paste solvent. The polymeric binder content in the paste is between 1% and 10% by volume, or between 2% and 5%.

The solvent comprises at least one organic compound. The boiling point of the solvent is between 40° C. and 200° C., between 50° C. and 175° C., or between 80° C. and 120° C. The vapor pressure of the solvent is between 0.01 and 50 mmHg at 25° C., between 1 and 30 mmHg at 25° C., or between 5 and 25 mmHg at 25° C. The solvent content in the paste is between 30% and 70% by volume, or between 30% and 50%.

The thixotropic additive comprises an amide, such as an organic acid diamide. The thixotropic additive content in the paste is between 0.01% and 5%, between 0.1% and 2.5%, or between 0.5% and 2%, by volume.

The dispersant comprises an organic polymer, such as a polymeric alkoxylate. The dispersant content in the paste is between 0.01% and 2%, between 0.05% and 1%, or between 0.1% and 1.0% by volume.

In a related embodiment, the paste further comprises a third metal powder. The third metal powder comprises a steel powder. In one embodiment, the third metal powder has the same particle size distribution of the first metal powder. In another embodiment, the third metal powder has the same particle size distribution of the second metal powder. The third metal powder comprises iron and at least one other element from the list of chromium, nickel, molybdenum, vanadium, manganese, silicon and carbon. In one embodiment, the third metal powder has a different composition than the first metal powder. In one embodiment, the third metal powder may be a high alloy steel powder. The ratio of the third metal powder in relation to the total metal content is between 1% and 50%, between 10% and 40%, or between 20% and 40% by volume.

In a separate set of embodiments, the third metal powder comprises a nickel powder. In one of these separate embodiments, the third metal powder has the same particle size distribution of the first metal powder. In another of these separate embodiments, the third metal powder has the same particle size distribution of the second metal powder. In one of these separate embodiments, the ratio of the third metal powder in relation to the total metal content is between 1% and 50%, between 5% and 40%, or between 10% and 20% by volume. In another of these separate embodiments, the ratio of the second metal powder in relation to the total metal content is between 1% and 50%, between 1% and 30%, or between 10% and 25% by volume.

In yet another related embodiment, the paste further comprises an anti-cracking additive. The anti-cracking additive comprises an organic compound with melting point above 25° C. The anti-cracking additive may be a non-polymeric organic compound, a small molecule (as opposed to macromolecules), or a terpenoid. In a similar embodiment, the anti-cracking additive may be a cellulose based polymer, or a hydroxypropyl cellulose. In another similar embodiment, the anti-cracking additive may be an ethoxylated fatty alcohol. The anti-cracking additive content in the paste is between 0.1% to 10%, 0.2% to 5%, or between 0.5% to 3% by volume.

In some embodiments, the paste has a viscosity ranging from about 10,000 cP to about 200,000 cP at a shear rate of 2 s⁻¹, and a viscosity ranging from about 1000 cP to about 100,000 cP at a shear rate of 50 s⁻¹, as measured at 25° C. with a Brookfield DV3T-HB Cone/Plate Rheometer equipped with a cone spindle CP-52. In some embodiments, the paste has a viscosity ranging from 30,000 cP to 150,000 cP or from 50,000 cP to 100,000 cP at a shear rate of 2 s⁻¹, and a viscosity ranging from 5,000 cP to 50,000 cP or from 10,000 cP to 20,000 cP at a shear rate of 50 s⁻¹, as measured in the same way as described above. By providing for the appropriate shear thinning properties and a solvent with an appropriate boiling point, the paste is formulated to have a desired balance of reflow after deposition and solvent evaporation rate so that it can form a smooth printed layer (good reflow properties) while also allowing for building a 3D object with complex edges, e.g., features with vertical or negative slopes.

Exemplary metal particles or powders contemplated and forming a portion of the present disclosure are illustrated below in Table 1. Table 1 illustrates the type, the elemental composition, and the particle size distribution of each of the respective metal powders listed therein.

TABLE 1

| | | Elemental | | |
|---|---|---|---|---|
| Metal | | Composition | | Particle Size |
| Particle | Type | (wt %) | | Distribution |
| M1 | Low | Fe > | 90%, | D99 ≤ 40 μm, 20 ≤ D90 ≤ 30 μm, |
| | Alloy | Cr < | 5%, | 10 ≤ D50 ≤ 20 μm, D10 ≤10 μm |
| | Steel | V > | 0.5%, | |
| | | Mo > | 1% | |
| M2 | Carbon | Fe > | 95%, | D99 ≤ 40 μm, 20 ≤ D90 ≤ 30 μm, |
| | Steel | Mn > | 0.5%, | 10 ≤ D50 ≤ 20 μm, D10 ≤ 10 μm |
| | | C > | 0.5% | |
| M3 | High | Fe < | 90%, | D99 ≤ 40 μm, 20 ≤ D90 ≤ 30 μm, |
| | Alloy | Cr > | 10% | 10 ≤ D50 ≤ 20 μm, D10 ≤ 10 μm |
| | Steel | | | |
| M4 | High | Fe < | 90%, | D99 ≤35 μm, 15 ≤ D90 ≤ 30 μm, |
| | Alloy | Cr > | 10% | 8 ≤ D50 ≤ 20 μm, D10 ≤8 μm |
| | Steel | | | |
| M5 | High | Fe < | 90%, | D99 ≤ 20 μm, 8 ≤ D90 ≤ 15 μm, |
| | Alloy | Cr > | 10% | 4 ≤ D50 ≤ 8 μm, D10 ≤ 5 μm |
| | Steel | | | |
| M6 | High | Fe < | 90%, | D99 ≤ 15 μm, 5 ≤ D90 ≤ 8 μm, |
| | Alloy | Cr > | 10% | 3 ≤ D50 ≤ 5 μm, D10 ≤3 μm |
| | Steel | | | |
| M7 | Nickel | Ni > | 90% | D99 ≤ 40 μm, 20 ≤ D90 ≤ 30 μm, |
| | | | | 10 ≤ D50 ≤ 20 μm, D10 ≤ 10 μm |
| M8 | Iron | Fe > | 97% | D99 ≤15 μm, D90 ≤ 10 μm, |
| | | | | 3 ≤ D50 ≤ 8 μm, D10 ≤5 μm |
| M9 | Iron | Fe > | 97% | D99 ≤ 20 μm, D90 ≤ 15 μm, |
| | | | | 5 ≤ D50 ≤ 10 μm, D10 ≤5 μm |
| M10 | Carbon | C > | 95% | D90 ≤1 μm |

Exemplary metal particles or powders compositions contemplated and forming a portion of the present disclosure are illustrated below in Table 2. Particularly, Table 2 illustrates exemplary metal powder compositions including varying combinations of the metal particles or powders of Table 1. It should be appreciated that other combinations of metal particles are contemplated and not limited to the disclosure in Table 2.

TABLE 2

| | Metal | Metal | Metal | Metal |
|---|---|---|---|---|
| Metal | Particle 1 | Particle 2 | Particle 3 | Particle 4 |
| Composition | (wt %) | (wt %) | (wt %) | (wt %) |
| MC1 | M1 80-95% | M8 5-20% | | |
| MC2 | M1 80-95% | M9 5-20% | | |
| MC3 | M1 50-70% | M3 20-40% | M8 5-20% | |
| MC4 | M1 50-70% | M3 20-40% | M9 5-20% | |
| MC5 | M1 50-70% | M4 20-40% | M8 5-20% | |
| MC6 | M1 50-70% | M4 20-40% | M9 5-20% | |
| MC7 | M1 50-70% | M5 20-40% | M8 5-20% | |
| MC8 | M1 50-70% | M5 20-40% | M9 5-20% | |
| MC9 | M1 50-70% | M6 20-40% | M8 5-20% | |
| MC10 | M1 50-70% | M6 20-40% | M9 5-20% | |
| MC11 | M1 50-70% | M7 10-20% | M8 10-25% | |
| MC12 | M1 50-70% | M7 10-20% | M9 10-25% | |
| MC13 | M1 50-70% | M7 10-20% | M8 10-25% | M10 0.1-1.0% |
| MC14 | M1 50-70% | M7 10-20% | M9 10-25% | M10 0.1-1.0% |
| MC15 | M2 80-95% | M8 5-20% | | |
| MC16 | M2 80-95% | M9 5-20% | | |
| MC17 | M1 70-90% | M3 10-30% | | |
| MC18 | M1 70-90% | M4 10-30% | | |
| MC19 | M1 70-90% | M5 10-30% | | |
| MC20 | M1 70-90% | M6 10-30% | | |
| MC21 | M2 70-90% | M3 10-30% | | |
| MC22 | M2 70-90% | M4 10-30% | | |
| MC23 | M2 70-90% | M5 10-30% | | |
| MC24 | M2 70-90% | M6 10-30% | | |

Exemplary paste compositions contemplated and forming a portion of the present disclosure are illustrated below in Table 3. Particularly, Table 3 illustrates exemplary paste compositions including one or more metal compositions, solvents, binders, thixotropic additive, dispersants, anti-cracking additives, or a combination thereof. It should be appreciated that other combinations of the metal composition, solvent, binder, thixotropic additive, dispersant, and/or anti-cracking additive are contemplated and not limited to the disclosure in Table 3.

TABLE 3

| | Metal | | | | | Anti-Cracking |
|---|---|---|---|---|---|---|
| Paste | Composition | | Binder | Thixotrope | Dispersant | Additive |
| # | (wt %) | Solvent | (wt %) | (wt %) | (wt %) | (wt %) |
| 1 | MC3 88-92% | 1-Butanol, | Ethyl | Thixatrol | Solsperse | |
| | | balance | cellulose | MAX 0.1- | 41000 0.02- | |
| | | | 0.5-0.9% | 0.4% | 1.0% | |
| 2 | MC7 88-92% | 1-Butanol, | Ethyl | Thixatrol | Solsperse | |
| | | balance | cellulose | MAX 0.1- | 41000 0.02- | |
| | | | 0.5-0.9% | 0.4% | 1.0% | |
| 3 | MC11 88-92% | 1-Butanol, | Ethyl | Thixatrol | Solsperse | |
| | | balance | cellulose | MAX 0.1- | 41000 0.02- | |
| | | | 0.5-0.9% | 0.4% | 1.0% | |
| 4 | MC13 88-92% | 1-Butanol, | Ethyl | Thixatrol | Solsperse | |
| | | balance | cellulose | MAX 0.1- | 41000 0.02- | |
| | | | 0.5-0.9% | 0.4% | 1.0% | |
| 5 | MC3 88-92% | 2-Butanol, | Ethyl | Thixatrol | Solsperse | |
| | | balance | cellulose | MAX 0.1- | 41000 0.02- | |
| | | | 0.5-0.9% | 0.4% | 1.0% | |
| 6 | MC7 88-92% | 2-Butanol, | Ethyl | Thixatrol | Solsperse | |
| | | balance | cellulose | MAX 0.1- | 41000 0.02- | |
| | | | 0.5-0.9% | 0.4% | 1.0% | |
| 7 | MC11 88-92% | 2-Butanol, | Ethyl | Thixatrol | Solsperse | |
| | | balance | cellulose | MAX 0.1- | 41000 0.02- | |
| | | | 0.5-0.9% | 0.4% | 1.0% | |
| 8 | MC13 88-92% | 2-Butanol, | Ethyl | Thixatrol | Solsperse | |
| | | balance | cellulose | MAX 0.1- | 41000 0.02- | |
| | | | 0.5-0.9% | 0.4% | 1.0% | |
| 9 | MC3 88-92% | 2-Pentanol, | Ethyl | Thixatrol | Solsperse | |
| | | balance | cellulose | MAX 0.1- | 41000 0.02- | |
| | | | 0.5-0.9% | 0.4% | 1.0% | |
| 10 | MC7 88-92% | 2-Pentanol, | Ethyl | Thixatrol | Solsperse | |
| | | balance | cellulose | MAX 0.1- | 41000 0.02- | |
| | | | 0.5-0.9% | 0.4% | 1.0% | |
| 11 | MC11 88-92% | 2-Pentanol, | Ethyl | Thixatrol | Solsperse | |
| | | balance | cellulose | MAX 0.1- | 41000 0.02- | |
| | | | 0.5-0.9% | 0.4% | 1.0% | |
| 12 | MC13 88-92% | 2-Pentanol, | Ethyl | Thixatrol | Solsperse | |
| | | balance | cellulose | MAX 0.1- | 41000 0.02- | |
| | | | 0.5-0.9% | 0.4% | 1.0% | |
| 13 | MC3 88-92% | 2-Pentanol/ | Ethyl | Thixatrol | Solsperse | |
| | | 1-pentanol | cellulose | MAX 0.1- | 41000 0.02- | |
| | | 2:1, | 0.5-0.9% | 0.4% | 1.0% | |
| | | balance | | | | |
| 14 | MC7 88-92% | 2-Pentanol/ | Ethyl | Thixatrol | Solsperse | |
| | | 1-pentanol | cellulose | MAX 0.1- | 41000 0.02- | |
| | | 2:1, | 0.5-0.9% | 0.4% | 1.0% | |
| | | balance | | | | |
| 15 | MC11 88-92% | 2-Pentanol/ | Ethyl | Thixatrol | Solsperse | |
| | | 1-pentanol | cellulose | MAX 0.1- | 41000 0.02- | |
| | | 2:1, | 0.5-0.9% | 0.4% | 1.0% | |
| | | balance | | | | |
| 16 | MC13 88-92% | 2-Pentanol/ | Ethyl | Thixatrol | Solsperse | |
| | | 1-pentanol | cellulose | MAX 0.1- | 41000 0.02- | |
| | | 2:1, | 0.5-0.9% | 0.4% | 1.0% | |
| | | balance | | | | |
| 17 | MC3 88-92% | 1-Butanol, | Ethyl | RheoByk- | Solsperse | |
| | | balance | cellulose | 100 0.5- | 41000 0.02- | |
| | | | 0.5-0.9% | 1.0% | 1.0% | |
| 18 | MC7 88-92% | 1-Butanol, | Ethyl | RheoByk- | Solsperse | |
| | | balance | cellulose | 100 0.5- | 41000 0.02- | |
| | | | 0.5-0.9% | 1.0% | 1.0% | |
| 19 | MC11 88-92% | 1-Butanol, | Ethyl | RheoByk- | Solsperse | |
| | | balance | cellulose | 100 0.5- | 41000 0.02- | |
| | | | 0.5-0.9% | 1.0% | 1.0% | |
| 20 | MC13 88-92% | 1-Butanol, | Ethyl | RheoByk- | Solsperse | |
| | | balance | cellulose | 100 0.5- | 41000 0.02- | |
| | | | 0.5-0.9% | 1.0% | 1.0% | |
| 21 | MC3 88-92% | 2-Butanol, | Ethyl | RheoByk- | Solsperse | |
| | | balance | cellulose | 100 0.5- | 41000 0.02- | |
| | | | 0.5-0.9% | 1.0% | 1.0% | |
| 22 | MC7 88-92% | 2-Butanol, | Ethyl | RheoByk- | Solsperse | |
| | | balance | cellulose | 100 0.5- | 41000 0.02- | |
| | | | 0.5-0.9% | 1.0% | 1.0% | |
| 23 | MC11 88-92% | 2-Butanol, | Ethyl | RheoByk- | Solsperse | |
| | | balance | cellulose | 100 0.5- | 41000 0.02- | |
| | | | 0.5-0.9% | 1.0% | 1.0% | |
| 24 | MC13 88-92% | 2-Butanol, | Ethyl | RheoByk- | Solsperse | |
| | | balance | cellulose | 100 0.5- | 41000 0.02- | |
| | | | 0.5-0.9% | 1.0% | 1.0% | |
| 25 | MC3 88-92% | 2-Pentanol, | Ethyl | RheoByk- | Solsperse | |
| | | balance | cellulose | 100 0.5- | 41000 0.02- | |
| | | | 0.5-0.9% | 1.0% | 1.0% | |
| 26 | MC7 88-92% | 2-Pentanol, | Ethyl | RheoByk- | Solsperse | |
| | | balance | cellulose | 100 0.5- | 41000 0.02- | |
| | | | 0.5-0.9% | 1.0% | 1.0% | |
| 27 | MC11 88-92% | 2-Pentanol, | Ethyl | RheoByk- | Solsperse | |
| | | balance | cellulose | 100 0.5- | 41000 0.02- | |
| | | | 0.5-0.9% | 1.0% | 1.0% | |
| 28 | MC13 88-92% | 2-Pentanol, | Ethyl | RheoByk- | Solsperse | |
| | | balance | cellulose | 100 0.5- | 41000 0.02- | |
| | | | 0.5-0.9% | 1.0% | 1.0% | |
| 29 | MC3 88-92% | 2-Pentanol/ | Ethyl | RheoByk- | Solsperse | |
| | | 1-pentanol | cellulose | 100 0.5- | 41000 0.02- | |
| | | 2:1, | 0.5-0.9% | 1.0% | 1.0% | |
| | | balance | | | | |
| 30 | MC7 88-92% | 2-Pentanol/ | Ethyl | RheoByk- | Solsperse | |
| | | 1-pentanol | cellulose | 100 0.5- | 41000 0.02- | |
| | | 2:1, | 0.5-0.9% | 1.0% | 1.0% | |
| | | balance | | | | |
| 31 | MC11 88-92% | 2-Pentanol/ | Ethyl | RheoByk- | Solsperse | |
| | | 1-pentanol | cellulose | 100 0.5- | 41000 0.02- | |
| | | 2:1, | 0.5-0.9% | 1.0% | 1.0% | |
| | | balance | | | | |
| 32 | MC13 88-92% | 2-Pentanol/ | Ethyl | RheoByk- | Solsperse | |
| | | 1-pentanol | cellulose | 100 0.5- | 41000 0.02- | |
| | | 2:1, | 0.5-0.9% | 1.0% | 1.0% | |
| | | balance | | | | |
| 33 | MC3 88-92% | 1-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 34 | MC7 88-92% | 1-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 35 | MC11 88-92% | 1-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 36 | MC13 88-92% | 1-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 37 | MC3 88-92% | 2-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 38 | MC7 88-92% | 2-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 39 | MC11 88-92% | 2-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 40 | MC13 88-92% | 2-Butanol, | Ethyl | Thixatrol | Solsperse | |
| | | balance | cellulose | PM 8054 | 41000 0.02- | |
| | | | 0.5-0.9% | 0.1-0.4% | 1.0% | |
| 41 | MC3 88-92% | 2-Pentanol, | Ethyl | Thixatrol | Solsperse | |
| | | balance | cellulose | PM 8054 | 41000 0.02- | |
| | | | 0.5-0.9% | 0.1-0.4% | 1.0% | |
| 42 | MC7 88-92% | 2-Pentanol, | Ethyl | Thixatrol | Solsperse | |
| | | balance | cellulose | PM 8054 | 41000 0.02- | |
| | | | 0.5-0.9% | 0.1-0.4% | 1.0% | |
| 43 | MC11 88-92% | 2-Pentanol, | Ethyl | Thixatrol | Solsperse | |
| | | balance | cellulose | PM 8054 | 41000 0.02- | |
| | | | 0.5-0.9% | 0.1-0.4% | 1.0% | |
| 44 | MC13 88-92% | 2-Pentanol, | Ethyl | Thixatrol | Solsperse | |
| | | balance | cellulose | PM 8054 | 41000 0.02- | |
| | | | 0.5-0.9% | 0.1-0.4% | 1.0% | |
| 45 | MC3 88-92% | 2-Pentanol/ | Ethyl | Thixatrol | Solsperse | |
| | | 1-pentanol | cellulose | PM 8054 | 41000 0.02- | |
| | | 2:1, | 0.5-0.9% | 0.1-0.4% | 1.0% | |
| | | balance | | | | |
| 46 | MC7 88-92% | 2-Pentanol/ | Ethyl | Thixatrol | Solsperse | |
| | | 1-pentanol | cellulose | PM 8054 | 41000 0.02- | |
| | | 2:1, | 0.5-0.9% | 0.1-0.4% | 1.0% | |
| | | balance | | | | |
| 47 | MC11 88-92% | 2-Pentanol/ | Ethyl | Thixatrol | Solsperse | |
| | | 1-pentanol | cellulose | PM 8054 | 41000 0.02- | |
| | | 2:1, | 0.5-0.9% | 0.1-0.4% | 1.0% | |
| | | balance | | | | |
| 48 | MC13 88-92% | 2-Pentanol/ | Ethyl | Thixatrol | Solsperse | |
| | | 1-pentanol | cellulose | PM 8054 | 41000 0.02- | |
| | | 2:1, | 0.5-0.9% | 0.1-0.4% | 1.0% | |
| | | balance | | | | |
| 49 | MC3 88-92% | 1-Butanol, | Ethyl | M-P-A 1075 | Solsperse | |
| | | balance | cellulose | 0.5-1.0% | 41000 0.02- | |
| | | | 0.5-0.9% | | 1.0% | |
| 50 | MC7 88-92% | 1-Butanol, | Ethyl | M-P-A 1075 | Solsperse | |
| | | balance | cellulose | 0.5-1.0% | 41000 0.02- | |
| | | | 0.5-0.9% | | 1.0% | |
| 51 | MC11 88-92% | 1-Butanol, | Ethyl | M-P-A 1075 | Solsperse | |
| | | balance | cellulose | 0.5-1.0% | 41000 0.02- | |
| | | | 0.5-0.9% | | 1.0% | |
| 52 | MC13 88-92% | 1-Butanol, | Ethyl | M-P-A 1075 | Solsperse | |
| | | balance | cellulose | 0.5-1.0% | 41000 0.02- | |
| | | | 0.5-0.9% | | 1.0% | |
| 53 | MC3 88-92% | 2-Butanol, | Ethyl | M-P-A 1075 | Solsperse | |
| | | balance | cellulose | 0.5-1.0% | 41000 0.02- | |
| | | | 0.5-0.9% | | 1.0% | |
| 54 | MC7 88-92% | 2-Butanol, | Ethyl | M-P-A 1075 | Solsperse | |
| | | balance | cellulose | 0.5-1.0% | 41000 0.02- | |
| | | | 0.5-0.9% | | 1.0% | |
| 55 | MC11 88-92% | 2-Butanol, | Ethyl | M-P-A 1075 | Solsperse | |
| | | balance | cellulose | 0.5-1.0% | 41000 0.02- | |
| | | | 0.5-0.9% | | 1.0% | |
| 56 | MC13 88-92% | 2-Butanol, | Ethyl | M-P-A 1075 | Solsperse | |
| | | balance | cellulose | 0.5-1.0% | 41000 0.02- | |
| | | | 0.5-0.9% | | 1.0% | |
| 57 | MC3 88-92% | 2-Pentanol, | Ethyl | M-P-A 1075 | Solsperse | |
| | | balance | cellulose | 0.5-1.0% | 41000 0.02- | |
| | | | 0.5-0.9% | | 1.0% | |
| 58 | MC7 88-92% | 2-Pentanol, | Ethyl | M-P-A 1075 | Solsperse | |
| | | balance | cellulose | 0.5-1.0% | 41000 0.02- | |
| | | | 0.5-0.9% | | 1.0% | |
| 59 | MC11 88-92% | 2-Pentanol, | Ethyl | M-P-A 1075 | Solsperse | |
| | | balance | cellulose | 0.5-1.0% | 41000 0.02- | |
| | | | 0.5-0.9% | | 1.0% | |
| 60 | MC13 88-92% | 2-Pentanol, | Ethyl | M-P-A 1075 | Solsperse | |
| | | balance | cellulose | 0.5-1.0% | 41000 0.02- | |
| | | | 0.5-0.9% | | 1.0% | |
| 61 | MC3 88-92% | 2-Pentanol/ | Ethyl | M-P-A 1075 | Solsperse | |
| | | 1-pentanol | cellulose | 0.5-1.0% | 41000 0.02- | |
| | | 2:1, | 0.5-0.9% | | 1.0% | |
| | | balance | | | | |
| 62 | MC7 88-92% | 2-Pentanol/ | Ethyl | M-P-A 1075 | Solsperse | |
| | | 1-pentanol | cellulose | 0.5-1.0% | 41000 0.02- | |
| | | 2:1, | 0.5-0.9% | | 1.0% | |
| | | balance | | | | |
| 63 | MC11 88-92% | 2-Pentanol/ | Ethyl | M-P-A 1075 | Solsperse | |
| | | 1-pentanol | cellulose | 0.5-1.0% | 41000 0.02- | |
| | | 2:1, | 0.5-0.9% | | 1.0% | |
| | | balance | | | | |
| 64 | MC13 88-92% | 2-Pentanol/ | Ethyl | M-P-A 1075 | Solsperse | |
| | | 1-pentanol | cellulose | 0.5-1.0% | 41000 0.02- | |
| | | 2:1, | 0.5-0.9% | | 1.0% | |
| | | balance | | | | |
| 65 | MC3 88-92% | 1-Butanol, | Ethyl | Thixatrol | Solsperse | |
| | | balance | cellulose | MAX 0.1- | 85000 0.02- | |
| | | | 0.5-0.9% | 0.4% | 1.0% | |
| 66 | MC7 88-92% | 1-Butanol, | Ethyl | Thixatrol | Solsperse | |
| | | balance | cellulose | MAX 0.1- | 85000 0.02- | |
| | | | 0.5-0.9% | 0.4% | 1.0% | |
| 67 | MC11 88-92% | 1-Butanol, | Ethyl | Thixatrol | Solsperse | |
| | | balance | cellulose | MAX 0.1- | 85000 0.02- | |
| | | | 0.5-0.9% | 0.4% | 1.0% | |
| 68 | MC13 88-92% | 1-Butanol, | Ethyl | Thixatrol | Solsperse | |
| | | balance | cellulose | MAX 0.1- | 85000 0.02- | |
| | | | 0.5-0.9% | 0.4% | 1.0% | |
| 69 | MC3 88-92% | 2-Butanol, | Ethyl | Thixatrol | Solsperse | |
| | | balance | cellulose | MAX 0.1- | 85000 0.02- | |
| | | | 0.5-0.9% | 0.4% | 1.0% | |
| 70 | MC7 88-92% | 2-Butanol, | Ethyl | Thixatrol | Solsperse | |
| | | balance | cellulose | MAX 0.1- | 85000 0.02- | |
| | | | 0.5-0.9% | 0.4% | 1.0% | |
| 71 | MC11 88-92% | 2-Butanol, | Ethyl | Thixatrol | Solsperse | |
| | | balance | cellulose | MAX 0.1- | 85000 0.02- | |
| | | | 0.5-0.9% | 0.4% | 1.0% | |
| 72 | MC13 88-92% | 2-Butanol, | Ethyl | Thixatrol | Solsperse | |
| | | balance | cellulose | MAX 0.1- | 85000 0.02- | |
| | | | 0.5-0.9% | 0.4% | 1.0% | |
| 73 | MC3 88-92% | 2-Pentanol, | Ethyl | Thixatrol | Solsperse | |
| | | balance | cellulose | MAX 0.1- | 85000 0.02- | |
| | | | 0.5-0.9% | 0.4% | 1.0% | |
| 74 | MC7 88-92% | 2-Pentanol, | Ethyl | Thixatrol | Solsperse | |
| | | balance | cellulose | MAX 0.1- | 85000 0.02- | |
| | | | 0.5-0.9% | 0.4% | 1.0% | |
| 75 | MC11 88-92% | 2-Pentanol, | Ethyl | Thixatrol | Solsperse | |
| | | balance | cellulose | MAX 0.1- | 85000 0.02- | |
| | | | 0.5-0.9% | 0.4% | 1.0% | |
| 76 | MC13 88-92% | 2-Pentanol, | Ethyl | Thixatrol | Solsperse | |
| | | balance | cellulose | MAX 0.1- | 85000 0.02- | |
| | | | 0.5-0.9% | 0.4% | 1.0% | |
| 77 | MC3 88-92% | 2-Pentanol/ | Ethyl | Thixatrol | Solsperse | |
| | | 1-pentanol | cellulose | MAX 0.1- | 85000 0.02- | |
| | | 2:1, | 0.5-0.9% | 0.4% | 1.0% | |
| | | balance | | | | |
| 78 | MC7 88-92% | 2-Pentanol/ | Ethyl | Thixatrol | Solsperse | |
| | | 1-pentanol | cellulose | MAX 0.1- | 85000 0.02- | |
| | | 2:1, | 0.5-0.9% | 0.4% | 1.0% | |
| | | balance | | | | |
| 79 | MC11 88-92% | 2-Pentanol/ | Ethyl | Thixatrol | Solsperse | |
| | | 1-pentanol | cellulose | MAX 0.1- | 85000 0.02- | |
| | | 2:1, | 0.5-0.9% | 0.4% | 1.0% | |
| | | balance | | | | |
| 80 | MC13 88-92% | 2-Pentanol/ | Ethyl | Thixatrol | Solsperse | |
| | | 1-pentanol | cellulose | MAX 0.1- | 85000 0.02- | |
| | | 2:1, | 0.5-0.9% | 0.4% | 1.0% | |
| | | balance | | | | |
| 81 | MC3 88-92% | 1-Butanol, | Ethyl | RheoByk- | Solsperse | |
| | | balance | cellulose | 100 0.5- | 85000 0.02- | |
| | | | 0.5-0.9% | 1.0% | 1.0% | |
| 82 | MC7 88-92% | 1-Butanol, | Ethyl | RheoByk- | Solsperse | |
| | | balance | cellulose | 100 0.5- | 85000 0.02- | |
| | | | 0.5-0.9% | 1.0% | 1.0% | |
| 83 | MC11 88-92% | 1-Butanol, | Ethyl | RheoByk- | Solsperse | |
| | | balance | cellulose | 100 0.5- | 85000 0.02- | |
| | | | 0.5-0.9% | 1.0% | 1.0% | |
| 84 | MC13 88-92% | 1-Butanol, | Ethyl | RheoByk- | Solsperse | |
| | | balance | cellulose | 100 0.5- | 85000 0.02- | |
| | | | 0.5-0.9% | 1.0% | 1.0% | |
| 85 | MC3 88-92% | 2-Butanol, | Ethyl | RheoByk- | Solsperse | |
| | | balance | cellulose | 100 0.5- | 85000 0.02- | |
| | | | 0.5-0.9% | 1.0% | 1.0% | |
| 86 | MC7 88-92% | 2-Butanol, | Ethyl | RheoByk- | Solsperse | |
| | | balance | cellulose | 100 0.5- | 85000 0.02- | |
| | | | 0.5-0.9% | 1.0% | 1.0% | |
| 87 | MC11 88-92% | 2-Butanol, | Ethyl | RheoByk- | Solsperse | |
| | | balance | cellulose | 100 0.5- | 85000 0.02- | |
| | | | 0.5-0.9% | 1.0% | 1.0% | |
| 88 | MC13 88-92% | 2-Butanol, | Ethyl | RheoByk- | Solsperse | |
| | | balance | cellulose | 100 0.5- | 85000 0.02- | |
| | | | 0.5-0.9% | 1.0% | 1.0% | |
| 89 | MC3 88-92% | 2-Pentanol, | Ethyl | RheoByk- | Solsperse | |
| | | balance | cellulose | 100 0.5- | 85000 0.02- | |
| | | | 0.5-0.9% | 1.0% | 1.0% | |
| 90 | MC7 88-92% | 2-Pentanol, | Ethyl | RheoByk- | Solsperse | |
| | | balance | cellulose | 100 0.5- | 85000 0.02- | |
| | | | 0.5-0.9% | 1.0% | 1.0% | |
| 91 | MC11 88-92% | 2-Pentanol, | Ethyl | RheoByk- | Solsperse | |
| | | balance | cellulose | 100 0.5- | 85000 0.02- | |
| | | | 0.5-0.9% | 1.0% | 1.0% | |
| 92 | MC13 88-92% | 2-Pentanol, | Ethyl | RheoByk- | Solsperse | |
| | | balance | cellulose | 100 0.5- | 85000 0.02- | |
| | | | 0.5-0.9% | 1.0% | 1.0% | |
| 93 | MC3 88-92% | 2-Pentanol/ | Ethyl | RheoByk- | Solsperse | |
| | | 1-pentanol | cellulose | 100 0.5- | 85000 0.02- | |
| | | 2:1, | 0.5-0.9% | 1.0% | 1.0% | |
| | | balance | | | | |
| 94 | MC7 88-92% | 2-Pentanol/ | Ethyl | RheoByk- | Solsperse | |
| | | 1-pentanol | cellulose | 100 0.5- | 85000 0.02- | |
| | | 2:1, | 0.5-0.9% | 1.0% | 1.0% | |
| | | balance | | | | |
| 95 | MC11 88-92% | 2-Pentanol/ | Ethyl | RheoByk- | Solsperse | |
| | | 1-pentanol | cellulose | 100 0.5- | 85000 0.02- | |
| | | 2:1, | 0.5-0.9% | 1.0% | 1.0% | |
| | | balance | | | | |
| 96 | MC13 88-92% | 2-Pentanol/ | Ethyl | RheoByk- | Solsperse | |
| | | 1-pentanol | cellulose | 100 0.5- | 85000 0.02- | |
| | | 2:1, | 0.5-0.9% | 1.0% | 1.0% | |
| | | balance | | | | |
| 97 | MC3 88-92% | 1-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 98 | MC7 88-92% | 1-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 99 | MC11 88-92% | 1-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 100 | MC13 88-92% | 1-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 101 | MC3 88-92% | 2-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 102 | MC7 88-92% | 2-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 103 | MC11 88-92% | 2-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 104 | MC13 88-92% | 2-Butanol, | Ethyl | Thixatrol | Solsperse | |
| | | balance | cellulose | PM 8054 | 85000 0.02- | |
| | | | 0.5-0.9% | 0.1-0.4% | 1.0% | |
| 105 | MC3 88-92% | 2-Pentanol, | Ethyl | Thixatrol | Solsperse | |
| | | balance | cellulose | PM 8054 | 85000 0.02- | |
| | | | 0.5-0.9% | 0.1-0.4% | 1.0% | |
| 106 | MC7 88-92% | 2-Pentanol, | Ethyl | Thixatrol | Solsperse | |
| | | balance | cellulose | PM 8054 | 85000 0.02- | |
| | | | 0.5-0.9% | 0.1-0.4% | 1.0% | |
| 107 | MC11 88-92% | 2-Pentanol, | Ethyl | Thixatrol | Solsperse | |
| | | balance | cellulose | PM 8054 | 85000 0.02- | |
| | | | 0.5-0.9% | 0.1-0.4% | 1.0% | |
| 108 | MC13 88-92% | 2-Pentanol, | Ethyl | Thixatrol | Solsperse | |
| | | balance | cellulose | PM 8054 | 85000 0.02- | |
| | | | 0.5-0.9% | 0.1-0.4% | 1.0% | |
| 109 | MC3 88-92% | 2-Pentanol/ | Ethyl | Thixatrol | Solsperse | |
| | | 1-pentanol | cellulose | PM 8054 | 85000 0.02- | |
| | | 2:1, | 0.5-0.9% | 0.1-0.4% | 1.0% | |
| | | balance | | | | |
| 110 | MC7 88-92% | 2-Pentanol/ | Ethyl | Thixatrol | Solsperse | |
| | | 1-pentanol | cellulose | PM 8054 | 85000 0.02- | |
| | | 2:1, | 0.5-0.9% | 0.1-0.4% | 1.0% | |
| | | balance | | | | |
| 111 | MC11 88-92% | 2-Pentanol/ | Ethyl | Thixatrol | Solsperse | |
| | | 1-pentanol | cellulose | PM 8054 | 85000 0.02- | |
| | | 2:1, | 0.5-0.9% | 0.1-0.4% | 1.0% | |
| | | balance | | | | |
| 112 | MC13 88-92% | 2-Pentanol/ | Ethyl | Thixatrol | Solsperse | |
| | | 1-pentanol | cellulose | PM 8054 | 85000 0.02- | |
| | | 2:1, | 0.5-0.9% | 0.1-0.4% | 1.0% | |
| | | balance | | | | |
| 113 | MC3 88-92% | 1-Butanol, | Ethyl | M-P-A 1075 | Solsperse | |
| | | balance | cellulose | 0.5-1.0% | 85000 0.02- | |
| | | | 0.5-0.9% | | 1.0% | |
| 114 | MC7 88-92% | 1-Butanol, | Ethyl | M-P-A 1075 | Solsperse | |
| | | balance | cellulose | 0.5-1.0% | 85000 0.02- | |
| | | | 0.5-0.9% | | 1.0% | |
| 115 | MC11 88-92% | 1-Butanol, | Ethyl | M-P-A 1075 | Solsperse | |
| | | balance | cellulose | 0.5-1.0% | 85000 0.02- | |
| | | | 0.5-0.9% | | 1.0% | |
| 116 | MC13 88-92% | 1-Butanol, | Ethyl | M-P-A 1075 | Solsperse | |
| | | balance | cellulose | 0.5-1.0% | 85000 0.02- | |
| | | | 0.5-0.9% | | 1.0% | |
| 117 | MC3 88-92% | 2-Butanol, | Ethyl | M-P-A 1075 | Solsperse | |
| | | balance | cellulose | 0.5-1.0% | 85000 0.02- | |
| | | | 0.5-0.9% | | 1.0% | |
| 118 | MC7 88-92% | 2-Butanol, | Ethyl | M-P-A 1075 | Solsperse | |
| | | balance | cellulose | 0.5-1.0% | 85000 0.02- | |
| | | | 0.5-0.9% | | 1.0% | |
| 119 | MC11 88-92% | 2-Butanol, | Ethyl | M-P-A 1075 | Solsperse | |
| | | balance | cellulose | 0.5-1.0% | 85000 0.02- | |
| | | | 0.5-0.9% | | 1.0% | |
| 120 | MC13 88-92% | 2-Butanol, | Ethyl | M-P-A 1075 | Solsperse | |
| | | balance | cellulose | 0.5-1.0% | 85000 0.02- | |
| | | | 0.5-0.9% | | 1.0% | |
| 121 | MC3 88-92% | 2-Pentanol, | Ethyl | M-P-A 1075 | Solsperse | |
| | | balance | cellulose | 0.5-1.0% | 85000 0.02- | |
| | | | 0.5-0.9% | | 1.0% | |
| 122 | MC7 88-92% | 2-Pentanol, | Ethyl | M-P-A 1075 | Solsperse | |
| | | balance | cellulose | 0.5-1.0% | 85000 0.02- | |
| | | | 0.5-0.9% | | 1.0% | |
| 123 | MC11 88-92% | 2-Pentanol, | Ethyl | M-P-A 1075 | Solsperse | |
| | | balance | cellulose | 0.5-1.0% | 85000 0.02- | |
| | | | 0.5-0.9% | | 1.0% | |
| 124 | MC13 88-92% | 2-Pentanol, | Ethyl | M-P-A 1075 | Solsperse | |
| | | balance | cellulose | 0.5-1.0% | 85000 0.02- | |
| | | | 0.5-0.9% | | 1.0% | |
| 125 | MC3 88-92% | 2-Pentanol/ | Ethyl | M-P-A 1075 | Solsperse | |
| | | 1-pentanol | cellulose | 0.5-1.0% | 85000 0.02- | |
| | | 2:1, | 0.5-0.9% | | 1.0% | |
| | | balance | | | | |
| 126 | MC7 88-92% | 2-Pentanol/ | Ethyl | M-P-A 1075 | Solsperse | |
| | | 1-pentanol | cellulose | 0.5-1.0% | 85000 0.02- | |
| | | 2:1, | 0.5-0.9% | | 1.0% | |
| | | balance | | | | |
| 127 | MC11 88-92% | 2-Pentanol/ | Ethyl | M-P-A 1075 | Solsperse | |
| | | 1-pentanol | cellulose | 0.5-1.0% | 85000 0.02- | |
| | | 2:1, | 0.5-0.9% | | 1.0% | |
| | | balance | | | | |
| 128 | MC13 88-92% | 2-Pentanol/ | Ethyl | M-P-A 1075 | Solsperse | |
| | | 1-pentanol | cellulose | 0.5-1.0% | 85000 0.02- | |
| | | 2:1, | 0.5-0.9% | | 1.0% | |
| | | balance | | | | |
| 129 | MC3 88-92% | 1-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 130 | MC7 88-92% | 1-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 131 | MC11 88-92% | 1-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 132 | MC13 88-92% | 1-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 133 | MC3 88-92% | 2-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 134 | MC7 88-92% | 2-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 135 | MC11 88-92% | 2-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 136 | MC13 88-92% | 2-Butanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 137 | MC3 88-92% | 2-Pentanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 138 | MC7 88-92% | 2-Pentanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 139 | MC11 88-92% | 2-Pentanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 140 | MC13 88-92% | 2-Pentanol, | Ethyl | Thixatrol | Solsperse | Polyoxyethylene |
| | | balance | cellulose | MAX 0.1- | 41000 0.02- | cetyl ether 0.1- |
| | | | 0.5-0.9% | 0.4% | 1.0% | 0.5% |
| 141 | MC3 88-92% | 2-Pentanol/ | Ethyl | Thixatrol | Solsperse | Polyoxyethylene |
| | | 1-pentanol | cellulose | MAX 0.1- | 41000 0.02- | cetyl ether 0.1- |
| | | 2:1, | 0.5-0.9% | 0.4% | 1.0% | 0.5% |
| | | balance | | | | |
| 142 | MC7 88-92% | 2-Pentanol/ | Ethyl | Thixatrol | Solsperse | Polyoxyethylene |
| | | 1-pentanol | cellulose | MAX 0.1- | 41000 0.02- | cetyl ether 0.1- |
| | | 2:1, | 0.5-0.9% | 0.4% | 1.0% | 0.5% |
| | | balance | | | | |
| 143 | MC11 88-92% | 2-Pentanol/ | Ethyl | Thixatrol | Solsperse | Polyoxyethylene |
| | | 1-pentanol | cellulose | MAX 0.1- | 41000 0.02- | cetyl ether 0.1- |
| | | 2:1, | 0.5-0.9% | 0.4% | 1.0% | 0.5% |
| | | balance | | | | |
| 144 | MC13 88-92% | 2-Pentanol/ | Ethyl | Thixatrol | Solsperse | Polyoxyethylene |
| | | 1-pentanol | cellulose | MAX 0.1- | 41000 0.02- | cetyl ether 0.1- |
| | | 2:1, | 0.5-0.9% | 0.4% | 1.0% | 0.5% |
| | | balance | | | | |
| 145 | MC3 88-92% | 1-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 146 | MC7 88-92% | 1-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 147 | MC11 88-92% | 1-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 148 | MC13 88-92% | 1-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 149 | MC3 88-92% | 2-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 150 | MC7 88-92% | 2-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 151 | MC11 88-92% | 2-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 152 | MC13 88-92% | 2-Butanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 153 | MC3 88-92% | 2-Pentanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 154 | MC7 88-92% | 2-Pentanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 155 | MC11 88-92% | 2-Pentanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 156 | MC13 88-92% | 2-Pentanol, | Ethyl | RheoByk- | Solsperse | Polyoxyethylene |
| | | balance | cellulose | 100 0.5- | 41000 0.02- | cetyl ether 0.1- |
| | | | 0.5-0.9% | 1.0% | 1.0% | 0.5% |
| 157 | MC3 88-92% | 2-Pentanol/ | Ethyl | RheoByk- | Solsperse | Polyoxyethylene |
| | | 1-pentanol | cellulose | 100 0.5- | 41000 0.02- | cetyl ether 0.1- |
| | | 2:1, | 0.5-0.9% | 1.0% | 1.0% | 0.5% |
| | | balance | | | | |
| 158 | MC7 88-92% | 2-Pentanol/ | Ethyl | RheoByk- | Solsperse | Polyoxyethylene |
| | | 1-pentanol | cellulose | 100 0.5- | 41000 0.02- | cetyl ether 0.1- |
| | | 2:1, | 0.5-0.9% | 1.0% | 1.0% | 0.5% |
| | | balance | | | | |
| 159 | MC11 88-92% | 2-Pentanol/ | Ethyl | RheoByk- | Solsperse | Polyoxyethylene |
| | | 1-pentanol | cellulose | 100 0.5- | 41000 0.02- | cetyl ether 0.1- |
| | | 2:1, | 0.5-0.9% | 1.0% | 1.0% | 0.5% |
| | | balance | | | | |
| 160 | MC13 88-92% | 2-Pentanol/ | Ethyl | RheoByk- | Solsperse | Polyoxyethylene |
| | | 1-pentanol | cellulose | 100 0.5- | 41000 0.02- | cetyl ether 0.1- |
| | | 2:1, | 0.5-0.9% | 1.0% | 1.0% | 0.5% |
| | | balance | | | | |
| 161 | MC3 88-92% | 1-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 162 | MC7 88-92% | 1-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 163 | MC11 88-92% | 1-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 164 | MC13 88-92% | 1-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 165 | MC3 88-92% | 2-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 166 | MC7 88-92% | 2-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 167 | MC11 88-92% | 2-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 168 | MC13 88-92% | 2-Butanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 169 | MC3 88-92% | 2-Pentanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 170 | MC7 88-92% | 2-Pentanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 171 | MC11 88-92% | 2-Pentanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 172 | MC13 88-92% | 2-Pentanol, | Ethyl | Thixatrol | Solsperse | Polyoxyethylene |
| | | balance | cellulose | PM 8054 | 41000 0.02- | cetyl ether 0.1- |
| | | | 0.5-0.9% | 0.1-0.4% | 1.0% | 0.5% |
| 173 | MC3 88-92% | 2-Pentanol/ | Ethyl | Thixatrol | Solsperse | Polyoxyethylene |
| | | 1-pentanol | cellulose | PM 8054 | 41000 0.02- | cetyl ether 0.1- |
| | | 2:1, | 0.5-0.9% | 0.1-0.4% | 1.0% | 0.5% |
| | | balance | | | | |
| 174 | MC7 88-92% | 2-Pentanol/ | Ethyl | Thixatrol | Solsperse | Polyoxyethylene |
| | | 1-pentanol | cellulose | PM 8054 | 41000 0.02- | cetyl ether 0.1- |
| | | 2:1, | 0.5-0.9% | 0.1-0.4% | 1.0% | 0.5% |
| | | balance | | | | |
| 175 | MC11 88-92% | 2-Pentanol/ | Ethyl | Thixatrol | Solsperse | Polyoxyethylene |
| | | 1-pentanol | cellulose | PM 8054 | 41000 0.02- | cetyl ether 0.1- |
| | | 2:1, | 0.5-0.9% | 0.1-0.4% | 1.0% | 0.5% |
| | | balance | | | | |
| 176 | MC13 88-92% | 2-Pentanol/ | Ethyl | Thixatrol | Solsperse | Polyoxyethylene |
| | | 1-pentanol | cellulose | PM 8054 | 41000 0.02- | cetyl ether 0.1- |
| | | 2:1, | 0.5-0.9% | 0.1-0.4% | 1.0% | 0.5% |
| | | balance | | | | |
| 177 | MC3 88-92% | 1-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 178 | MC7 88-92% | 1-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 179 | MC11 88-92% | 1-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 180 | MC13 88-92% | 1-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 181 | MC3 88-92% | 2-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 182 | MC7 88-92% | 2-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 183 | MC11 88-92% | 2-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 184 | MC13 88-92% | 2-Butanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 185 | MC3 88-92% | 2-Pentanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 186 | MC7 88-92% | 2-Pentanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 187 | MC11 88-92% | 2-Pentanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 188 | MC13 88-92% | 2-Pentanol, | Ethyl | M-P-A 1075 | Solsperse | Polyoxyethylene |
| | | balance | cellulose | 0.5-1.0% | 41000 0.02- | cetyl ether 0.1- |
| | | | 0.5-0.9% | | 1.0% | 0.5% |
| 189 | MC3 88-92% | 2-Pentanol/ | Ethyl | M-P-A 1075 | Solsperse | Polyoxyethylene |
| | | 1-pentanol | cellulose | 0.5-1.0% | 41000 0.02- | cetyl ether 0.1- |
| | | 2:1, | 0.5-0.9% | | 1.0% | 0.5% |
| | | balance | | | | |
| 190 | MC7 88-92% | 2-Pentanol/ | Ethyl | M-P-A 1075 | Solsperse | Polyoxyethylene |
| | | 1-pentanol | cellulose | 0.5-1.0% | 41000 0.02- | cetyl ether 0.1- |
| | | 2:1, | 0.5-0.9% | | 1.0% | 0.5% |
| | | balance | | | | |
| 191 | MC11 88-92% | 2-Pentanol/ | Ethyl | M-P-A 1075 | Solsperse | Polyoxyethylene |
| | | 1-pentanol | cellulose | 0.5-1.0% | 41000 0.02- | cetyl ether 0.1- |
| | | 2:1, | 0.5-0.9% | | 1.0% | 0.5% |
| | | balance | | | | |
| 192 | MC13 88-92% | 2-Pentanol/ | Ethyl | M-P-A 1075 | Solsperse | Polyoxyethylene |
| | | 1-pentanol | cellulose | 0.5-1.0% | 41000 0.02- | cetyl ether 0.1- |
| | | 2:1, | 0.5-0.9% | | 1.0% | 0.5% |
| | | balance | | | | |
| 193 | MC3 88-92% | 1-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 194 | MC7 88-92% | 1-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 195 | MC11 88-92% | 1-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 196 | MC13 88-92% | 1-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 197 | MC3 88-92% | 2-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 198 | MC7 88-92% | 2-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 199 | MC11 88-92% | 2-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 200 | MC13 88-92% | 2-Butanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 201 | MC3 88-92% | 2-Pentanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 202 | MC7 88-92% | 2-Pentanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 203 | MC11 88-92% | 2-Pentanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 204 | MC13 88-92% | 2-Pentanol, | Ethyl | Thixatrol | Solsperse | Polyoxyethylene |
| | | balance | cellulose | MAX 0.1- | 85000 0.02- | cetyl ether 0.1- |
| | | | 0.5-0.9% | 0.4% | 1.0% | 0.5% |
| 205 | MC3 88-92% | 2-Pentanol/ | Ethyl | Thixatrol | Solsperse | Polyoxyethylene |
| | | 1-pentanol | cellulose | MAX 0.1- | 85000 0.02- | cetyl ether 0.1- |
| | | 2:1, | 0.5-0.9% | 0.4% | 1.0% | 0.5% |
| | | balance | | | | |
| 206 | MC7 88-92% | 2-Pentanol/ | Ethyl | Thixatrol | Solsperse | Polyoxyethylene |
| | | 1-pentanol | cellulose | MAX 0.1- | 85000 0.02- | cetyl ether 0.1- |
| | | 2:1, | 0.5-0.9% | 0.4% | 1.0% | 0.5% |
| | | balance | | | | |
| 207 | MC11 88-92% | 2-Pentanol/ | Ethyl | Thixatrol | Solsperse | Polyoxyethylene |
| | | 1-pentanol | cellulose | MAX 0.1- | 85000 0.02- | cetyl ether 0.1- |
| | | 2:1, | 0.5-0.9% | 0.4% | 1.0% | 0.5% |
| | | balance | | | | |
| 208 | MC13 88-92% | 2-Pentanol/ | Ethyl | Thixatrol | Solsperse | Polyoxyethylene |
| | | 1-pentanol | cellulose | MAX 0.1- | 85000 0.02- | cetyl ether 0.1- |
| | | 2:1, | 0.5-0.9% | 0.4% | 1.0% | 0.5% |
| | | balance | | | | |
| 209 | MC3 88-92% | 1-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 210 | MC7 88-92% | 1-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 211 | MC11 88-92% | 1-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 212 | MC13 88-92% | 1-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 213 | MC3 88-92% | 2-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 214 | MC7 88-92% | 2-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 215 | MC11 88-92% | 2-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 216 | MC13 88-92% | 2-Butanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 217 | MC3 88-92% | 2-Pentanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 218 | MC7 88-92% | 2-Pentanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 219 | MC11 88-92% | 2-Pentanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 220 | MC13 88-92% | 2-Pentanol, | Ethyl | RheoByk- | Solsperse | Polyoxyethylene |
| | | balance | cellulose | 100 0.5- | 85000 0.02- | cetyl ether 0.1- |
| | | | 0.5-0.9% | 1.0% | 1.0% | 0.5% |
| 221 | MC3 88-92% | 2-Pentanol/ | Ethyl | RheoByk- | Solsperse | Polyoxyethylene |
| | | 1-pentanol | cellulose | 100 0.5- | 85000 0.02- | cetyl ether 0.1- |
| | | 2:1, | 0.5-0.9% | 1.0% | 1.0% | 0.5% |
| | | balance | | | | |
| 222 | MC7 88-92% | 2-Pentanol/ | Ethyl | RheoByk- | Solsperse | Polyoxyethylene |
| | | 1-pentanol | cellulose | 100 0.5- | 85000 0.02- | cetyl ether 0.1- |
| | | 2:1, | 0.5-0.9% | 1.0% | 1.0% | 0.5% |
| | | balance | | | | |
| 223 | MC11 88-92% | 2-Pentanol/ | Ethyl | RheoByk- | Solsperse | Polyoxyethylene |
| | | 1-pentanol | cellulose | 100 0.5- | 85000 0.02- | cetyl ether 0.1- |
| | | 2:1, | 0.5-0.9% | 1.0% | 1.0% | 0.5% |
| | | balance | | | | |
| 224 | MC13 88-92% | 2-Pentanol/ | Ethyl | RheoByk- | Solsperse | Polyoxyethylene |
| | | 1-pentanol | cellulose | 100 0.5- | 85000 0.02- | cetyl ether 0.1- |
| | | 2:1, | 0.5-0.9% | 1.0% | 1.0% | 0.5% |
| | | balance | | | | |
| 225 | MC3 88-92% | 1-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 226 | MC7 88-92% | 1-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 227 | MC11 88-92% | 1-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 228 | MC13 88-92% | 1-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 229 | MC3 88-92% | 2-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 230 | MC7 88-92% | 2-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 231 | MC11 88-92% | 2-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 232 | MC13 88-92% | 2-Butanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 233 | MC3 88-92% | 2-Pentanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 234 | MC7 88-92% | 2-Pentanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 235 | MC11 88-92% | 2-Pentanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 236 | MC13 88-92% | 2-Pentanol, | Ethyl | Thixatrol | Solsperse | Polyoxyethylene |
| | | balance | cellulose | PM 8054 | 85000 0.02- | cetyl ether 0.1- |
| | | | 0.5-0.9% | 0.1-0.4% | 1.0% | 0.5% |
| 237 | MC3 88-92% | 2-Pentanol/ | Ethyl | Thixatrol | Solsperse | Polyoxyethylene |
| | | 1-pentanol | cellulose | PM 8054 | 85000 0.02- | cetyl ether 0.1- |
| | | 2:1, | 0.5-0.9% | 0.1-0.4% | 1.0% | 0.5% |
| | | balance | | | | |
| 238 | MC7 88-92% | 2-Pentanol/ | Ethyl | Thixatrol | Solsperse | Polyoxyethylene |
| | | 1-pentanol | cellulose | PM 8054 | 85000 0.02- | cetyl ether 0.1- |
| | | 2:1, | 0.5-0.9% | 0.1-0.4% | 1.0% | 0.5% |
| | | balance | | | | |
| 239 | MC11 88-92% | 2-Pentanol/ | Ethyl | Thixatrol | Solsperse | Polyoxyethylene |
| | | 1-pentanol | cellulose | PM 8054 | 85000 0.02- | cetyl ether 0.1- |
| | | 2:1, | 0.5-0.9% | 0.1-0.4% | 1.0% | 0.5% |
| | | balance | | | | |
| 240 | MC13 88-92% | 2-Pentanol/ | Ethyl | Thixatrol | Solsperse | Polyoxyethylene |
| | | 1-pentanol | cellulose | PM 8054 | 85000 0.02- | cetyl ether 0.1- |
| | | 2:1, | 0.5-0.9% | 0.1-0.4% | 1.0% | 0.5% |
| | | balance | | | | |
| 241 | MC3 88-92% | 1-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 242 | MC7 88-92% | 1-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 243 | MC11 88-92% | 1-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 244 | MC13 88-92% | 1-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 245 | MC3 88-92% | 2-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 246 | MC7 88-92% | 2-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 247 | MC11 88-92% | 2-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 248 | MC13 88-92% | 2-Butanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 249 | MC3 88-92% | 2-Pentanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 250 | MC7 88-92% | 2-Pentanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 251 | MC11 88-92% | 2-Pentanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 252 | MC13 88-92% | 2-Pentanol, | Ethyl | M-P-A 1075 | Solsperse | Polyoxyethylene |
| | | balance | cellulose | 0.5-1.0% | 85000 0.02- | cetyl ether 0.1- |
| | | | 0.5-0.9% | | 1.0% | 0.5% |
| 253 | MC3 88-92% | 2-Pentanol/ | Ethyl | M-P-A 1075 | Solsperse | Polyoxyethylene |
| | | 1-pentanol | cellulose | 0.5-1.0% | 85000 0.02- | cetyl ether 0.1- |
| | | 2:1, | 0.5-0.9% | | 1.0% | 0.5% |
| | | balance | | | | |
| 254 | MC7 88-92% | 2-Pentanol/ | Ethyl | M-P-A 1075 | Solsperse | Polyoxyethylene |
| | | 1-pentanol | cellulose | 0.5-1.0% | 85000 0.02- | cetyl ether 0.1- |
| | | 2:1, | 0.5-0.9% | | 1.0% | 0.5% |
| | | balance | | | | |
| 255 | MC11 88-92% | 2-Pentanol/ | Ethyl | M-P-A 1075 | Solsperse | Polyoxyethylene |
| | | 1-pentanol | cellulose | 0.5-1.0% | 85000 0.02- | cetyl ether 0.1- |
| | | 2:1, | 0.5-0.9% | | 1.0% | 0.5% |
| | | balance | | | | |
| 256 | MC13 88-92% | 2-Pentanol/ | Ethyl | M-P-A 1075 | Solsperse | Polyoxyethylene |
| | | 1-pentanol | cellulose | 0.5-1.0% | 85000 0.02- | cetyl ether 0.1- |
| | | 2:1, | 0.5-0.9% | | 1.0% | 0.5% |
| | | balance | | | | |
| 257 | MC3 88-92% | 1-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 258 | MC7 88-92% | 1-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 259 | MC11 88-92% | 1-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 260 | MC13 88-92% | 1-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 261 | MC3 88-92% | 2-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 262 | MC7 88-92% | 2-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 263 | MC11 88-92% | 2-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 264 | MC13 88-92% | 2-Butanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 265 | MC3 88-92% | 2-Pentanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 266 | MC7 88-92% | 2-Pentanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 267 | MC11 88-92% | 2-Pentanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 268 | MC13 88-92% | 2-Pentanol, | Ethyl | Thixatrol | Solsperse | Polyoxyethylene |
| | | balance | cellulose | MAX 0.1- | 41000 0.02- | lauryl ether 0.1- |
| | | | 0.5-0.9% | 0.4% | 1.0% | 0.5% |
| 269 | MC3 88-92% | 2-Pentanol/ | Ethyl | Thixatrol | Solsperse | Polyoxyethylene |
| | | 1-pentanol | cellulose | MAX 0.1- | 41000 0.02- | lauryl ether 0.1- |
| | | 2:1, | 0.5-0.9% | 0.4% | 1.0% | 0.5% |
| | | balance | | | | |
| 270 | MC7 88-92% | 2-Pentanol/ | Ethyl | Thixatrol | Solsperse | Polyoxyethylene |
| | | 1-pentanol | cellulose | MAX 0.1- | 41000 0.02- | lauryl ether 0.1- |
| | | 2:1, | 0.5-0.9% | 0.4% | 1.0% | 0.5% |
| | | balance | | | | |
| 271 | MC11 88-92% | 2-Pentanol/ | Ethyl | Thixatrol | Solsperse | Polyoxyethylene |
| | | 1-pentanol | cellulose | MAX 0.1- | 41000 0.02- | lauryl ether 0.1- |
| | | 2:1, | 0.5-0.9% | 0.4% | 1.0% | 0.5% |
| | | balance | | | | |
| 272 | MC13 88-92% | 2-Pentanol/ | Ethyl | Thixatrol | Solsperse | Polyoxyethylene |
| | | 1-pentanol | cellulose | MAX 0.1- | 41000 0.02- | lauryl ether 0.1- |
| | | 2:1, | 0.5-0.9% | 0.4% | 1.0% | 0.5% |
| | | balance | | | | |
| 273 | MC3 88-92% | 1-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 274 | MC7 88-92% | 1-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 275 | MC11 88-92% | 1-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 276 | MC13 88-92% | 1-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 277 | MC3 88-92% | 2-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 278 | MC7 88-92% | 2-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 279 | MC11 88-92% | 2-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 280 | MC13 88-92% | 2-Butanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 281 | MC3 88-92% | 2-Pentanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 282 | MC7 88-92% | 2-Pentanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 283 | MC11 88-92% | 2-Pentanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 284 | MC13 88-92% | 2-Pentanol, | Ethyl | RheoByk- | Solsperse | Polyoxyethylene |
| | | balance | cellulose | 100 0.5- | 41000 0.02- | lauryl ether 0.1- |
| | | | 0.5-0.9% | 1.0% | 1.0% | 0.5% |
| 285 | MC3 88-92% | 2-Pentanol/ | Ethyl | RheoByk- | Solsperse | Polyoxyethylene |
| | | 1-pentanol | cellulose | 100 0.5- | 41000 0.02- | lauryl ether 0.1- |
| | | 2:1, | 0.5-0.9% | 1.0% | 1.0% | 0.5% |
| | | balance | | | | |
| 286 | MC7 88-92% | 2-Pentanol/ | Ethyl | RheoByk- | Solsperse | Polyoxyethylene |
| | | 1-pentanol | cellulose | 100 0.5- | 41000 0.02- | lauryl ether 0.1- |
| | | 2:1, | 0.5-0.9% | 1.0% | 1.0% | 0.5% |
| | | balance | | | | |
| 287 | MC11 88-92% | 2-Pentanol/ | Ethyl | RheoByk- | Solsperse | Polyoxyethylene |
| | | 1-pentanol | cellulose | 100 0.5- | 41000 0.02- | lauryl ether 0.1- |
| | | 2:1, | 0.5-0.9% | 1.0% | 1.0% | 0.5% |
| | | balance | | | | |
| 288 | MC13 88-92% | 2-Pentanol/ | Ethyl | RheoByk- | Solsperse | Polyoxyethylene |
| | | 1-pentanol | cellulose | 100 0.5- | 41000 0.02- | lauryl ether 0.1- |
| | | 2:1, | 0.5-0.9% | 1.0% | 1.0% | 0.5% |
| | | balance | | | | |
| 289 | MC3 88-92% | 1-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 290 | MC7 88-92% | 1-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 291 | MC11 88-92% | 1-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 292 | MC13 88-92% | 1-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 293 | MC3 88-92% | 2-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 294 | MC7 88-92% | 2-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 295 | MC11 88-92% | 2-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 296 | MC13 88-92% | 2-Butanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 297 | MC3 88-92% | 2-Pentanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 298 | MC7 88-92% | 2-Pentanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 299 | MC11 88-92% | 2-Pentanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 300 | MC13 88-92% | 2-Pentanol, | Ethyl | Thixatrol | Solsperse | Polyoxyethylene |
| | | balance | cellulose | PM 8054 | 41000 0.02- | lauryl ether 0.1- |
| | | | 0.5-0.9% | 0.1-0.4% | 1.0% | 0.5% |
| 301 | MC3 88-92% | 2-Pentanol/ | Ethyl | Thixatrol | Solsperse | Polyoxyethylene |
| | | 1-pentanol | cellulose | PM 8054 | 41000 0.02- | lauryl ether 0.1- |
| | | 2:1, | 0.5-0.9% | 0.1-0.4% | 1.0% | 0.5% |
| | | balance | | | | |
| 302 | MC7 88-92% | 2-Pentanol/ | Ethyl | Thixatrol | Solsperse | Polyoxyethylene |
| | | 1-pentanol | cellulose | PM 8054 | 41000 0.02- | lauryl ether 0.1- |
| | | 2:1, | 0.5-0.9% | 0.1-0.4% | 1.0% | 0.5% |
| | | balance | | | | |
| 303 | MC11 88-92% | 2-Pentanol/ | Ethyl | Thixatrol | Solsperse | Polyoxyethylene |
| | | 1-pentanol | cellulose | PM 8054 | 41000 0.02- | lauryl ether 0.1- |
| | | 2:1, | 0.5-0.9% | 0.1-0.4% | 1.0% | 0.5% |
| | | balance | | | | |
| 304 | MC13 88-92% | 2-Pentanol/ | Ethyl | Thixatrol | Solsperse | Polyoxyethylene |
| | | 1-pentanol | cellulose | PM 8054 | 41000 0.02- | lauryl ether 0.1- |
| | | 2:1, | 0.5-0.9% | 0.1-0.4% | 1.0% | 0.5% |
| | | balance | | | | |
| 305 | MC3 88-92% | 1-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 306 | MC7 88-92% | 1-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 307 | MC11 88-92% | 1-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 308 | MC13 88-92% | 1-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 309 | MC3 88-92% | 2-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 310 | MC7 88-92% | 2-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 311 | MC11 88-92% | 2-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 312 | MC13 88-92% | 2-Butanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 313 | MC3 88-92% | 2-Pentanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 314 | MC7 88-92% | 2-Pentanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 315 | MC11 88-92% | 2-Pentanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 316 | MC13 88-92% | 2-Pentanol, | Ethyl | M-P-A 1075 | Solsperse | Polyoxyethylene |
| | | balance | cellulose | 0.5-1.0% | 41000 0.02- | lauryl ether 0.1- |
| | | | 0.5-0.9% | | 1.0% | 0.5% |
| 317 | MC3 88-92% | 2-Pentanol/ | Ethyl | M-P-A 1075 | Solsperse | Polyoxyethylene |
| | | 1-pentanol | cellulose | 0.5-1.0% | 41000 0.02- | lauryl ether 0.1- |
| | | 2:1, | 0.5-0.9% | | 1.0% | 0.5% |
| | | balance | | | | |
| 318 | MC7 88-92% | 2-Pentanol/ | Ethyl | M-P-A 1075 | Solsperse | Polyoxyethylene |
| | | 1-pentanol | cellulose | 0.5-1.0% | 41000 0.02- | lauryl ether 0.1- |
| | | 2:1, | 0.5-0.9% | | 1.0% | 0.5% |
| | | balance | | | | |
| 319 | MC11 88-92% | 2-Pentanol/ | Ethyl | M-P-A 1075 | Solsperse | Polyoxyethylene |
| | | 1-pentanol | cellulose | 0.5-1.0% | 41000 0.02- | lauryl ether 0.1- |
| | | 2:1, | 0.5-0.9% | | 1.0% | 0.5% |
| | | balance | | | | |
| 320 | MC13 88-92% | 2-Pentanol/ | Ethyl | M-P-A 1075 | Solsperse | Polyoxyethylene |
| | | 1-pentanol | cellulose | 0.5-1.0% | 41000 0.02- | lauryl ether 0.1- |
| | | 2:1, | 0.5-0.9% | | 1.0% | 0.5% |
| | | balance | | | | |
| 321 | MC3 88-92% | 1-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 322 | MC7 88-92% | 1-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 323 | MC11 88-92% | 1-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 324 | MC13 88-92% | 1-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 325 | MC3 88-92% | 2-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 326 | MC7 88-92% | 2-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 327 | MC11 88-92% | 2-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 328 | MC13 88-92% | 2-Butanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 329 | MC3 88-92% | 2-Pentanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 330 | MC7 88-92% | 2-Pentanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 331 | MC11 88-92% | 2-Pentanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 332 | MC13 88-92% | 2-Pentanol, | Ethyl | Thixatrol | Solsperse | Polyoxyethylene |
| | | balance | cellulose | MAX 0.1- | 85000 0.02- | lauryl ether 0.1- |
| | | | 0.5-0.9% | 0.4% | 1.0% | 0.5% |
| 333 | MC3 88-92% | 2-Pentanol/ | Ethyl | Thixatrol | Solsperse | Polyoxyethylene |
| | | 1-pentanol | cellulose | MAX 0.1- | 85000 0.02- | lauryl ether 0.1- |
| | | 2:1, | 0.5-0.9% | 0.4% | 1.0% | 0.5% |
| | | balance | | | | |
| 334 | MC7 88-92% | 2-Pentanol/ | Ethyl | Thixatrol | Solsperse | Polyoxyethylene |
| | | 1-pentanol | cellulose | MAX 0.1- | 85000 0.02- | lauryl ether 0.1- |
| | | 2:1, | 0.5-0.9% | 0.4% | 1.0% | 0.5% |
| | | balance | | | | |
| 335 | MC11 88-92% | 2-Pentanol/ | Ethyl | Thixatrol | Solsperse | Polyoxyethylene |
| | | 1-pentanol | cellulose | MAX 0.1- | 85000 0.02- | lauryl ether 0.1- |
| | | 2:1, | 0.5-0.9% | 0.4% | 1.0% | 0.5% |
| | | balance | | | | |
| 336 | MC13 88-92% | 2-Pentanol/ | Ethyl | Thixatrol | Solsperse | Polyoxyethylene |
| | | 1-pentanol | cellulose | MAX 0.1- | 85000 0.02- | lauryl ether 0.1- |
| | | 2:1, | 0.5-0.9% | 0.4% | 1.0% | 0.5% |
| | | balance | | | | |
| 337 | MC3 88-92% | 1-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 338 | MC7 88-92% | 1-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 339 | MC11 88-92% | 1-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 340 | MC13 88-92% | 1-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 341 | MC3 88-92% | 2-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 342 | MC7 88-92% | 2-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 343 | MC11 88-92% | 2-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 344 | MC13 88-92% | 2-Butanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 345 | MC3 88-92% | 2-Pentanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 346 | MC7 88-92% | 2-Pentanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 347 | MC11 88-92% | 2-Pentanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 348 | MC13 88-92% | 2-Pentanol, | Ethyl | RheoByk- | Solsperse | Polyoxyethylene |
| | | balance | cellulose | 100 0.5- | 85000 0.02- | lauryl ether 0.1- |
| | | | 0.5-0.9% | 1.0% | 1.0% | 0.5% |
| 349 | MC3 88-92% | 2-Pentanol/ | Ethyl | RheoByk- | Solsperse | Polyoxyethylene |
| | | 1-pentanol | cellulose | 100 0.5- | 85000 0.02- | lauryl ether 0.1- |
| | | 2:1, | 0.5-0.9% | 1.0% | 1.0% | 0.5% |
| | | balance | | | | |
| 350 | MC7 88-92% | 2-Pentanol/ | Ethyl | RheoByk- | Solsperse | Polyoxyethylene |
| | | 1-pentanol | cellulose | 100 0.5- | 85000 0.02- | lauryl ether 0.1- |
| | | 2:1, | 0.5-0.9% | 1.0% | 1.0% | 0.5% |
| | | balance | | | | |
| 351 | MC11 88-92% | 2-Pentanol/ | Ethyl | RheoByk- | Solsperse | Polyoxyethylene |
| | | 1-pentanol | cellulose | 100 0.5- | 85000 0.02- | lauryl ether 0.1- |
| | | 2:1, | 0.5-0.9% | 1.0% | 1.0% | 0.5% |
| | | balance | | | | |
| 352 | MC13 88-92% | 2-Pentanol/ | Ethyl | RheoByk- | Solsperse | Polyoxyethylene |
| | | 1-pentanol | cellulose | 100 0.5- | 85000 0.02- | lauryl ether 0.1- |
| | | 2:1, | 0.5-0.9% | 1.0% | 1.0% | 0.5% |
| | | balance | | | | |
| 353 | MC3 88-92% | 1-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 354 | MC7 88-92% | 1-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 355 | MC11 88-92% | 1-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 356 | MC13 88-92% | 1-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 357 | MC3 88-92% | 2-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 358 | MC7 88-92% | 2-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 359 | MC11 88-92% | 2-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 360 | MC13 88-92% | 2-Butanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 361 | MC3 88-92% | 2-Pentanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 362 | MC7 88-92% | 2-Pentanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 363 | MC11 88-92% | 2-Pentanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 364 | MC13 88-92% | 2-Pentanol, | Ethyl | Thixatrol | Solsperse | Polyoxyethylene |
| | | balance | cellulose | PM 8054 | 85000 0.02- | lauryl ether 0.1- |
| | | | 0.5-0.9% | 0.1-0.4% | 1.0% | 0.5% |
| 365 | MC3 88-92% | 2-Pentanol/ | Ethyl | Thixatrol | Solsperse | Polyoxyethylene |
| | | 1-pentanol | cellulose | PM 8054 | 85000 0.02- | lauryl ether 0.1- |
| | | 2:1, | 0.5-0.9% | 0.1-0.4% | 1.0% | 0.5% |
| | | balance | | | | |
| 366 | MC7 88-92% | 2-Pentanol/ | Ethyl | Thixatrol | Solsperse | Polyoxyethylene |
| | | 1-pentanol | cellulose | PM 8054 | 85000 0.02- | lauryl ether 0.1- |
| | | 2:1, | 0.5-0.9% | 0.1-0.4% | 1.0% | 0.5% |
| | | balance | | | | |
| 367 | MC11 88-92% | 2-Pentanol/ | Ethyl | Thixatrol | Solsperse | Polyoxyethylene |
| | | 1-pentanol | cellulose | PM 8054 | 85000 0.02- | lauryl ether 0.1- |
| | | 2:1, | 0.5-0.9% | 0.1-0.4% | 1.0% | 0.5% |
| | | balance | | | | |
| 368 | MC13 88-92% | 2-Pentanol/ | Ethyl | Thixatrol | Solsperse | Polyoxyethylene |
| | | 1-pentanol | cellulose | PM 8054 | 85000 0.02- | lauryl ether 0.1- |
| | | 2:1, | 0.5-0.9% | 0.1-0.4% | 1.0% | 0.5% |
| | | balance | | | | |
| 369 | MC3 88-92% | 1-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 370 | MC7 88-92% | 1-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 371 | MC11 88-92% | 1-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 372 | MC13 88-92% | 1-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 373 | MC3 88-92% | 2-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 374 | MC7 88-92% | 2-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 375 | MC11 88-92% | 2-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 376 | MC13 88-92% | 2-Butanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 377 | MC3 88-92% | 2-Pentanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 378 | MC7 88-92% | 2-Pentanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 379 | MC11 88-92% | 2-Pentanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 380 | MC13 88-92% | 2-Pentanol, | Ethyl | M-P-A 1075 | Solsperse | Polyoxyethylene |
| | | balance | cellulose | 0.5-1.0% | 85000 0.02- | lauryl ether 0.1- |
| | | | 0.5-0.9% | | 1.0% | 0.5% |
| 381 | MC3 88-92% | 2-Pentanol/ | Ethyl | M-P-A 1075 | Solsperse | Polyoxyethylene |
| | | 1-pentanol | cellulose | 0.5-1.0% | 85000 0.02- | lauryl ether 0.1- |
| | | 2:1, | 0.5-0.9% | | 1.0% | 0.5% |
| | | balance | | | | |
| 382 | MC7 88-92% | 2-Pentanol/ | Ethyl | M-P-A 1075 | Solsperse | Polyoxyethylene |
| | | 1-pentanol | cellulose | 0.5-1.0% | 85000 0.02- | lauryl ether 0.1- |
| | | 2:1, | 0.5-0.9% | | 1.0% | 0.5% |
| | | balance | | | | |
| 383 | MC11 88-92% | 2-Pentanol/ | Ethyl | M-P-A 1075 | Solsperse | Polyoxyethylene |
| | | 1-pentanol | cellulose | 0.5-1.0% | 85000 0.02- | lauryl ether 0.1- |
| | | 2:1, | 0.5-0.9% | | 1.0% | 0.5% |
| | | balance | | | | |
| 384 | MC13 88-92% | 2-Pentanol/ | Ethyl | M-P-A 1075 | Solsperse | Polyoxyethylene |
| | | 1-pentanol | cellulose | 0.5-1.0% | 85000 0.02- | lauryl ether 0.1- |
| | | 2:1, | 0.5-0.9% | | 1.0% | 0.5% |
| | | balance | | | | |
| 385 | MC3 88-92% | 1-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 386 | MC7 88-92% | 1-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 387 | MC11 88-92% | 1-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 388 | MC13 88-92% | 1-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 389 | MC3 88-92% | 2-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 390 | MC7 88-92% | 2-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 391 | MC11 88-92% | 2-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 392 | MC13 88-92% | 2-Butanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 393 | MC3 88-92% | 2-Pentanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 394 | MC7 88-92% | 2-Pentanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 395 | MC11 88-92% | 2-Pentanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 396 | MC13 88-92% | 2-Pentanol, | Ethyl | Thixatrol | Solsperse | Polyoxyethylene |
| | | balance | cellulose | MAX 0.1- | 41000 0.02- | oleyl ether 0.1- |
| | | | 0.5-0.9% | 0.4% | 1.0% | 0.5% |
| 397 | MC3 88-92% | 2-Pentanol/ | Ethyl | Thixatrol | Solsperse | Polyoxyethylene |
| | | 1-pentanol | cellulose | MAX 0.1- | 41000 0.02- | oleyl ether 0.1- |
| | | 2:1, | 0.5-0.9% | 0.4% | 1.0% | 0.5% |
| | | balance | | | | |
| 398 | MC7 88-92% | 2-Pentanol/ | Ethyl | Thixatrol | Solsperse | Polyoxyethylene |
| | | 1-pentanol | cellulose | MAX 0.1- | 41000 0.02- | oleyl ether 0.1- |
| | | 2:1, | 0.5-0.9% | 0.4% | 1.0% | 0.5% |
| | | balance | | | | |
| 399 | MC11 88-92% | 2-Pentanol/ | Ethyl | Thixatrol | Solsperse | Polyoxyethylene |
| | | 1-pentanol | cellulose | MAX 0.1- | 41000 0.02- | oleyl ether 0.1- |
| | | 2:1, | 0.5-0.9% | 0.4% | 1.0% | 0.5% |
| | | balance | | | | |
| 400 | MC13 88-92% | 2-Pentanol/ | Ethyl | Thixatrol | Solsperse | Polyoxyethylene |
| | | 1-pentanol | cellulose | MAX 0.1- | 41000 0.02- | oleyl ether 0.1- |
| | | 2:1, | 0.5-0.9% | 0.4% | 1.0% | 0.5% |
| | | balance | | | | |
| 401 | MC3 88-92% | 1-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 402 | MC7 88-92% | 1-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 403 | MC11 88-92% | 1-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 404 | MC13 88-92% | 1-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 405 | MC3 88-92% | 2-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 406 | MC7 88-92% | 2-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 407 | MC11 88-92% | 2-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 408 | MC13 88-92% | 2-Butanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 409 | MC3 88-92% | 2-Pentanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 410 | MC7 88-92% | 2-Pentanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 411 | MC11 88-92% | 2-Pentanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 412 | MC13 88-92% | 2-Pentanol, | Ethyl | RheoByk- | Solsperse | Polyoxyethylene |
| | | balance | cellulose | 100 0.5- | 41000 0.02- | oleyl ether 0.1- |
| | | | 0.5-0.9% | 1.0% | 1.0% | 0.5% |
| 413 | MC3 88-92% | 2-Pentanol/ | Ethyl | RheoByk- | Solsperse | Polyoxyethylene |
| | | 1-pentanol | cellulose | 100 0.5- | 41000 0.02- | oleyl ether 0.1- |
| | | 2:1, | 0.5-0.9% | 1.0% | 1.0% | 0.5% |
| | | balance | | | | |
| 414 | MC7 88-92% | 2-Pentanol/ | Ethyl | RheoByk- | Solsperse | Polyoxyethylene |
| | | 1-pentanol | cellulose | 100 0.5- | 41000 0.02- | oleyl ether 0.1- |
| | | 2:1, | 0.5-0.9% | 1.0% | 1.0% | 0.5% |
| | | balance | | | | |
| 415 | MC11 88-92% | 2-Pentanol/ | Ethyl | RheoByk- | Solsperse | Polyoxyethylene |
| | | 1-pentanol | cellulose | 100 0.5- | 41000 0.02- | oleyl ether 0.1- |
| | | 2:1, | 0.5-0.9% | 1.0% | 1.0% | 0.5% |
| | | balance | | | | |
| 416 | MC13 88-92% | 2-Pentanol/ | Ethyl | RheoByk- | Solsperse | Polyoxyethylene |
| | | 1-pentanol | cellulose | 100 0.5- | 41000 0.02- | oleyl ether 0.1- |
| | | 2:1, | 0.5-0.9% | 1.0% | 1.0% | 0.5% |
| | | balance | | | | |
| 417 | MC3 88-92% | 1-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 418 | MC7 88-92% | 1-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 419 | MC11 88-92% | 1-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 420 | MC13 88-92% | 1-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 421 | MC3 88-92% | 2-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 422 | MC7 88-92% | 2-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 423 | MC11 88-92% | 2-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 424 | MC13 88-92% | 2-Butanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 425 | MC3 88-92% | 2-Pentanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 426 | MC7 88-92% | 2-Pentanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 427 | MC11 88-92% | 2-Pentanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 428 | MC13 88-92% | 2-Pentanol, | Ethyl | Thixatrol | Solsperse | Polyoxyethylene |
| | | balance | cellulose | PM 8054 | 41000 0.02- | oleyl ether 0.1- |
| | | | 0.5-0.9% | 0.1-0.4% | 1.0% | 0.5% |
| 429 | MC3 88-92% | 2-Pentanol/ | Ethyl | Thixatrol | Solsperse | Polyoxyethylene |
| | | 1-pentanol | cellulose | PM 8054 | 41000 0.02- | oleyl ether 0.1- |
| | | 2:1, | 0.5-0.9% | 0.1-0.4% | 1.0% | 0.5% |
| | | balance | | | | |
| 430 | MC7 88-92% | 2-Pentanol/ | Ethyl | Thixatrol | Solsperse | Polyoxyethylene |
| | | 1-pentanol | cellulose | PM 8054 | 41000 0.02- | oleyl ether 0.1- |
| | | 2:1, | 0.5-0.9% | 0.1-0.4% | 1.0% | 0.5% |
| | | balance | | | | |
| 431 | MC11 88-92% | 2-Pentanol/ | Ethyl | Thixatrol | Solsperse | Polyoxyethylene |
| | | 1-pentanol | cellulose | PM 8054 | 41000 0.02- | oleyl ether 0.1- |
| | | 2:1, | 0.5-0.9% | 0.1-0.4% | 1.0% | 0.5% |
| | | balance | | | | |
| 432 | MC13 88-92% | 2-Pentanol/ | Ethyl | Thixatrol | Solsperse | Polyoxyethylene |
| | | 1-pentanol | cellulose | PM 8054 | 41000 0.02- | oleyl ether 0.1- |
| | | 2:1, | 0.5-0.9% | 0.1-0.4% | 1.0% | 0.5% |
| | | balance | | | | |
| 433 | MC3 88-92% | 1-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 434 | MC7 88-92% | 1-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 435 | MC11 88-92% | 1-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 436 | MC13 88-92% | 1-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 437 | MC3 88-92% | 2-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 438 | MC7 88-92% | 2-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 439 | MC11 88-92% | 2-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 440 | MC13 88-92% | 2-Butanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 441 | MC3 88-92% | 2-Pentanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 442 | MC7 88-92% | 2-Pentanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 443 | MC11 88-92% | 2-Pentanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 444 | MC13 88-92% | 2-Pentanol, | Ethyl | M-P-A 1075 | Solsperse | Polyoxyethylene |
| | | balance | cellulose | 0.5-1.0% | 41000 0.02- | oleyl ether 0.1- |
| | | | 0.5-0.9% | | 1.0% | 0.5% |
| 445 | MC3 88-92% | 2-Pentanol/ | Ethyl | M-P-A 1075 | Solsperse | Polyoxyethylene |
| | | 1-pentanol | cellulose | 0.5-1.0% | 41000 0.02- | oleyl ether 0.1- |
| | | 2:1, | 0.5-0.9% | | 1.0% | 0.5% |
| | | balance | | | | |
| 446 | MC7 88-92% | 2-Pentanol/ | Ethyl | M-P-A 1075 | Solsperse | Polyoxyethylene |
| | | 1-pentanol | cellulose | 0.5-1.0% | 41000 0.02- | oleyl ether 0.1- |
| | | 2:1, | 0.5-0.9% | | 1.0% | 0.5% |
| | | balance | | | | |
| 447 | MC11 88-92% | 2-Pentanol/ | Ethyl | M-P-A 1075 | Solsperse | Polyoxyethylene |
| | | 1-pentanol | cellulose | 0.5-1.0% | 41000 0.02- | oleyl ether 0.1- |
| | | 2:1, | 0.5-0.9% | | 1.0% | 0.5% |
| | | balance | | | | |
| 448 | MC13 88-92% | 2-Pentanol/ | Ethyl | M-P-A 1075 | Solsperse | Polyoxyethylene |
| | | 1-pentanol | cellulose | 0.5-1.0% | 41000 0.02- | oleyl ether 0.1- |
| | | 2:1, | 0.5-0.9% | | 1.0% | 0.5% |
| | | balance | | | | |
| 449 | MC3 88-92% | 1-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 450 | MC7 88-92% | 1-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 451 | MC11 88-92% | 1-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 452 | MC13 88-92% | 1-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 453 | MC3 88-92% | 2-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 454 | MC7 88-92% | 2-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 455 | MC11 88-92% | 2-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 456 | MC13 88-92% | 2-Butanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 457 | MC3 88-92% | 2-Pentanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 458 | MC7 88-92% | 2-Pentanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 459 | MC11 88-92% | 2-Pentanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 460 | MC13 88-92% | 2-Pentanol, | Ethyl | Thixatrol | Solsperse | Polyoxyethylene |
| | | balance | cellulose | MAX 0.1- | 85000 0.02- | oleyl ether 0.1- |
| | | | 0.5-0.9% | 0.4% | 1.0% | 0.5% |
| 461 | MC3 88-92% | 2-Pentanol/ | Ethyl | Thixatrol | Solsperse | Polyoxyethylene |
| | | 1-pentanol | cellulose | MAX 0.1- | 85000 0.02- | oleyl ether 0.1- |
| | | 2:1, | 0.5-0.9% | 0.4% | 1.0% | 0.5% |
| | | balance | | | | |
| 462 | MC7 88-92% | 2-Pentanol/ | Ethyl | Thixatrol | Solsperse | Polyoxyethylene |
| | | 1-pentanol | cellulose | MAX 0.1- | 85000 0.02- | oleyl ether 0.1- |
| | | 2:1, | 0.5-0.9% | 0.4% | 1.0% | 0.5% |
| | | balance | | | | |
| 463 | MC11 88-92% | 2-Pentanol/ | Ethyl | Thixatrol | Solsperse | Polyoxyethylene |
| | | 1-pentanol | cellulose | MAX 0.1- | 85000 0.02- | oleyl ether 0.1- |
| | | 2:1, | 0.5-0.9% | 0.4% | 1.0% | 0.5% |
| | | balance | | | | |
| 464 | MC13 88-92% | 2-Pentanol/ | Ethyl | Thixatrol | Solsperse | Polyoxyethylene |
| | | 1-pentanol | cellulose | MAX 0.1- | 85000 0.02- | oleyl ether 0.1- |
| | | 2:1, | 0.5-0.9% | 0.4% | 1.0% | 0.5% |
| | | balance | | | | |
| 465 | MC3 88-92% | 1-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 466 | MC7 88-92% | 1-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 467 | MC11 88-92% | 1-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 468 | MC13 88-92% | 1-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 469 | MC3 88-92% | 2-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 470 | MC7 88-92% | 2-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 471 | MC11 88-92% | 2-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 472 | MC13 88-92% | 2-Butanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 473 | MC3 88-92% | 2-Pentanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 474 | MC7 88-92% | 2-Pentanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 475 | MC11 88-92% | 2-Pentanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 476 | MC13 88-92% | 2-Pentanol, | Ethyl | RheoByk- | Solsperse | Polyoxyethylene |
| | | balance | cellulose | 100 0.5- | 85000 0.02- | oleyl ether 0.1- |
| | | | 0.5-0.9% | 1.0% | 1.0% | 0.5% |
| 477 | MC3 88-92% | 2-Pentanol/ | Ethyl | RheoByk- | Solsperse | Polyoxyethylene |
| | | 1-pentanol | cellulose | 100 0.5- | 85000 0.02- | oleyl ether 0.1- |
| | | 2:1, | 0.5-0.9% | 1.0% | 1.0% | 0.5% |
| | | balance | | | | |
| 478 | MC7 88-92% | 2-Pentanol/ | Ethyl | RheoByk- | Solsperse | Polyoxyethylene |
| | | 1-pentanol | cellulose | 100 0.5- | 85000 0.02- | oleyl ether 0.1- |
| | | 2:1, | 0.5-0.9% | 1.0% | 1.0% | 0.5% |
| | | balance | | | | |
| 479 | MC11 88-92% | 2-Pentanol/ | Ethyl | RheoByk- | Solsperse | Polyoxyethylene |
| | | 1-pentanol | cellulose | 100 0.5- | 85000 0.02- | oleyl ether 0.1- |
| | | 2:1, | 0.5-0.9% | 1.0% | 1.0% | 0.5% |
| | | balance | | | | |
| 480 | MC13 88-92% | 2-Pentanol/ | Ethyl | RheoByk- | Solsperse | Polyoxyethylene |
| | | 1-pentanol | cellulose | 100 0.5- | 85000 0.02- | oleyl ether 0.1- |
| | | 2:1, | 0.5-0.9% | 1.0% | 1.0% | 0.5% |
| | | balance | | | | |
| 481 | MC3 88-92% | 1-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 482 | MC7 88-92% | 1-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 483 | MC11 88-92% | 1-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 484 | MC13 88-92% | 1-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 485 | MC3 88-92% | 2-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 486 | MC7 88-92% | 2-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 487 | MC11 88-92% | 2-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 488 | MC13 88-92% | 2-Butanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 489 | MC3 88-92% | 2-Pentanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 490 | MC7 88-92% | 2-Pentanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 491 | MC11 88-92% | 2-Pentanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 492 | MC13 88-92% | 2-Pentanol, | Ethyl | Thixatrol | Solsperse | Polyoxyethylene |
| | | balance | cellulose | PM 8054 | 85000 0.02- | oleyl ether 0.1- |
| | | | 0.5-0.9% | 0.1-0.4% | 1.0% | 0.5% |
| 493 | MC3 88-92% | 2-Pentanol/ | Ethyl | Thixatrol | Solsperse | Polyoxyethylene |
| | | 1-pentanol | cellulose | PM 8054 | 85000 0.02- | oleyl ether 0.1- |
| | | 2:1, | 0.5-0.9% | 0.1-0.4% | 1.0% | 0.5% |
| | | balance | | | | |
| 494 | MC7 88-92% | 2-Pentanol/ | Ethyl | Thixatrol | Solsperse | Polyoxyethylene |
| | | 1-pentanol | cellulose | PM 8054 | 85000 0.02- | oleyl ether 0.1- |
| | | 2:1, | 0.5-0.9% | 0.1-0.4% | 1.0% | 0.5% |
| | | balance | | | | |
| 495 | MC11 88-92% | 2-Pentanol/ | Ethyl | Thixatrol | Solsperse | Polyoxyethylene |
| | | 1-pentanol | cellulose | PM 8054 | 85000 0.02- | oleyl ether 0.1- |
| | | 2:1, | 0.5-0.9% | 0.1-0.4% | 1.0% | 0.5% |
| | | balance | | | | |
| 496 | MC13 88-92% | 2-Pentanol/ | Ethyl | Thixatrol | Solsperse | Polyoxyethylene |
| | | 1-pentanol | cellulose | PM 8054 | 85000 0.02- | oleyl ether 0.1- |
| | | 2:1, | 0.5-0.9% | 0.1-0.4% | 1.0% | 0.5% |
| | | balance | | | | |
| 497 | MC3 88-92% | 1-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 498 | MC7 88-92% | 1-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 499 | MC11 88-92% | 1-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 500 | MC13 88-92% | 1-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 501 | MC3 88-92% | 2-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 502 | MC7 88-92% | 2-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 503 | MC11 88-92% | 2-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 504 | MC13 88-92% | 2-Butanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 505 | MC3 88-92% | 2-Pentanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 506 | MC7 88-92% | 2-Pentanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 507 | MC11 88-92% | 2-Pentanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 508 | MC13 88-92% | 2-Pentanol, | Ethyl | M-P-A 1075 | Solsperse | Polyoxyethylene |
| | | balance | cellulose | 0.5-1.0% | 85000 0.02- | oleyl ether 0.1- |
| | | | 0.5-0.9% | | 1.0% | 0.5% |
| 509 | MC3 88-92% | 2-Pentanol/ | Ethyl | M-P-A 1075 | Solsperse | Polyoxyethylene |
| | | 1-pentanol | cellulose | 0.5-1.0% | 85000 0.02- | oleyl ether 0.1- |
| | | 2:1, | 0.5-0.9% | | 1.0% | 0.5% |
| | | balance | | | | |
| 510 | MC7 88-92% | 2-Pentanol/ | Ethyl | M-P-A 1075 | Solsperse | Polyoxyethylene |
| | | 1-pentanol | cellulose | 0.5-1.0% | 85000 0.02- | oleyl ether 0.1- |
| | | 2:1, | 0.5-0.9% | | 1.0% | 0.5% |
| | | balance | | | | |
| 511 | MC11 88-92% | 2-Pentanol/ | Ethyl | M-P-A 1075 | Solsperse | Polyoxyethylene |
| | | 1-pentanol | cellulose | 0.5-1.0% | 85000 0.02- | oleyl ether 0.1- |
| | | 2:1, | 0.5-0.9% | | 1.0% | 0.5% |
| | | balance | | | | |
| 512 | MC13 88-92% | 2-Pentanol/ | Ethyl | M-P-A 1075 | Solsperse | Polyoxyethylene |
| | | 1-pentanol | cellulose | 0.5-1.0% | 85000 0.02- | oleyl ether 0.1- |
| | | 2:1, | 0.5-0.9% | | 1.0% | 0.5% |
| | | balance | | | | |
| 513 | MC3 88-92% | 1-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 514 | MC7 88-92% | 1-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 515 | MC11 88-92% | 1-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 516 | MC13 88-92% | 1-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 517 | MC3 88-92% | 2-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 518 | MC7 88-92% | 2-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 519 | MC11 88-92% | 2-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 520 | MC13 88-92% | 2-Butanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 521 | MC3 88-92% | 2-Pentanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 522 | MC7 88-92% | 2-Pentanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 523 | MC11 88-92% | 2-Pentanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 524 | MC13 88-92% | 2-Pentanol, | Ethyl | Thixatrol | Solsperse | Polyoxyethylene |
| | | balance | cellulose | MAX 0.1- | 41000 0.02- | stearyl ether 0.1- |
| | | | 0.5-0.9% | 0.4% | 1.0% | 0.5% |
| 525 | MC3 88-92% | 2-Pentanol/ | Ethyl | Thixatrol | Solsperse | Polyoxyethylene |
| | | 1-pentanol | cellulose | MAX 0.1- | 41000 0.02- | stearyl ether 0.1- |
| | | 2:1, | 0.5-0.9% | 0.4% | 1.0% | 0.5% |
| | | balance | | | | |
| 526 | MC7 88-92% | 2-Pentanol/ | Ethyl | Thixatrol | Solsperse | Polyoxyethylene |
| | | 1-pentanol | cellulose | MAX 0.1- | 41000 0.02- | stearyl ether 0.1- |
| | | 2:1, | 0.5-0.9% | 0.4% | 1.0% | 0.5% |
| | | balance | | | | |
| 527 | MC11 88-92% | 2-Pentanol/ | Ethyl | Thixatrol | Solsperse | Polyoxyethylene |
| | | 1-pentanol | cellulose | MAX 0.1- | 41000 0.02- | stearyl ether 0.1- |
| | | 2:1, | 0.5-0.9% | 0.4% | 1.0% | 0.5% |
| | | balance | | | | |
| 528 | MC13 88-92% | 2-Pentanol/ | Ethyl | Thixatrol | Solsperse | Polyoxyethylene |
| | | 1-pentanol | cellulose | MAX 0.1- | 41000 0.02- | stearyl ether 0.1- |
| | | 2:1, | 0.5-0.9% | 0.4% | 1.0% | 0.5% |
| | | balance | | | | |
| 529 | MC3 88-92% | 1-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 530 | MC7 88-92% | 1-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 531 | MC11 88-92% | 1-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 532 | MC13 88-92% | 1-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 533 | MC3 88-92% | 2-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 534 | MC7 88-92% | 2-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 535 | MC11 88-92% | 2-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 536 | MC13 88-92% | 2-Butanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 537 | MC3 88-92% | 2-Pentanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 538 | MC7 88-92% | 2-Pentanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 539 | MC11 88-92% | 2-Pentanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 540 | MC13 88-92% | 2-Pentanol, | Ethyl | RheoByk- | Solsperse | Polyoxyethylene |
| | | balance | cellulose | 100 0.5- | 41000 0.02- | stearyl ether 0.1- |
| | | | 0.5-0.9% | 1.0% | 1.0% | 0.5% |
| 541 | MC3 88-92% | 2-Pentanol/ | Ethyl | RheoByk- | Solsperse | Polyoxyethylene |
| | | 1-pentanol | cellulose | 100 0.5- | 41000 0.02- | stearyl ether 0.1- |
| | | 2:1, | 0.5-0.9% | 1.0% | 1.0% | 0.5% |
| | | balance | | | | |
| 542 | MC7 88-92% | 2-Pentanol/ | Ethyl | RheoByk- | Solsperse | Polyoxyethylene |
| | | 1-pentanol | cellulose | 100 0.5- | 41000 0.02- | stearyl ether 0.1- |
| | | 2:1, | 0.5-0.9% | 1.0% | 1.0% | 0.5% |
| | | balance | | | | |
| 543 | MC11 88-92% | 2-Pentanol/ | Ethyl | RheoByk- | Solsperse | Polyoxyethylene |
| | | 1-pentanol | cellulose | 100 0.5- | 41000 0.02- | stearyl ether 0.1- |
| | | 2:1, | 0.5-0.9% | 1.0% | 1.0% | 0.5% |
| | | balance | | | | |
| 544 | MC13 88-92% | 2-Pentanol/ | Ethyl | RheoByk- | Solsperse | Polyoxyethylene |
| | | 1-pentanol | cellulose | 100 0.5- | 41000 0.02- | stearyl ether 0.1- |
| | | 2:1, | 0.5-0.9% | 1.0% | 1.0% | 0.5% |
| | | balance | | | | |
| 545 | MC3 88-92% | 1-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 546 | MC7 88-92% | 1-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 547 | MC11 88-92% | 1-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 548 | MC13 88-92% | 1-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 549 | MC3 88-92% | 2-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 550 | MC7 88-92% | 2-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 551 | MC11 88-92% | 2-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 552 | MC13 88-92% | 2-Butanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 553 | MC3 88-92% | 2-Pentanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 554 | MC7 88-92% | 2-Pentanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 555 | MC11 88-92% | 2-Pentanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 556 | MC13 88-92% | 2-Pentanol, | Ethyl | Thixatrol | Solsperse | Polyoxyethylene |
| | | balance | cellulose | PM 8054 | 41000 0.02- | stearyl ether 0.1- |
| | | | 0.5-0.9% | 0.1-0.4% | 1.0% | 0.5% |
| 557 | MC3 88-92% | 2-Pentanol/ | Ethyl | Thixatrol | Solsperse | Polyoxyethylene |
| | | 1-pentanol | cellulose | PM 8054 | 41000 0.02- | stearyl ether 0.1- |
| | | 2:1, | 0.5-0.9% | 0.1-0.4% | 1.0% | 0.5% |
| | | balance | | | | |
| 558 | MC7 88-92% | 2-Pentanol/ | Ethyl | Thixatrol | Solsperse | Polyoxyethylene |
| | | 1-pentanol | cellulose | PM 8054 | 41000 0.02- | stearyl ether 0.1- |
| | | 2:1, | 0.5-0.9% | 0.1-0.4% | 1.0% | 0.5% |
| | | balance | | | | |
| 559 | MC11 88-92% | 2-Pentanol/ | Ethyl | Thixatrol | Solsperse | Polyoxyethylene |
| | | 1-pentanol | cellulose | PM 8054 | 41000 0.02- | stearyl ether 0.1- |
| | | 2:1, | 0.5-0.9% | 0.1-0.4% | 1.0% | 0.5% |
| | | balance | | | | |
| 560 | MC13 88-92% | 2-Pentanol/ | Ethyl | Thixatrol | Solsperse | Polyoxyethylene |
| | | 1-pentanol | cellulose | PM 8054 | 41000 0.02- | stearyl ether 0.1- |
| | | 2:1, | 0.5-0.9% | 0.1-0.4% | 1.0% | 0.5% |
| | | balance | | | | |
| 561 | MC3 88-92% | 1-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 562 | MC7 88-92% | 1-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 563 | MC11 88-92% | 1-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 564 | MC13 88-92% | 1-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 565 | MC3 88-92% | 2-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 566 | MC7 88-92% | 2-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 567 | MC11 88-92% | 2-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 568 | MC13 88-92% | 2-Butanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 569 | MC3 88-92% | 2-Pentanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 570 | MC7 88-92% | 2-Pentanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 571 | MC11 88-92% | 2-Pentanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 572 | MC13 88-92% | 2-Pentanol, | Ethyl | M-P-A 1075 | Solsperse | Polyoxyethylene |
| | | balance | cellulose | 0.5-1.0% | 41000 0.02- | stearyl ether 0.1- |
| | | | 0.5-0.9% | | 1.0% | 0.5% |
| 573 | MC3 88-92% | 2-Pentanol/ | Ethyl | M-P-A 1075 | Solsperse | Polyoxyethylene |
| | | 1-pentanol | cellulose | 0.5-1.0% | 41000 0.02- | stearyl ether 0.1- |
| | | 2:1, | 0.5-0.9% | | 1.0% | 0.5% |
| | | balance | | | | |
| 574 | MC7 88-92% | 2-Pentanol/ | Ethyl | M-P-A 1075 | Solsperse | Polyoxyethylene |
| | | 1-pentanol | cellulose | 0.5-1.0% | 41000 0.02- | stearyl ether 0.1- |
| | | 2:1, | 0.5-0.9% | | 1.0% | 0.5% |
| | | balance | | | | |
| 575 | MC11 88-92% | 2-Pentanol/ | Ethyl | M-P-A 1075 | Solsperse | Polyoxyethylene |
| | | 1-pentanol | cellulose | 0.5-1.0% | 41000 0.02- | stearyl ether 0.1- |
| | | 2:1, | 0.5-0.9% | | 1.0% | 0.5% |
| | | balance | | | | |
| 576 | MC13 88-92% | 2-Pentanol/ | Ethyl | M-P-A 1075 | Solsperse | Polyoxyethylene |
| | | 1-pentanol | cellulose | 0.5-1.0% | 41000 0.02- | stearyl ether 0.1- |
| | | 2:1, | 0.5-0.9% | | 1.0% | 0.5% |
| | | balance | | | | |
| 577 | MC3 88-92% | 1-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 578 | MC7 88-92% | 1-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 579 | MC11 88-92% | 1-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 580 | MC13 88-92% | 1-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 581 | MC3 88-92% | 2-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 582 | MC7 88-92% | 2-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 583 | MC11 88-92% | 2-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 584 | MC13 88-92% | 2-Butanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 585 | MC3 88-92% | 2-Pentanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 586 | MC7 88-92% | 2-Pentanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 587 | MC11 88-92% | 2-Pentanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 588 | MC13 88-92% | 2-Pentanol, | Ethyl | Thixatrol | Solsperse | Polyoxyethylene |
| | | balance | cellulose | MAX 0.1- | 85000 0.02- | stearyl ether 0.1- |
| | | | 0.5-0.9% | 0.4% | 1.0% | 0.5% |
| 589 | MC3 88-92% | 2-Pentanol/ | Ethyl | Thixatrol | Solsperse | Polyoxyethylene |
| | | 1-pentanol | cellulose | MAX 0.1- | 85000 0.02- | stearyl ether 0.1- |
| | | 2:1, | 0.5-0.9% | 0.4% | 1.0% | 0.5% |
| | | balance | | | | |
| 590 | MC7 88-92% | 2-Pentanol/ | Ethyl | Thixatrol | Solsperse | Polyoxyethylene |
| | | 1-pentanol | cellulose | MAX 0.1- | 85000 0.02- | stearyl ether 0.1- |
| | | 2:1, | 0.5-0.9% | 0.4% | 1.0% | 0.5% |
| | | balance | | | | |
| 591 | MC11 88-92% | 2-Pentanol/ | Ethyl | Thixatrol | Solsperse | Polyoxyethylene |
| | | 1-pentanol | cellulose | MAX 0.1- | 85000 0.02- | stearyl ether 0.1- |
| | | 2:1, | 0.5-0.9% | 0.4% | 1.0% | 0.5% |
| | | balance | | | | |
| 592 | MC13 88-92% | 2-Pentanol/ | Ethyl | Thixatrol | Solsperse | Polyoxyethylene |
| | | 1-pentanol | cellulose | MAX 0.1- | 85000 0.02- | stearyl ether 0.1- |
| | | 2:1, | 0.5-0.9% | 0.4% | 1.0% | 0.5% |
| | | balance | | | | |
| 593 | MC3 88-92% | 1-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 594 | MC7 88-92% | 1-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 595 | MC11 88-92% | 1-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 596 | MC13 88-92% | 1-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 597 | MC3 88-92% | 2-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 598 | MC7 88-92% | 2-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 599 | MC11 88-92% | 2-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 600 | MC13 88-92% | 2-Butanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 601 | MC3 88-92% | 2-Pentanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 602 | MC7 88-92% | 2-Pentanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 603 | MC11 88-92% | 2-Pentanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 604 | MC13 88-92% | 2-Pentanol, | Ethyl | RheoByk- | Solsperse | Polyoxyethylene |
| | | balance | cellulose | 100 0.5- | 85000 0.02- | stearyl ether 0.1- |
| | | | 0.5-0.9% | 1.0% | 1.0% | 0.5% |
| 605 | MC3 88-92% | 2-Pentanol/ | Ethyl | RheoByk- | Solsperse | Polyoxyethylene |
| | | 1-pentanol | cellulose | 100 0.5- | 85000 0.02- | stearyl ether 0.1- |
| | | 2:1, | 0.5-0.9% | 1.0% | 1.0% | 0.5% |
| | | balance | | | | |
| 606 | MC7 88-92% | 2-Pentanol/ | Ethyl | RheoByk- | Solsperse | Polyoxyethylene |
| | | 1-pentanol | cellulose | 100 0.5- | 85000 0.02- | stearyl ether 0.1- |
| | | 2:1, | 0.5-0.9% | 1.0% | 1.0% | 0.5% |
| | | balance | | | | |
| 607 | MC11 88-92% | 2-Pentanol/ | Ethyl | RheoByk- | Solsperse | Polyoxyethylene |
| | | 1-pentanol | cellulose | 100 0.5- | 85000 0.02- | stearyl ether 0.1- |
| | | 2:1, | 0.5-0.9% | 1.0% | 1.0% | 0.5% |
| | | balance | | | | |
| 608 | MC13 88-92% | 2-Pentanol/ | Ethyl | RheoByk- | Solsperse | Polyoxyethylene |
| | | 1-pentanol | cellulose | 100 0.5- | 85000 0.02- | stearyl ether 0.1- |
| | | 2:1, | 0.5-0.9% | 1.0% | 1.0% | 0.5% |
| | | balance | | | | |
| 609 | MC3 88-92% | 1-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 610 | MC7 88-92% | 1-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 611 | MC11 88-92% | 1-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 612 | MC13 88-92% | 1-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 613 | MC3 88-92% | 2-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 614 | MC7 88-92% | 2-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 615 | MC11 88-92% | 2-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 616 | MC13 88-92% | 2-Butanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 617 | MC3 88-92% | 2-Pentanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 618 | MC7 88-92% | 2-Pentanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 619 | MC11 88-92% | 2-Pentanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 620 | MC13 88-92% | 2-Pentanol, | Ethyl | Thixatrol | Solsperse | Polyoxyethylene |
| | | balance | cellulose | PM 8054 | 85000 0.02- | stearyl ether 0.1- |
| | | | 0.5-0.9% | 0.1-0.4% | 1.0% | 0.5% |
| 621 | MC3 88-92% | 2-Pentanol/ | Ethyl | Thixatrol | Solsperse | Polyoxyethylene |
| | | 1-pentanol | cellulose | PM 8054 | 85000 0.02- | stearyl ether 0.1- |
| | | 2:1, | 0.5-0.9% | 0.1-0.4% | 1.0% | 0.5% |
| | | balance | | | | |
| 622 | MC7 88-92% | 2-Pentanol/ | Ethyl | Thixatrol | Solsperse | Polyoxyethylene |
| | | 1-pentanol | cellulose | PM 8054 | 85000 0.02- | stearyl ether 0.1- |
| | | 2:1, | 0.5-0.9% | 0.1-0.4% | 1.0% | 0.5% |
| | | balance | | | | |
| 623 | MC11 88-92% | 2-Pentanol/ | Ethyl | Thixatrol | Solsperse | Polyoxyethylene |
| | | 1-pentanol | cellulose | PM 8054 | 85000 0.02- | stearyl ether 0.1- |
| | | 2:1, | 0.5-0.9% | 0.1-0.4% | 1.0% | 0.5% |
| | | balance | | | | |
| 624 | MC13 88-92% | 2-Pentanol/ | Ethyl | Thixatrol | Solsperse | Polyoxyethylene |
| | | 1-pentanol | cellulose | PM 8054 | 85000 0.02- | stearyl ether 0.1- |
| | | 2:1, | 0.5-0.9% | 0.1-0.4% | 1.0% | 0.5% |
| | | balance | | | | |
| 625 | MC3 88-92% | 1-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 626 | MC7 88-92% | 1-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 627 | MC11 88-92% | 1-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 628 | MC13 88-92% | 1-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 629 | MC3 88-92% | 2-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 630 | MC7 88-92% | 2-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 631 | MC11 88-92% | 2-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 632 | MC13 88-92% | 2-Butanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 633 | MC3 88-92% | 2-Pentanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 634 | MC7 88-92% | 2-Pentanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 635 | MC11 88-92% | 2-Pentanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 636 | MC13 88-92% | 2-Pentanol, | Ethyl | M-P-A 1075 | Solsperse | Polyoxyethylene |
| | | balance | cellulose | 0.5-1.0% | 85000 0.02- | stearyl ether 0.1- |
| | | | 0.5-0.9% | | 1.0% | 0.5% |
| 637 | MC3 88-92% | 2-Pentanol/ | Ethyl | M-P-A 1075 | Solsperse | Polyoxyethylene |
| | | 1-pentanol | cellulose | 0.5-1.0% | 85000 0.02- | stearyl ether 0.1- |
| | | 2:1, | 0.5-0.9% | | 1.0% | 0.5% |
| | | balance | | | | |
| 638 | MC7 88-92% | 2-Pentanol/ | Ethyl | M-P-A 1075 | Solsperse | Polyoxyethylene |
| | | 1-pentanol | cellulose | 0.5-1.0% | 85000 0.02- | stearyl ether 0.1- |
| | | 2:1, | 0.5-0.9% | | 1.0% | 0.5% |
| | | balance | | | | |
| 639 | MC11 88-92% | 2-Pentanol/ | Ethyl | M-P-A 1075 | Solsperse | Polyoxyethylene |
| | | 1-pentanol | cellulose | 0.5-1.0% | 85000 0.02- | stearyl ether 0.1- |
| | | 2:1, | 0.5-0.9% | | 1.0% | 0.5% |
| | | balance | | | | |
| 640 | MC13 88-92% | 2-Pentanol/ | Ethyl | M-P-A 1075 | Solsperse | Polyoxyethylene |
| | | 1-pentanol | cellulose | 0.5-1.0% | 85000 0.02- | stearyl ether 0.1- |
| | | 2:1, | 0.5-0.9% | | 1.0% | 0.5% |
| | | balance | | | | |

Methods of Making a Part by 3D Printing the Paste

The present disclosure is also directed to an additive manufacturing method for making a three-dimensional object. The method comprises: depositing a first layer comprising a paste over a build plate; depositing a second layer comprising the paste on the first layer; repeating the process of depositing the second layer or a subsequent layer one or more times to form a three-dimensional object; and heating to sinter the three-dimensional object. The present disclosure is also directed to a hybrid additive manufacturing method for making a three-dimensional object, in which the method further comprises an optional manipulating or machining step to remove some portion of the deposited material. The paste composition is described hereinbefore.

Due in part to the thixotropic additive included in the paste and the associated ability of the paste to reflow after deposition, the deposited layers are self-leveling so as to have a relatively smooth surface. A paste that enables a leveled layer has significant advantage because the paste allows for printing a thinner wet layer which is advantageous because it dries faster and more uniformly and consumes less paste. Moreover, a leveled layer advantageously allows for removing less materials in a hybrid additive manufacturing method. After drying, as discussed below, the printed layer roughness ranges from about 0.05 to about 0.7.

In an embodiment, a drying process is carried out to dry the first and second layers. The drying process can include drying each layer prior to the deposition of a subsequent layer. Thus, for example, the first layer is dried, followed by deposition of the second layer. Then the second layer is dried before repeating the process of depositing another layer. Drying between deposition of every layer can reduce or eliminate uneven shrinkage during the sintering process. One of ordinary skill in the art would recognize that, while it is advantageous to dry each deposited layer, other drying schemes are possible. For example, the drying can be performed only after depositing every two layers, every three layers, every four layers, etc. or any combination thereof, or only after the deposition of all layers.

During drying one or more volatile components of the paste, for example the solvent, are removed from each of the layers, which are built up to form a green body. This can be accomplished using any known or later developed drying technique, such as drying using convection (e.g., flowing heated air over the layers) and/or radiation (e.g., employing a heat lamp). In an example, the drying is carried out so that the solvent, or any other volatile component, is removed from the layers so that the final green body has an amount of residual solvent, or any other volatile component, of less than 5% by volume, in about 0.1 to about 10 minutes using a thermal flux of about 5 to about 150 kW/m² and at a pressure of about 1 atmosphere. Additional methods of drying are described in the U.S. patent application Ser. No. 17/641,047, filed on Mar. 7, 2022, and U.S. Patent Publication No. 2019/0016904, published on Jan. 17, 2019, the contents of which are incorporated herein by reference in their entirety.

During drying, relatively low temperatures and/or low power (e.g., in the case of a heat lamp) are employed so that thermal expansion of material does not move material out of desired dimensions during drying or significantly altering the green body dimensions, which could detrimentally affect the accuracy of paste deposition and/or green body manipulation.

In an embodiment, each layer is manipulated, for example machined, after drying, prior to depositing another layer. This can potentially provide for ease of machining and/or the ability to machine intricate patterns. Examples of techniques for machining a green body are disclosed in and U.S. Patent Publication No. 2018/0071819, published on Mar. 15, 2018, which is incorporated herein by reference in its entirety. Alternatively, a plurality of layers can be deposited and dried before being machined, followed by the deposition and drying of one or more additional layers, followed by the machining of the one or more additional layers. The process of 1) deposition of one or more layers, 2) drying between each layer and 3) machining of the one or more layers either separately or together, can be repeated any desired number of times in order to produce a desired three-dimensional product. In yet another embodiment, all of the layers are deposited and dried prior to machining of the layers. Machining is generally carried out prior to sintering. In some embodiments, machining is performed during the drying step.

Drying of the layers results in a green body as described above. The green body is sintered to form the three-dimensional object. The sintering temperatures are generally higher than the drying temperatures. For example, the drying temperatures can be at or above the boiling point of the solvent and below the melting point of the particles. Examples of suitable drying temperatures range from about 0° C. to about 350° C., such as about 50° C. to about 200° C. Examples of suitable sintering temperatures range from about 400° C. to about 2000° C., such as about 800° C. to about 1500° C. The sintering temperatures are below the melting point of the particles. The difference between the melting point and the sintering temperature depends, among other things, on the surface energy and size of the particles. For example, the melting point of iron is 1538° C., but iron particles typically sinter between 900° C. and 1400° C. One of ordinary skill in the art would readily understand that the suitable drying temperature and suitable sintering temperature depend on the nature and composition of the solvents and the particles, respectively.

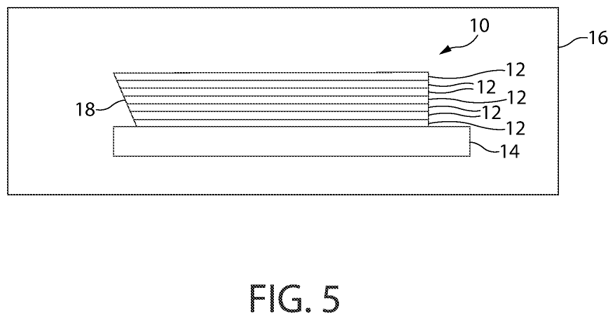

FIG. 5 illustrates an example of a green body 10 formed by the 3D printing methods described herein. The green body 10 is made by depositing a plurality of layers 12 one on the other in a stacked fashion on a build plate 14. A drying process is carried out after depositing each layer 12 prior to depositing a subsequent layer 12. In this manner the green body 10 is built by adding one layer 12 onto another layer 12 until a desired thickness of the green body 10 is realized. The process is carried out in a 3D printer, as is generally represented by 16. The green body 10 can have any desired shape. In FIG. 5, the green body 10 includes an overhang 18 (e.g., a wall with negative slope) that is smooth.

In some embodiments, the green body density is about 65% to about 75%, such as 67% to 74% or 69% to 72%. Due to the relatively high green body density, the paste can be sintered to >90% density, >95% density, or >98% density. One of ordinary skill in the art would readily appreciate that the higher the green body density is, the less the amount of material that needs to be removed, e.g. burned out, during the sintering process, which in turn may result in higher density of the final sintered object.

The green body 10 has a fracture strength of at least 5 MPa. The paste can reach a certain strength after being dried due, at least in part, to the polymeric binder employed. In an embodiment, in addition to employing the polymeric binder, the strength can also be increased by not including or limiting the amounts of waxes, oils and/or dispersants, as these ingredients can potentially weaken the green body.

The green body 10 can have a uniform packing density, uniform chemical composition and can include a packing of mixed metal particles. In addition, the green body 10 can be made to a precise desired size. For example, the dried body has a span (tolerance) of actual dimensions versus target dimension (measured dimension subtract CAD target dimension)/CAD target dimension) of less than 0.05%.

In an embodiment, a ceramic interface layer is 3D printed on a build plate of the 3D printer before depositing the metal paste. The metal 3D object is then printed on the ceramic interface layer. The ceramic interface layer can be made from any of the pastes that comprise particles comprising ceramic, as described herein. As an example, the ceramic interface layer paste can have the same ingredients as used for the metal paste, except that the particles comprise a ceramic material rather than a metal. In an example, the ceramic interface layer is machined on the build plate before 3D printing the paste comprising metal particles. The interface layer is machined for the purpose of creating in-situ a leveled substrate for building the 3D object, which is essentially flat and horizontal in the machine coordinate system. The interface layer provides a retention force between the build plate and the 3D object that opposes the forces applied to the 3D object during the machining step, the drying step, the material deposition step, the transferring between the printing and the sintering steps, or any other step in the additive manufacturing process. Additional descriptions and embodiments of the use of the interface layer are provided in the U.S. Provisional Application No. 63/001,180, filed on Mar. 27, 2020, which is hereby incorporated in its entirety by reference.

### Examples

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

A series of exemplary paste formulations were prepared by combining the components according to Table 4. It should be appreciated that the metal compositions (MC) are represented by Tables 2. Each of the exemplary paste formulations were evaluated and their properties are summarized in Tables 5-9. The viscosity values were determined using a Brookfield DV3T-HB Cone/Plate Rheometer equipped with a cone spindle CP-52 and temperature control set at 25° C. The viscosity was determined at different shear rate values, starting with low shear rate (2 s⁻¹), stepwise increasing it to 50 s⁻¹ and then lowering it again stepwise back to 2 s⁻¹. One of the ordinary skill in the art will immediately recognize that the ratio between the first measurement at 2 s⁻¹ and the measurement at 50 s⁻¹ is an indication of the rheology behavior of the paste, e.g. shear thinning, shear thickening, Newtonian, etc; while the difference between the two measurements at low shear (e.g. 2 s⁻¹) are an indication of the thixotropic behavior of the paste. The stability was determined by visual inspection of the paste in a tube or cartridge. The drying time refers to the overall time required to completely dry a printed layer of paste deposited and dried according to the methods described herein. The green body scratch test was performed by scratching the surface of a printed green body with thickness of at least 1 mm using a TQC Hardness Pen with a 1 mm tip and the 0-10N spring set at 6N. The cracks were identified by visual inspection of printed green bodies in high stress points.

The percentages and concentrations in the present disclosure, including in the tables below, are based on weight, unless specified otherwise.

TABLE 4
Paste Compositions

| | Metal | | | | | |
|---|---|---|---|---|---|---|
| Paste | Composition | Solvent | Binder | Thixotrope | Dispersant | Anti-Cracking Additive |
| P1 | MC19 88-90% | 2-pentanol/ | Ethyl | | | |
| | | 1-pentanol | cellulose | | | |
| | | 2:1, balance | 0.5-0.65% | | | |
| P2 | MC19 88-90% | 2-pentanol/ | Ethyl | Thixatrol | | |
| | | 1-pentanol | cellulose | MAX 0.2- | | |
| | | 2:1, balance | 0.5-0.65% | 0.4% | | |
| P3 | MC19 88-90% | 2-pentanol/ | Ethyl | RheoByk- | | |
| | | 1-pentanol | cellulose | 100 0.8-1.0% | | |
| | | 2:1, balance | 0.5-0.65% | | | |
| P4 | MC19 88-90% | 2-pentanol/ | Ethyl | Thixatrol PM | | |
| | | 1-pentanol | cellulose | 8056 0.2- | | |
| | | 1:1, balance | 0.5-0.65% | 0.4% | | |
| P5 | MC19 88-90% | 1-hexanol | Ethyl | Thixatrol PM | | |
| | | balance | cellulose | 8054 0.2- | | |
| | | | 0.5-0.65% | 0.4% | | |
| P6 | MC15 88-90% | 2-butanol | Ethyl | Thixatrol | | |
| | | balance | cellulose | MAX 0.2- | | |
| | | | 0.5-0.65% | 0.4% | | |
| P7 | MC15 90% | 2-butanol | Ethyl | Thixatrol | Solsperse | |
| | | balance | cellulose | MAX 0.2- | 41000 0.06- | |
| | | | 0.5-0.65% | 0.4% | 1.0% | |
| P8 | MC15 91% | 2-butanol | Ethyl | Thixatrol | Solsperse | |
| | | balance | cellulose | MAX 0.2- | 41000 0.06- | |
| | | | 0.5-0.65% | 0.4% | 1.0% | |
| P9 | MC15 92% | 2-butanol | Ethyl | Thixatrol | Solsperse | |
| | | balance | cellulose | MAX 0.2- | 41000 0.06- | |
| | | | 0.5-0.65% | 0.4% | 1.0% | |
| P10 | MC15 92% | 1-butanol | Ethyl | Thixatrol | Solsperse | |
| | | balance | cellulose | MAX 0.2- | 65000 0.06- | |
| | | | 0.5-0.65% | 0.4% | 0.1% | |
| P11 | MC15 92% | 1-butanol | Ethyl | Thixatrol | Solsperse | |
| | | balance | cellulose | MAX 0.1- | 65000 0.1- | |
| | | | 0.5-0.65% | 0.2% | 0.2% | |
| P12 | MC15 91% | 2-butanol | Ethyl | Thixatrol | Solsperse | |
| | | balance | cellulose | MAX 0.1- | 41000 0.06- | |
| | | | 0.6% | 0.2% | 1.0% | |
| P13 | MC15 91% | 2-butanol | Ethyl | Thixatrol | Solsperse | |
| | | balance | cellulose | MAX 0.1- | 41000 0.06- | |
| | | | 0.7% | 0.2% | 1.0% | |
| P14 | MC15 91% | 2-butanol | Ethyl | Thixatrol | Solsperse | |
| | | balance | cellulose | MAX 0.1- | 41000 0.06- | |
| | | | 1.0% | 0.2% | 1.0% | |
| P15 | MC7 88-90% | 2-butanol | Ethyl | Thixatrol | Solsperse | Camphor 0.1-0.5 %, |
| | | balance | cellulose | MAX 0.1- | 41000 0.02- | |
| | | | 0.5-0.65% | 0.2% | 0.06% | |
| P16 | MC13 88-90% | 2-butanol | Ethyl | Thixatrol | Solsperse | Camphor 0.1-0.5 %, |
| | | balance | cellulose | MAX 0.1- | 41000 0.02- | |
| | | | 0.5-0.65% | 0.2% | 0.06% | |
| P17 | MC7 88-90% | 2-pentanol | Ethyl | Thixatrol | Solsperse | Menthol 0.1-0.5%, |
| | | balance | cellulose | MAX 0.1- | 41000 0.02- | |
| | | | 0.5-0.65% | 0.2% | 0.06% | |
| P18 | MC7 88-90% | 2-pentanol | Ethyl | Thixatrol | Solsperse | Menthol 0.1-0.5%, |
| | | balance | cellulose | MAX 0.1- | 41000 0.02- | hydroxypropyl cellulose |
| | | | 0.5-0.65% | 0.2% | 0.06% | 0.1-0.5% |
| P19 | MC7 88-90% | 2-butanol | Ethyl | Thixatrol | | Camphor 0.1-0.5%, |
| | | balance | cellulose | MAX 0.1- | | hydroxypropyl cellulose |
| | | | 0.5-0.65% | 0.2% | | 0.1-0.5% |
| P20 | MC7 88-90% | 2-butanol | Ethyl | Thixatrol | | Camphor 0.1-0.5%, |
| | | balance | cellulose | MAX 0.1- | | hydroxypropyl cellulose |
| | | | 0.5-0.65% | 0.2% | | 0.1-0.5%, |
| | | | | | | polyoxyethylene cetyl |
| | | | | | | ether 0.1-0.5% |
| P21 | MC7 88-90% | 2-butanol | Ethyl | Thixatrol | Solsperse | Camphor 0.1-0.5 %, |
| | | balance | cellulose | MAX 0.1- | 41000 0.02- | hydroxypropyl cellulose |
| | | | 0.5-0.65% | 0.2% | 0.06% | 0.1-0.5%, |
| | | | | | | polyoxyethylene cetyl |
| | | | | | | ether 0.1-0.5% |
| P22 | MC7 88-90% | 2-pentanol | Ethyl | Thixatrol | Solsperse | Menthol 0.1-0.5%, |
| | | balance | cellulose | MAX 0.1- | 41000 0.02- | hydroxypropyl cellulose |
| | | | 0.5-0.65% | 0.2% | 0.06% | 0.1-0.5%, |
| | | | | | | polyoxyethylene cetyl |
| | | | | | | ether 0.1-0.5% |
| P23 | MC7 88-90% | 2-pentanol | Ethyl | Thixatrol | Solsperse | Menthol 0.1-0.5%, |
| | | balance | cellulose | MAX 0.1- | 41000 0.02- | hydroxypropyl cellulose |
| | | | 0.7-0.9% | 0.2% | 0.06% | 0.1-0.5%, |
| | | | | | | polyoxyethylene oleyl |
| | | | | | | ether 0.1-0.5% |
| P24 | MC7 88-90% | 2-pentanol | Ethyl | Thixatrol | Solsperse | Menthol 0.1-0.5%, |
| | | balance | cellulose | MAX 0.1- | 41000 0.02- | hydroxypropyl cellulose |
| | | | 0.9-1.0% | 0.2% | 0.06% | 0.1-0.5%, |
| | | | | | | polyoxyethylene lauryl |
| | | | | | | ether 0.1-0.5% |
| P25 | MC7 88-90% | 2-pentanol | Ethyl | RheoByk- | Solsperse | Menthol 0.1-0.5%, |
| | | balance | cellulose | 7410 ET | 65000 0.02- | hydroxypropyl cellulose |
| | | | 0.9-1.0% | 0.5% | 0.06% | 0.1-0.5%, |
| | | | | | | polyoxyethylene lauryl |
| | | | | | | ether 0.1-0.5% |
| P26 | MC7 88-90% | 2-butanol | Ethyl | Thixatrol | Solsperse | Hydroxypropyl |
| | | balance | cellulose | MAX 0.1- | 41000 0.02- | cellulose 0.1-0.5%, |
| | | | 0.5-0.65% | 0.2% | 0.06% | polyoxyethylene cetyl |
| | | | | | | ether 0.1-0.5% |
| P27 | MC13 88-90% | 2-butanol | Ethyl | Thixatrol | Solsperse | Hydroxypropyl |
| | | balance | cellulose | MAX 0.1- | 41000 0.02- | cellulose 0.1-0.5%, |
| | | | 0.5-0.65% | 0.2% | 0.06% | polyoxyethylene cetyl |
| | | | | | | ether 0.1-0.5% |
| P28 | MC7 88-90% | 1-butanol | Ethyl | Thixatrol | Solsperse | Hydroxypropyl |
| | | balance | cellulose | MAX 0.1- | 41000 0.02- | cellulose 0.1-0.5%, |
| | | | 0.5-0.65% | 0.2% | 0.06% | polyoxyethylene cetyl |
| | | | | | | ether 0.1-0.5% |
| P29 | MC1 90-92% | 1-butanol | Ethyl | | | Polyoxyethylene cetyl |
| | | balance | cellulose | | | ether 0.1-0.5% |
| | | | 0.5-0.65% | | | |
| P30 | MC1 90-92% | 1-butanol | Ethyl | | Solsperse | Polyoxyethylene cetyl |
| | | balance | cellulose | | 41000 0.02- | ether 0.1-0.5% |
| | | | 0.5-0.65% | | 0.06% | |
| P31 | MC1 90-92% | 1-butanol | Ethyl | | Solsperse | Polyoxyethylene cetyl |
| | | balance | cellulose | | 85000 0.02- | ether 0.1-0.5% |
| | | | 0.5-0.65% | | 0.06% | |
| P32 | MC1 90-92% | 1-butanol | Ethyl | | Solsperse | Polyoxyethylene cetyl |
| | | balance | cellulose | | 85000 0.08- | ether 0.1-0.5% |
| | | | 0.5-0.65% | | 0.15% | |
| P33 | MC1 92-94% | 1-butanol | Ethyl | | Solsperse | Polyoxyethylene cetyl |
| | | balance | cellulose | | 85000 0.08- | ether 0.1-0.5% |
| | | | 0.5-0.65% | | 0.15% | |
| P34 | MC1 90-92% | 1-butanol | Ethyl | | Solsperse | Polyoxyethylene cetyl |
| | | balance | cellulose | | 41000 0.02- | ether 0.1-0.5% |
| | | | 0.5-0.65% | | 0.06% | |
| P35 | MC1 90-92% | 1-butanol | Ethyl | | Solsperse | Polyoxyethylene lauryl |
| | | balance | cellulose | | 41000 0.02- | ether 0.1-0.5% |
| | | | 0.5-0.65% | | 0.06% | |
| P36 | MC1 90-92% | 1-butanol | Ethyl | | Solsperse | Polyoxyethylene oleyl |
| | | balance | cellulose | | 41000 0.02- | ether 0.1-0.5% |
| | | | 0.5-0.65% | | 0.06% | |
| P37 | MC1 90-92% | 1-butanol | Ethyl | | Solsperse | Polyoxyethylene stearyl |
| | | balance | cellulose | | 41000 0.02- | ether 0.1-0.5% |
| | | | 0.5-0.65% | | 0.06% | |
| P38 | MC1 90-92% | 1-butanol | Ethyl | M-P-A 1075 | Solsperse | Polyoxyethylene cetyl |
| | | balance | cellulose | 0.2-1.0% | 41000 0.02- | ether 0.1-0.5% |
| | | | 0.7-0.9% | | 0.06% | |
| P39 | MC1 90-92% | 1-butanol | Ethyl | M-P-A 1075 | Solsperse | Polyoxyethylene cetyl |
| | | balance | cellulose | 0.2-1.0% | 85000 0.08- | ether 0.1-0.5% |
| | | | 0.7-0.9% | | 0.15% | |
| P40 | MC1 90-92% | 1-butanol | Ethyl | Thixatrol | Solsperse | Polyoxyethylene cetyl |
| | | balance | cellulose | MAX 0.1- | 85000 0.08- | ether 0.1-0.5% |
| | | | 0.7-0.9% | 0.2% | 0.15% | |
| P41 | MC7 90-92% | 1-butanol | Ethyl | Thixatrol | Solsperse | Polyoxyethylene stearyl |
| | | balance | cellulose | MAX 0.1- | 85000 0.08- | ether 0.1-0.5% |
| | | | 0.7-0.9% | 0.2% | 0.15% | |
| P42 | MC13 90-92% | 1-butanol | Ethyl | Thixatrol | Solsperse | Polyoxyethylene stearyl |
| | | balance | cellulose | MAX 0.1- | 85000 0.08- | ether 0.1-0.5% |
| | | | 0.7-0.9% | 0.2% | 0.15% | |

TABLE 5
Effect of Thioxotrope on Paste Properties

| | | | Viscosity | |
|---|---|---|---|---|
| | Viscosity | Viscosity | [cP at 2 | |
| | [cP at 2 | [cP at 50 | 1/s shear rate, | |
| Paste | 1/s shear rate) | 1/s shear rate) | 2^{nd} round) | Stability |
| P1 | 16700 | 9400 | 16000 | Phase separation |
| P2 | 158000 | 21970 | 123800 | No phase separation |
| P29 | 75400 | >30000 | 79400 | Phase separation |
| P38 | 103200 | >30000 | 101600 | No phase separation |
| P39 | 98400 | >30000 | 100800 | No phase separation |
| P41 | 83400 | 22500 | 65100 | No phase separation |

TABLE 6
Effect of Solvent on Paste Properties

| | Drying Time |
|---|---|
| Paste | (1 = Fastest; 5 = Slowest) |
| P2 | 3 |
| P4 | 4 |
| P5 | 5 |
| P6 | 1 |
| P17 | 2 |
| P22 | 2 |
| P26 | 1 |
| P28 | 2 |

TABLE 7
Effect of Dispersant and Metal Content on Paste Properties

| | | | | Viscosity |
|---|---|---|---|---|
| | Green Body | Viscosity | Viscosity | [cP at 2 |
| | Density | [cP at 2 | [cP at 50 | 1/s shear rate, |
| Paste | [g/cm3] | 1/s shear rate) | 1/s shear rate) | 2^{nd} round) |
| P6 | 5.198 | 112700 | 14420 | 78580 |
| P7 | 5.515 | 54770 | 16100 | 42070 |
| P8 | 5.566 | 56360 | 18030 | 46040 |
| P9 | 5.586 | 115900 | 31000 | 91280 |
| P29 | 5.37 | 75400 | >30000 | 79400 |
| P30 | 5.62 | 41300 | 20400 | 38900 |
| P31 | 5.45 | 24600 | 9600 | 23800 |
| P32 | 5.582 | 16700 | 6200 | 16700 |
| P33 | 5.645 | 57900 | 19800 | 54000 |
| P38 | 5.574 | 103200 | >30000 | 101600 |
| P39 | NA | 98400 | >30000 | 100800 |

TABLE 8
Effect of Binder on Paste Properties

| | Green Body Scratch | Green Body Hardness |
|---|---|---|
| Paste | Test [mm] | (extrapolated from scratch test) |
| P12 | 0.77 | Less hard |
| P13 | 0.64 | More hard |

TABLE 9
Effect of Anti-Cracking Additive on Paste Properties

| Paste | Cracks in Green Body |
|---|---|
| P15 | Yes |
| P20 | No |
| P34-38 | No |

What is claimed is:

1. A paste composition for additive manufacturing, comprising:
an organic vehicle, comprising:
a solvent;
a polymeric binder;
a thixotropic additive; and
a dispersant; and
one or more powders dispersed in the organic vehicle.

2. The paste composition of claim 1, wherein the polymeric binder comprises a cellulose based polymer, optionally, the cellulose based polymer comprises cellulose ether, further optionally, a cellulose ether soluble in the solvent.

3. The paste composition of claim 1, wherein the solvent comprises an organic solvent, optionally, the organic solvent comprises a boiling point of from 40° C. to 200° C., optionally from 50° C. to 175° C., further optionally, from 80° C. to 120° C., further optionally, the organic solvent comprises a vapor pressure of from 0.01 to 50 mmHg at 25° C., optionally, from 1 to 30 mmHg at 25° C., further optionally, from 5 to 25 mmHg at 25° C.

4. The paste composition of claim 1, wherein the thixotropic additive comprises one or more thixotropic compounds in the form of one or more of a small molecule, a macromolecule, an oligomer, a polymer, an inorganic material, or a combination thereof.

5. The paste composition of claim 1, wherein the thixotropic additive comprises one or more of a castor oil derivative, a modified polyurea, a polyamide, a polyamide wax, an amide, an amide wax, a diamide, an organic acid diamide, a reaction product of a diamine and an organic acid, a reaction product of an amide, a polyurethane, a polyacrylate, a silicate, an organoclay, a phyllosilicate, an overbased sulfonate, or a combination thereof.

6. The paste composition of claim 1, wherein the thixotropic additive comprises an amide, optionally, an organic acid diamide.

7. The paste composition of claim 1, wherein the dispersant comprises an organic polymer, optionally the dispersant comprises a polymeric alkoxylate.

8. The paste composition of claim 1, wherein the organic vehicle further comprises an anti-cracking additive, wherein the anti-cracking additive comprises:
an organic compound comprising a melting point greater than 25° C., optionally, a non-polymeric organic compound, further optionally, a small molecule organic compound, even further optionally, a terpenoid;
a cellulose based polymer, optionally, a hydroxypropyl cellulose; or
an ethoxylated fatty alcohol.

9. The paste composition of claim 1, wherein the organic vehicle is configured to provide the paste composition with a viscosity as measured at about 25° C. of from about 10,000 cP to about 200,000 cP at a shear rate of about 2 s⁻¹, a viscosity of from about 1,000 cP to about 50,000 cP at a shear rate of 50 s⁻¹, or a combination thereof.

10. The paste composition of claim 1, wherein the organic vehicle is configured to provide a stable paste composition for a period of greater than 30 days at room temperature and pressure.

11. The paste composition of claim 1, wherein the one or more powders comprises a first metal powder and a second metal powder.

12. The paste composition of claim 11, wherein the first metal powder comprises an iron based alloy, optionally, the first metal powder comprises an iron based alloy comprising iron and one or more of chromium, nickel, molybdenum, vanadium, manganese, silicon, or a combination thereof.

13. The paste composition of claim 11, wherein the first metal powder comprises a particle size distribution D99 of less than 40 μm, optionally, a particle size distribution D90 between 20 and 30 μm, further optionally, a particle size distribution D50 between 10 and 20 μm.

14. The paste composition of claim 11, wherein the second metal powder comprises an iron powder.

15. The paste composition of claim 11, wherein the second metal powder comprises a maximum particle size distribution D90 of 15 μm, optionally, a particle size distribution D50 of from 3 μm to 8 μm, further optionally, a particle size distribution D10 of from 3 μm to 5 μm.

15. The paste composition of claim 11, wherein the paste composition comprises a total metal content of from about 30% to 60% by volume.

16. The paste composition of claim 15, wherein the second metal powder is present in an amount of from about 1% to 50%, optionally, from about 1% to 25%, further optionally, from about 5% to 15%, based on a volume of the total metal content of the paste composition.

17. The paste composition of claim 11, wherein the one or more powders further comprises a third metal powder, wherein the first metal powder comprises a low alloy steel comprising less than 8% alloying elements by weight based on the total weight of the low alloy steel, and wherein the third metal powder comprise a high alloy steel comprising from 8% to 50% alloying elements by weight based on the total weight of the high alloy steel.

18. The paste composition of claim 17, wherein the third metal powder is present in an amount of from about 1% to 50%, optionally, from about 10% to 40%, further optionally, from about 20% to 40%, based on a volume of the total metal content of the paste composition.

19. The paste composition of claim 11, wherein the one or more powders further comprises a third metal powder, wherein the third metal powder comprises a nickel powder, optionally, wherein the third metal powder is present in an amount of from about 1% to 50%, optionally, from about 5% to 40%, further optionally, from about 10% to 20%, based on a volume of the total metal content of the paste composition.

20. The paste composition of claim 1, wherein:
the one or more powders comprise a spherical shape, a spheroidal shape, or a combination thereof, and/or
the one or more powders comprise a multimodal size distribution.

21. The paste composition of claim 1, wherein the one or more powders comprise a ceramic powder, wherein the ceramic powder comprises one or more of a metal oxide, aluminum oxide, aluminum nitride, silicon nitride, silicon oxide, aluminum silicon oxide, cerium oxides, boron nitride, boron oxide, silicon carbide, titanium nitride, titanium carbide, titanium oxide, calcium titanate, strontium titanate, barium titanate, zinc oxide, zinc sulfide, zirconium oxide, calcium zirconate, strontium zirconate, barium zirconate, yttrium stabilized zirconium oxide, partially stabilized zirconium oxide, hafnium oxide, tungsten oxide, tungsten carbide, iron oxide, bismuth strontium calcium copper oxide, yttrium barium copper oxide, or a combination thereof.
